(19) United States
(12) Patent Application Publication
(10) Pub. No.: US 2012/0188981 A1
(43) Pub. Date: Jul. 26, 2012

(54) SIGNALLING METHOD FOR DIRECT COMMUNICATION BETWEEN TERMINALS

(75) Inventors: Sung Cheol Chang, Daejeon (KR); Mi-Young Yun, Daejeon (KR); Seokki Kim, Osan-si (KR); Won-Ik Kim, Daejeon (KR); Sung Kyung Kim, Daejeon (KR); Eunkyung Kim, Daejeon (KR); Hyun Lee, Daejeon (KR); Chul Sik Yoon, Seoul (KR); Kwang Jae Lim, Daejeon (KR)

(73) Assignee: ELECTRONICS AND TELECOMMUNICATIONS RESEARCH INSTITUTE, Daejeon (KR)

(21) Appl. No.: 13/336,920

(22) Filed: Dec. 23, 2011

(30) Foreign Application Priority Data
Dec. 24, 2010 (KR) 10-2010-0134912
Sep. 14, 2011 (KR) 10-2011-0092606
Nov. 1, 2011 (KR) 10-2011-0112962
Dec. 23, 2011 (KR) 10-2011-0141642
Dec. 23, 2011 (KR) 10-2011-0141644

(51) Int. Cl. H04W 72/04; H04W 36/00

(52) U.S. Cl. 370/331; 370/329

(57) ABSTRACT

A signaling method of a first terminal for direct communication between terminals includes transmitting a link establishment request message for establishing a direct communication link including flow information to a second terminal, receiving a link establishment response message for establishing a direct communication link including flow information from the second terminal, and establishing a direct communication link between the first terminal and the second terminal.

### CROSS-REFERENCE TO RELATED APPLICATION

This application claims priority to and the benefit of Korean Patent Application Nos. 10-2010-0134912, 10-2011-0092606, 10-2011-0112962, 10-2011-0141642, and 10-2011-0141644 filed in the Korean Intellectual Property Office on Dec. 24, 2010, Sep. 14, 2011, Nov. 1, 2011, Dec. 23, 2011, and Dec. 23, 2011, the entire contents of which are incorporated herein by reference.

### BACKGROUND OF THE INVENTION

(a) Field of the Invention

The present invention relates to a signaling method for direct communication between terminals (or mobile stations).

(b) Description of the Related Art

Direct communication refers to signal transmission and reception between terminals without a base station's mediation or control therebetween. As demand for direct communication between terminals is on the rise, a direct communication method within or outside an infrastructure communication region is required.

Meanwhile, demand for simultaneous communication between and among multiple users is also increasing. Thus, a signaling procedure for one-to-many (or 1:N) direct communication, as well as a signaling procedure for one-to-one (or 1:1) direct communication, is required.

In particular, it is required to add information indicating that communication is in a direct mode to a control message for direct communication so as to be discriminated from an infrastructure communication scheme between a base station and a terminal.

### SUMMARY OF THE INVENTION

The present invention has been made in an effort to provide a signaling method for direct communication between terminals.

An exemplary embodiment of the present invention provides a signaling method of a first terminal for direct communication between terminals, including: transmitting a link establishment request message for establishing a direct communication link including flow information to a second terminal; receiving a link establishment response message for establishing a direct communication link including flow information from the second terminal; and establishing a direct communication link between the first terminal and the second terminal.

Another embodiment of the present invention provides a signaling method of a first terminal for direct communication between terminals, including: transmitting a first command message for establishing a direct communication link including flow information to a plurality of second terminals; and establishing a direct communication link between the first terminal and the plurality of second terminals.

Yet another embodiment of the present invention provides a signaling method of a first terminal for direct communication between terminals, including: transmitting a first link establishment request message for establishing a direct communication link to a second terminal through an RTS (request to send) data region; receiving a first link establishment response message for establishing a direct communication link from the second terminal through a CTS (clear to send) data region; and establishing a direct communication link in a first direction with respect to the second terminal from the first terminal.

Still another embodiment of the present invention provides a signaling method of a first terminal for direct communication between terminals, including: multicasting a link establishment command message for establishing a direct communication link to a plurality of second terminals through an RTS (request to send) data region; receiving CTS (clear to send) from the plurality of second terminals; and establishing a direct communication link between the first terminal and the plurality of second terminals.

### BRIEF DESCRIPTION OF THE DRAWINGS

FIG. 1 is a flowchart illustrating a method for establishing a link between terminals in one-to-one direct communication according to an embodiment of the present invention.

FIG. 2 is a flowchart illustrating a method for establishing a link between terminals in one-to-one direct communication according to another embodiment of the present invention.

FIG. 3 is a flowchart illustrating a method for establishing a link between terminals in one-to-one direct communication according to another embodiment of the present invention.

FIG. 4 is a flowchart illustrating a method for establishing a link between terminals in one-to-one direct communication according to another embodiment of the present invention.

FIG. 5 is a flowchart illustrating a method for establishing a link between terminals in one-to-many direct communication according to an embodiment of the present invention.

FIG. 6 is a flowchart illustrating a method for establishing a link between terminals in one-to-many direct communication according to another embodiment of the present invention.

FIG. 7 is a flowchart illustrating a method for establishing a link between terminals in one-to-many direct communication according to another embodiment of the present invention.

FIG. 8 is a flowchart illustrating a method for establishing a link between terminals in one-to-many direct communication according to another embodiment of the present invention.

FIGS. 9 and 10 are flowcharts illustrating a method for performing one-to-one direct communication according to an embodiment of the present invention.

FIG. 11 is a flowchart illustrating a method for configuring a flow in one-to-one direct communication according to an embodiment of the present invention.

FIG. 12 is a flowchart illustrating a method for changing a flow in one-to-one direct communication according to an embodiment of the present invention.

FIG. 13 is a flowchart illustrating a method for releasing a flow in one-to-one direct communication according to an embodiment of the present invention.

FIG. 14 is a flowchart illustrating a method for configuring a flow in one-to-many direct communication according to an embodiment of the present invention.

FIG. 15 is a flowchart illustrating a method for changing a flow in one-to-many direct communication according to an embodiment of the present invention.

FIG. 16 is a flowchart illustrating a method for releasing a flow in one-to-many direct communication according to an embodiment of the present invention.

FIG. 17 is a flowchart illustrating a method for releasing a flow in one-to-one direct communication according to an embodiment of the present invention.

FIG. 18 is a flowchart illustrating a method for releasing a direct communication link in one-to-many direct communication according to an embodiment of the present invention.

FIG. 19 is a flowchart illustrating a method for measuring a channel in one-to-one direct communication according to an embodiment of the present invention.

FIG. 20 is a flowchart illustrating a method for measuring a channel in one-to-many direct communication according to an embodiment of the present invention.

FIG. 21 is a flowchart illustrating a method for changing a resource in one-to-one direct communication according to an embodiment of the present invention.

FIG. 22 is a flowchart illustrating a method for changing a resource in one-to-many direct communication according to an embodiment of the present invention.

FIG. 23 is a flowchart illustrating a method for broadcasting information of a terminal in direct communication according to an embodiment of the present invention.

FIG. 24 to FIG. 26 are flowcharts illustrating a method for managing a unicast transmission in a half-duplex manner according to an embodiment of the present invention.

FIG. 27 is a flowchart illustrating a method for managing a multicast transmission in a half-duplex manner according to an embodiment of the present invention.

FIGS. 28 and 29 are views showing frame structures denoting a resource for direct communication according to an embodiment of the present invention.

FIGS. 30 and 31 are flowcharts illustrating a procedure for establishing a link in unidirectional one-to-one direct communication according to an embodiment of the present invention.

FIGS. 32 and 33 are flowcharts illustrating a procedure for establishing a link in unidirectional one-to-one direct communication according to another embodiment of the present invention.

FIG. 34 is a flowchart illustrating a procedure for establishing a link in unidirectional one-to-one direct communication according to another embodiment of the present invention.

FIG. 35 is a flowchart illustrating a procedure for establishing a link in unidirectional one-to-one direct communication according to another embodiment of the present invention.

FIG. 36 is a flowchart illustrating a procedure for releasing a link in unidirectional one-to-one direct communication according to an embodiment of the present invention.

FIG. 37 is a flowchart illustrating a procedure for managing a flow in unidirectional one-to-one direct communication according to an embodiment of the present invention.

FIGS. 38 to 40 are flowcharts illustrating a procedure for measuring a channel in unidirectional one-to-one direct communication according to an embodiment of the present invention.

FIG. 41 is a flowchart illustrating a procedure for changing a resource in unidirectional one-to-one direct communication according to an embodiment of the present invention.

FIG. 42 is a flowchart illustrating a procedure for changing a resource in unidirectional one-to-one direct communication according to an embodiment of the present invention.

FIGS. 43 and 44 are flowcharts illustrating a procedure for managing a token in unidirectional one-to-one direct communication according to an embodiment of the present invention.

FIG. 45 is a flowchart illustrating a procedure for establishing a link in bi-directional one-to-one direct communication according to an embodiment of the present invention.

FIG. 46 is a flowchart illustrating a procedure for establishing a link in bi-directional one-to-one direct communication according to another embodiment of the present invention.

FIG. 47 is a flowchart illustrating a procedure for establishing a link in bi-directional one-to-one direct communication according to another embodiment of the present invention.

FIG. 48 is a flowchart illustrating a procedure for establishing a link in bi-directional one-to-one direct communication according to another embodiment of the present invention.

FIG. 49 is a flowchart illustrating a procedure for establishing a link in bi-directional one-to-one direct communication according to another embodiment of the present invention.

FIG. 50 is a flowchart illustrating a procedure for establishing a link in bi-directional one-to-one direct communication according to another embodiment of the present invention.

FIG. 51 is a flowchart illustrating a procedure for releasing a link in bi-directional one-to-one direct communication according to another embodiment of the present invention.

FIG. 52 is a flowchart illustrating a procedure for managing a flow in bi-directional one-to-one direct communication according to an embodiment of the present invention.

FIG. 53 is a flowchart illustrating a procedure for establishing a link in bi-directional one-to-one direct communication according to an embodiment of the present invention.

FIG. 54 is a flowchart illustrating a procedure for establishing a link in bi-directional one-to-one direct communication according to another embodiment of the present invention.

FIG. 55 is a flowchart illustrating a procedure for releasing a link in bi-directional one-to-one direct communication according to an embodiment of the present invention.

FIG. 56 is a flowchart illustrating a procedure for managing a flow in bi-directional one-to-one direct communication according to an embodiment of the present invention.

FIG. 57 is a flowchart illustrating a measurement process in bi-directional one-to-one direct communication according to an embodiment of the present invention.

FIG. 58 is a flowchart illustrating a procedure for changing a resource in bi-directional one-to-one direct communication according to an embodiment of the present invention. FIG. 59 is a flowchart illustrating a procedure for changing a resource in bi-directional one-to-one direct communication according to another embodiment of the present invention.

FIG. 60 is a flowchart illustrating a procedure for establishing a link in unidirectional one-to-many direct communication according to an embodiment of the present invention.

FIG. 61 is a flowchart illustrating a procedure for establishing a link in unidirectional one-to-many direct communication according to another embodiment of the present invention.

FIG. 62 is a flowchart illustrating a procedure for establishing a link in unidirectional one-to-many direct communication according to another embodiment of the present invention.

FIG. 63 is a flowchart illustrating a procedure for establishing a link in unidirectional one-to-many direct communication according to another embodiment of the present invention.

FIG. 64 is a flowchart illustrating a procedure for establishing a link in unidirectional one-to-many direct communication according to another embodiment of the present invention.

FIG. 65 is a flowchart illustrating a procedure for establishing a link in unidirectional one-to-many direct communication according to another embodiment of the present invention.

FIG. 66 is a flowchart illustrating a procedure for establishing a link in unidirectional one-to-many direct communication according to another embodiment of the present invention.

FIG. 67 is a flowchart illustrating a procedure for establishing a link in unidirectional one-to-many direct communication according to another embodiment of the present invention.

FIG. 68 is a flowchart illustrating a procedure for releasing a link in unidirectional one-to-many direct communication according to another embodiment of the present invention.

FIG. 69 is a flowchart illustrating a procedure for managing a flow in unidirectional one-to-many direct communication according to an embodiment of the present invention.

FIG. 70 is a flowchart illustrating a procedure for measuring a channel in unidirectional one-to-many direct communication according to an embodiment of the present invention.

FIG. 71 is a flowchart illustrating a procedure for measuring a channel in unidirectional one-to-many direct communication according to another embodiment of the present invention.

FIG. 72 is a flowchart illustrating a procedure for changing a resource in unidirectional one-to-many direct communication according to an embodiment of the present invention.

FIG. 73 is a flowchart illustrating a procedure for changing a resource in unidirectional one-to-many direct communication according to another embodiment of the present invention.

FIG. 74 is a flowchart illustrating a procedure for changing a resource in unidirectional one-to-many direct communication according to another embodiment of the present invention.

FIG. 75 is a flowchart illustrating a procedure for managing a token according to an embodiment of the present invention.

FIG. 76 is a flowchart illustrating a procedure for managing a token according to another embodiment of the present invention.

FIGS. 77 and 78 are views showing an environment in which a terminal relays a direct communication link, and FIG. 79 is a flowchart illustrating a procedure for relaying a direct communication link.

FIG. 80 is a flowchart illustrating a procedure for broadcasting relay information according to an embodiment of the present invention.

FIG. 81 is a flowchart illustrating a procedure for broadcasting relay information according to another embodiment of the present invention.

FIG. 82 is a flowchart illustrating a procedure for obtaining relay information according to an embodiment of the present invention.

FIG. 83 is a flowchart illustrating a procedure for obtaining relay information according to another embodiment of the present invention.

FIG. 84 is a view showing an example of a unidirectional one-to-many relay environment.

FIG. 85 is a flowchart illustrating a procedure for managing a token by a relay terminal according to an embodiment of the present invention.

FIG. 86 is a flowchart illustrating a procedure for managing a token by a relay terminal according to another embodiment of the present invention.

FIG. 87 is a flowchart illustrating a procedure for managing a token by a relay terminal according to another embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, a mobile station (MS) may refer to a terminal, a mobile terminal (MT), a subscriber station (SS), a portable subscriber station (PSS), an access terminal (AT), user equipment (UE), or the like, and may include an entirety or a portion of functions of a terminal, an MT, an SS, a PSS, an AT, a UE, and the like.

Also, a base station (BS) may refer to a node B, an evolved node B (eNodeB), an access point (AP), a radio access station (RAS), a base transceiver station (BTS), a mobile multihop relay (MMR)-BS, and the like, and may include an entirety or a portion of functions of a node B, an eNodeB, an AP, a RAS, a BTS, an MMR-BS, and the like.

A basic procedure for direct communication between terminals may include a link establishment procedure, a flow management procedure, a channel measurement procedure, a resource management procedure, an information broadcast procedure, and a token management procedure. The link establishment procedure, a procedure for establishing a link for direct communication between terminals may additionally include flow information. The flow management procedure may include a flow establishment procedure, a flow changing procedure, and a flow releasing procedure. The channel measurement procedure refers to a procedure for measuring and reporting a radio channel by a reception terminal. The resource management procedure includes a procedure for changing a radio resource allocated for direct communication. The information broadcasting procedure includes a procedure for broadcasting a terminal state or a communication environment. The token management procedure includes a procedure for controlling the authority to talk in a push-to-talk (PTT) operation.

The basic procedure in direct communication may vary according to one-to-one direct communication or one-to-many direct communication.

First, a method for establishing a link between terminals in one-to-one direct communication will be described. To this end, a direct mode ranging request (DM-RNG-REQ) message requesting connection establishment and a direct mode ranging response (DM-RNG-RSP) message as a response to the connection establishment request may be exchanged between terminals. The DM-RNG-REQ message and the DM-RNG-RSP message may include a field required for a link establishment. The DM-RNG-REQ message may be used together with a direct mode link establish request (DM-LEST-REQ) message, and the DM-RNG-RSP message may be used together with a direct mode link establish response (DM-LEST-RSP) message.

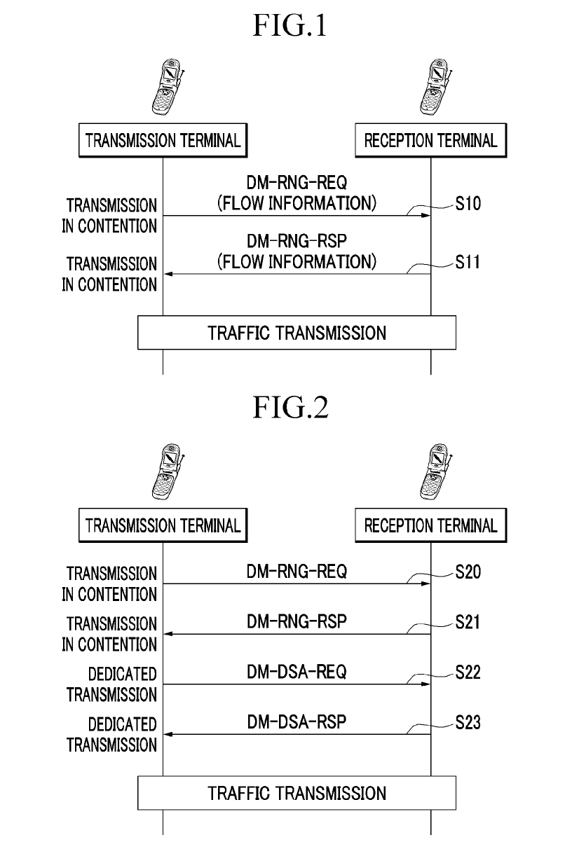

FIG. 1 is a flowchart illustrating a method for establishing a link between terminals in one-to-one direct communication according to an embodiment of the present invention.

With reference to FIG. 1, a transmission terminal contendingly transmits a DM-RNG-REQ message including flow information to a reception terminal (S10), and the reception terminal contendingly transmits a DM-RNG-RSP message including flow information to a transmission terminal (S11).

Accordingly, a link for direct communication is established between the transmission terminal and the reception terminal, and traffic transmission may be performed therebetween.

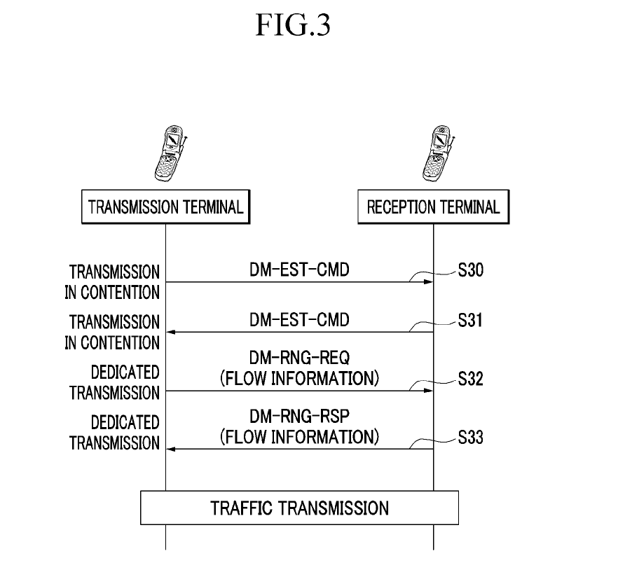

FIG. 2 is a flowchart illustrating a method for establishing a link between terminals in one-to-one direct communication according to another embodiment of the present invention.

With reference to FIG. 2, the transmission terminal contendingly transmits a DM-RNG-REQ message including terminal identifier information to the reception terminal (S20), and the reception terminal contendingly transmits a DM-RNG-RSP message to the transmission terminal (S21). Thereafter, the transmission terminal dedicatedly transmits a DM-DSA-REQ message to the reception terminal (S22), and the reception terminal dedicatedly transmits a DM-DSA-RSP message to the transmission terminal (S23). Accordingly, a link for direct communication may be established between the transmission terminal and the reception terminal, and traffic transmission may be performed therebetween.

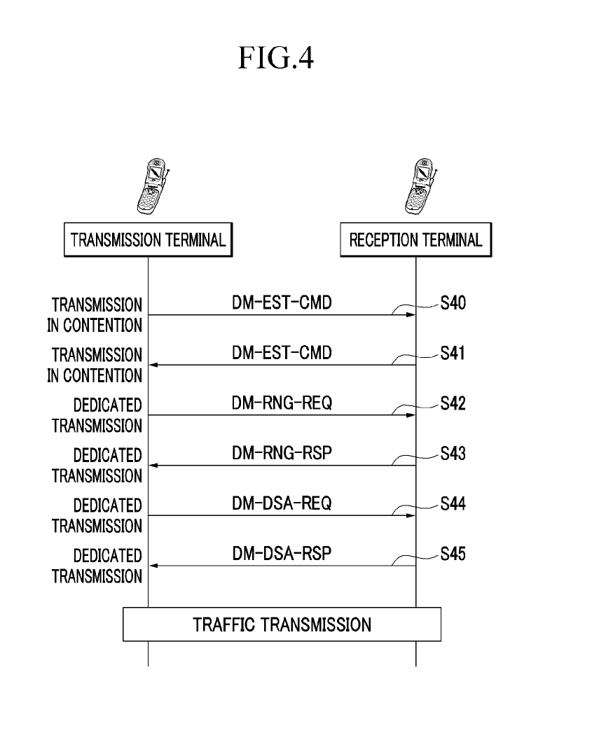

FIG. 3 is a flowchart illustrating a method for establishing a link between terminals in one-to-one direct communication according to another embodiment of the present invention. Here, this embodiment is different from the cases of FIGS. 1 and 2, in that a procedure for transmitting a direct mode establishment command (DM-EST-CMD) message, an independent control message for a transmission in contention, is added.

With reference to FIG. 3, the transmission terminal and the reception terminal exchange a DM-EST-CMD message (S30, S31). The DM-EST-CMD is transmitted in contention. The DM-EST-CMD includes terminal identifier information, and a resource for dedicated transmission may be allocated through the DM-EST-CMD message.

Thereafter, the transmission terminal dedicatedly transmits a DM-RNG-REQ message including flow information to the reception terminal (S32), and the reception terminal dedicatedly transmits a DM-RNG-RSP message including flow information to the transmission terminal (S33). Accordingly, a link for direct communication is established between the transmission terminal and the reception terminal, and traffic transmission may be performed therebetween.

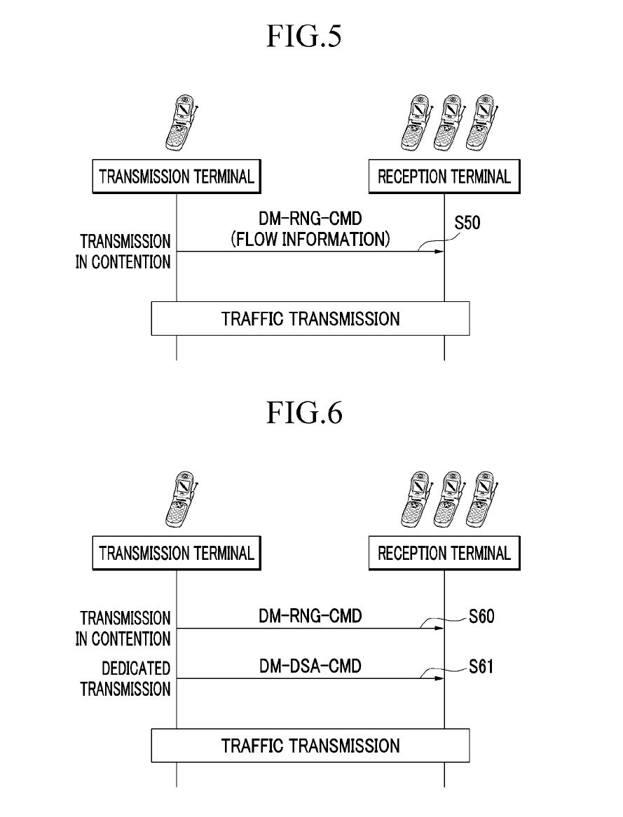

FIG. 4 is a flowchart illustrating a method for establishing a link between terminals in one-to-one direct communication according to another embodiment of the present invention. Here, this embodiment is different from the cases of FIGS. 1 and 2, in that a procedure for transmitting a direct mode establishment command (DM-EST-CMD) message, an independent control message for a transmission in contention, is added.

With reference to FIG. 4, the transmission terminal and the reception terminal exchange a DM-EST-CMD message (S40, S41). The DM-EST-CMD message is transmitted in contention. The DM-EST-CMD includes terminal identifier information, and a resource for a dedicated transmission may be allocated through the DM-EST-CMD message.

The transmission terminal dedicatedly transmits a DM-RNG-REQ message to the reception terminal (S42), and the reception terminal dedicatedly transmits a DM-RNG-RSP message to the transmission terminal (S43). And, the transmission terminal dedicatedly transmits a DM-DSA-REQ message to the reception terminal (S44), and the reception terminal dedicatedly transmits a DM-DSA-RSP message to the transmission terminal (S45). Accordingly, a link for direct communication is established between the transmission terminal and the reception terminal, and traffic transmission may be performed therebetween.

According to FIGS. 3 and 4, since control messages are dedicatedly transmitted, reliability of the signal transmission can be enhanced and a transmission delay can be reduced.

Hereinafter, a method for establishing a link between terminals in one-to-many direct communication will be described.

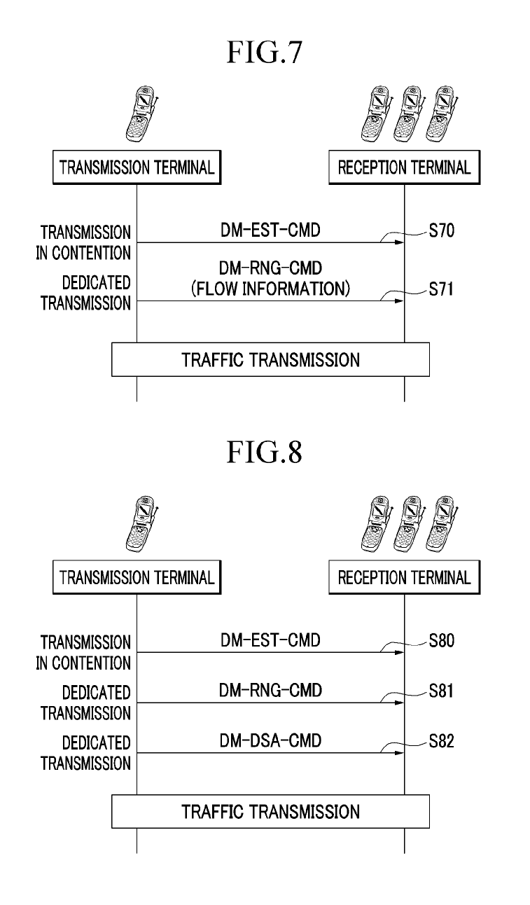

FIG. 5 is a flowchart illustrating a method for establishing a link between terminals in one-to-many direct communication according to an embodiment of the present invention.

With reference to FIG. 5, the transmission terminal contendingly transmits a direct mode ranging command (DM-RNG-CMD) message including flow information to a plurality of reception terminals (S50). The DM-RNG-CMD message may be used together with a DM-LEST-CMD message. Accordingly, a direct communication link may be established between the transmission terminal and the plurality of reception terminals, and traffic transmission may be performed therebetween. Here, the DM-RNG-CMD message may include a field required for establishing a link.

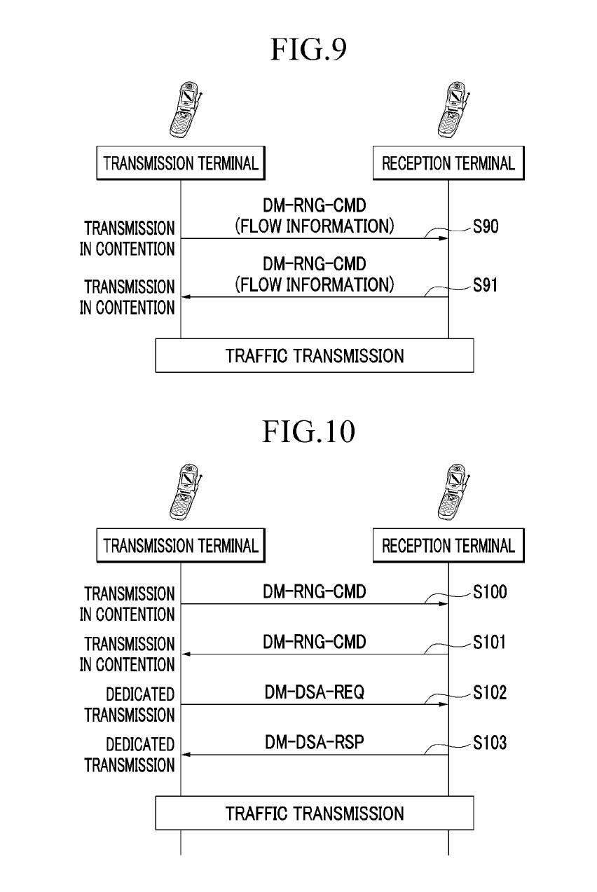

FIG. 6 is a flowchart illustrating a method for establishing a link between terminals in one-to-many direct communication according to another embodiment of the present invention.

With reference to FIG. 6, the transmission terminal contendingly transmits a DM-RNG-CMD message to a plurality of reception terminals (S60), and the transmission terminal dedicatedly transmits a DM-DSA-CMD message to the plurality of reception terminals (S61). Accordingly, a link for direct communication may be established between the transmission terminal and the reception terminals, and traffic transmission may be performed therebetween.

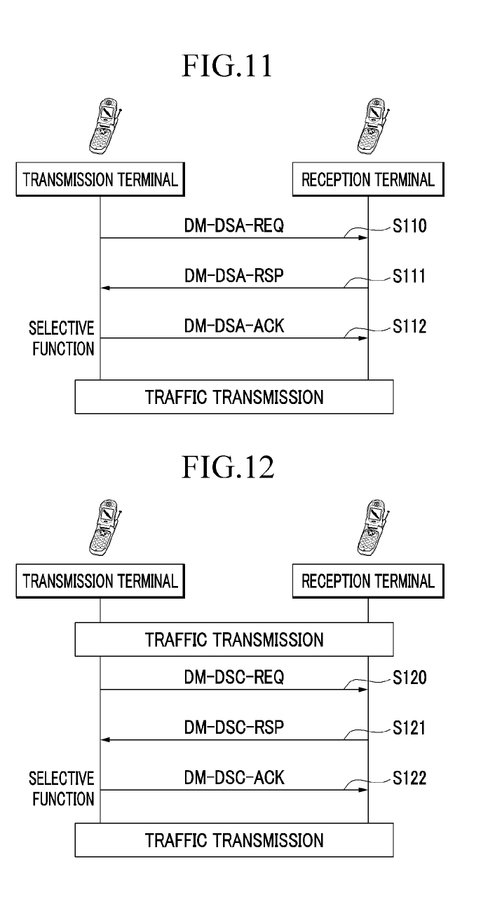

FIG. 7 is a flowchart illustrating a method for establishing a link between terminals in one-to-many direct communication according to another embodiment of the present invention. Here, this embodiment is different from the cases of FIGS. 5 and 6, in that a procedure for transmitting a DM-EST-CMD message, an independent control message for transmission in contention, is added.

With reference to FIG. 7, the transmission terminal contendingly transmits a DM-EST-CMD message to a plurality of reception terminals (S70), and the transmission terminal dedicatedly transmits a DM-RNG-CMD message including flow information to the plurality of reception terminals (S71). Accordingly, a link for direct communication is established between the transmission terminal and the reception terminals, and traffic transmission may be performed.

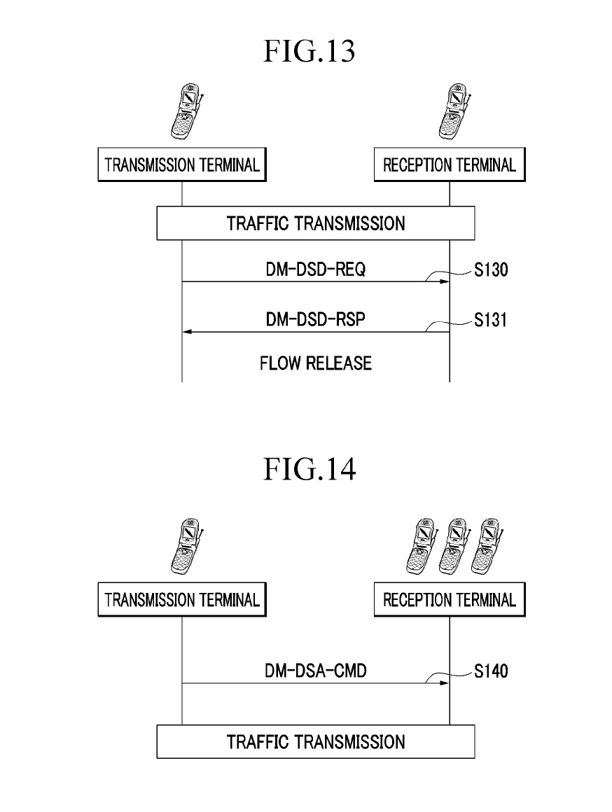

FIG. 8 is a flowchart illustrating a method for establishing a link between terminals in one-to-many direct communication according to another embodiment of the present invention. Here, this embodiment is different from the cases of FIGS. 5 and 6, in that a procedure for transmitting an independent control message for a transmission in contention is added.

With reference to FIG. 8, the transmission terminal contendingly transmits a DM-EST-CMD message to a plurality of reception terminals (S80), the transmission terminal dedicatedly transmits a DM-RNG-CMD message to the plurality of reception terminals (S81), and the transmission terminal dedicatedly transmits a DM-DSA-CMD message to the plurality of transmission terminals (S82). Accordingly, a link for direct communication may be established between the transmission terminal and the reception terminal, and traffic transmission may be performed.

As shown in FIGS. 7 and 8, a dedicated resource for a follow-up procedure may be obtained by transmitting the DM-EST-CMD message in contention. The DM-EST-CMD message may include terminal identifier information.

Hereinafter, a method for performing one-to-one direct communication by using a one-to-many link establishment procedure will be described.

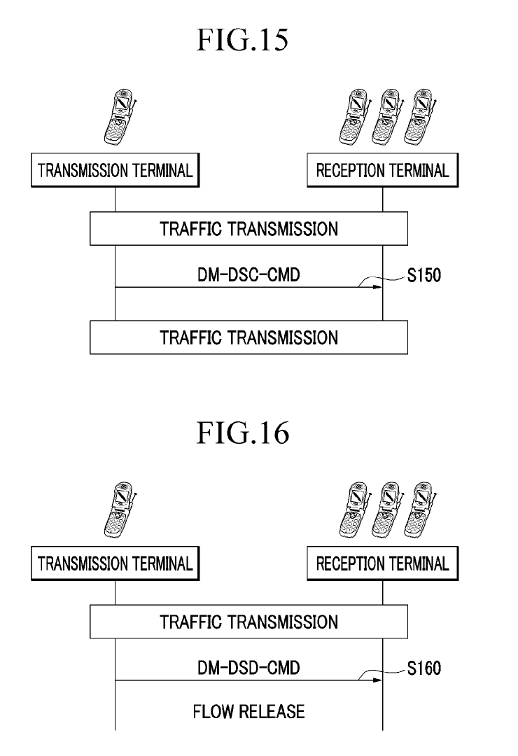

FIGS. 9 and 10 are flowcharts illustrating a method for performing one-to-one direct communication according to an embodiment of the present invention.

With reference to FIG. 9, the transmission terminal contendingly transmits a DM-RNG-CMD message including flow information to a reception terminal (S90), and the reception terminal contendingly transmits a DM-RNG-CMD message including flow information to the transmission terminal (S91). Accordingly, a link for direct communication may be established between the transmission terminal and the reception terminal, and traffic transmission may be performed.

With reference to FIG. 10, the transmission terminal contendingly transmits a DM-RNG-CMD message to the reception terminal (S100), the reception terminal contendingly transmits a DM-RNG-CMD message to the transmission terminal (S101), the transmission terminal dedicatedly transmits a DM-DSA-REQ message to the reception terminal (S102), and the reception terminal dedicatedly transmits a DM-DSA-RSP message to the transmission terminal (S103). Accordingly, a link for direct communication may be established between the transmission terminal and the reception terminal, and traffic transmission may be performed.

As shown in FIGS. 9 and 10, in order to perform one-to-one direct communication by using the one-to-many link establishment procedure, a DM-EST-CMD message or a DM-RNG-CMD message may be contendingly transmitted, and then a DM-RNG-REQ/RSP message or a DM-DSA-REQ/RSP message may be dedicatedly transmitted during the one-to-many link establishment procedure. And, the DM-RNG-CMD message, a control message, may be transmitted in a contending transmission manner.

Next, a method for managing a flow in one-to-one direct communication will be described.

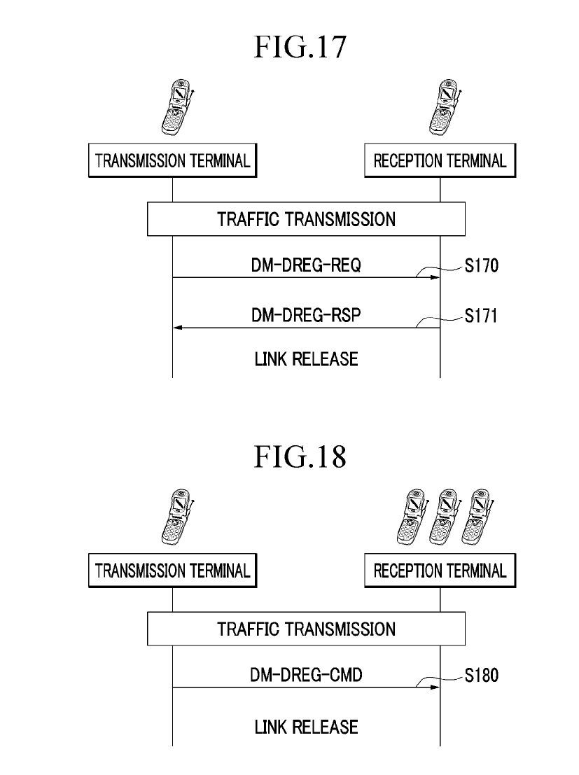

FIG. 11 is a flowchart illustrating a method for configuring a flow in one-to-one direct communication according to an embodiment of the present invention.

With reference to FIG. 11, the transmission terminal transmits a direct mode dynamic service addition request (DM-DSA-REQ) message to the reception terminal (S110), the reception terminal transmits a direct mode dynamic service addition response (DM-DSA-RSP) message to the transmission terminal (S111), and the transmission terminal transmits a direct mode dynamic service addition acknowledge (DM-DSA-ACK) message to the reception terminal (S112). Thereafter, traffic transmission may be performed between the transmission terminal and the reception terminal.

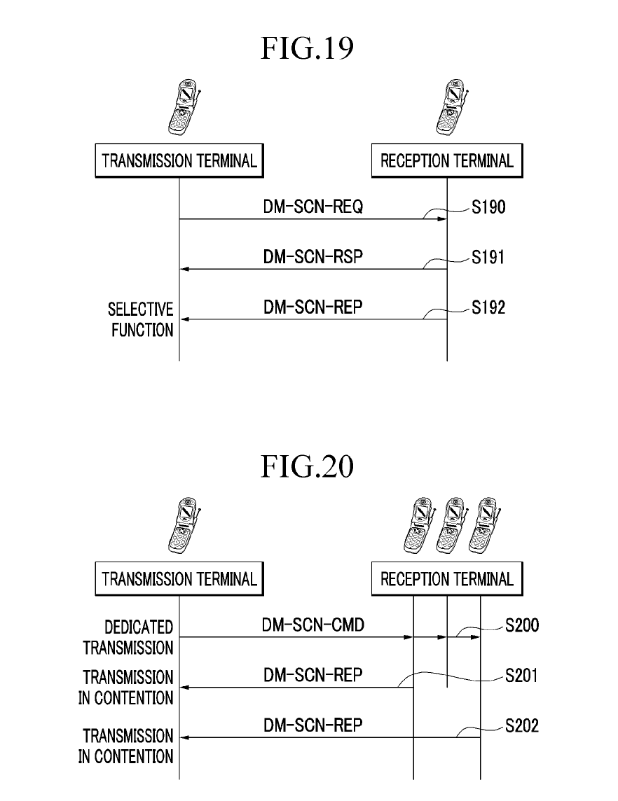

FIG. 12 is a flowchart illustrating a method for changing a flow in one-to-one direct communication according to an embodiment of the present invention.

With reference to FIG. 12, when there is a need to change a flow while traffic is being transmitted between the transmission terminal and the reception terminal, the transmission terminal transmits a direct mode dynamic service change request (DM-DSC-REQ) message to the reception terminal (S120), the reception terminal transmits a direct mode dynamic service change response (DM-DSC-RSP) message to the transmission terminal (S121), and the transmission terminal transmits a direct mode dynamic service change acknowledge (DM-DSC-ACK) message to the reception terminal (S122). Thereafter, the transmission terminal and the reception terminal perform traffic transmission according to the changed flow.

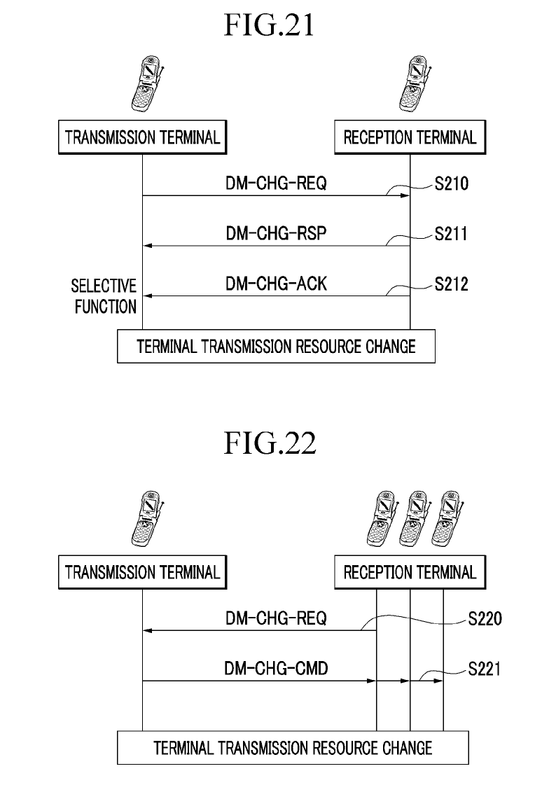

FIG. 13 is a flowchart illustrating a method for releasing a flow in one-to-one direct communication according to an embodiment of the present invention.

With reference to FIG. 13, when there is a need to release a flow while traffic is being transmitted between the transmission terminal and the reception terminal, the transmission terminal transmits a direct mode dynamic service delete request (DM-DSD-REQ) message to the reception terminal (S130), and the reception terminal transmits a direct mode dynamic service delete response (DM-DSD-RSP) message to the transmission terminal (S131). Accordingly, a flow between the transmission terminal and the reception terminal is released.

Next, a method for managing a flow in one-to-many direct communication will be described.

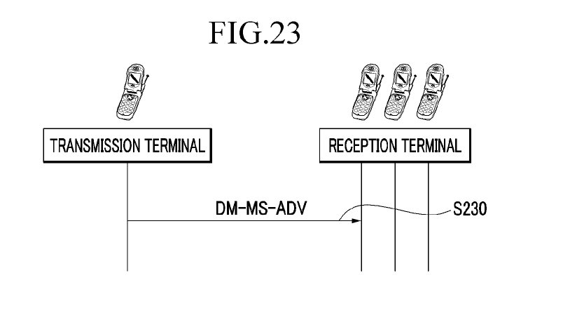

FIG. 14 is a flowchart illustrating a method for configuring a flow in one-to-many direct communication according to an embodiment of the present invention.

With reference to FIG. 14, the transmission terminal transmits a direct mode dynamic service addition command (DM-DSA-CMD) message instructing about configuring a flow to a plurality of reception terminals (S140). Accordingly, a flow is configured between the transmission terminal and the plurality of reception terminals, and traffic transmission may be performed therebetween.

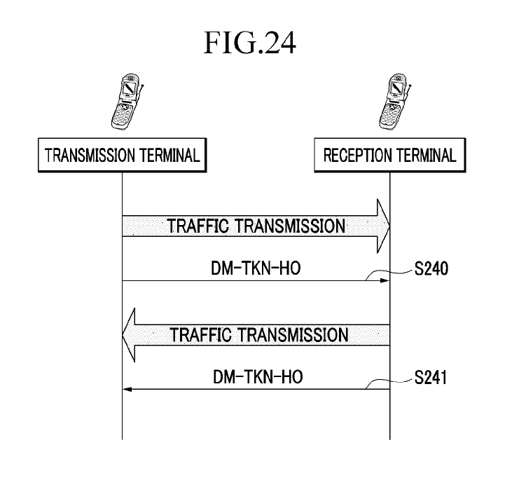

FIG. 15 is a flowchart illustrating a method for changing a flow in one-to-many direct communication according to an embodiment of the present invention.

With reference to FIG. 15, when there is a need to change a flow while traffic is being transmitted between the transmission terminal and a plurality of reception terminals, the transmission terminal transmits a direct mode dynamic service change command (DM-DSD-CMD) message instructing about changing of a flow to the plurality of reception terminals (S150), and the transmission terminal and the plurality of reception terminals perform traffic transmission according to the changed flow.

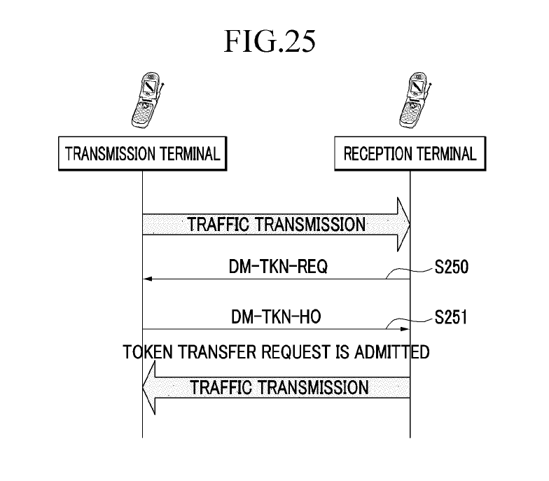

FIG. 16 is a flowchart illustrating a method for releasing a flow in one-to-many direct communication according to an embodiment of the present invention.

With reference to FIG. 16, when there is a need to release a flow while traffic is being transmitted between the transmission terminal and a plurality of reception terminals, the transmission terminal transmits a direct mode dynamic service delete command (DM-DSC-CMD) message to the reception terminals (S160). Accordingly, the flow between the transmission terminal and the reception terminals is released.

Next, a link releasing method, namely, a method for releasing direct communication between terminals, will be described.

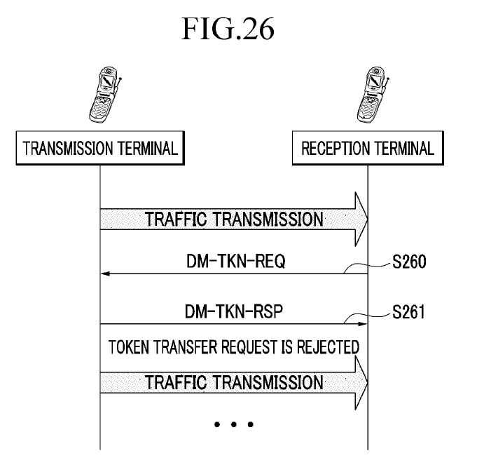

FIG. 17 is a flowchart illustrating a method for releasing a flow in one-to-one direct communication according to an embodiment of the present invention.

With reference to FIG. 17, when a direct communication link is intended to be released while traffic is being transmitted between the transmission terminal and the reception terminal, the transmission terminal transmits a direct mode deregister request (DM-DREG-REQ) message for requesting release of a direct communication link to the reception terminal (S170), and the reception terminal transmits a direct mode deregister response (DM-DREG-RSP) message for responding to the request for releasing the direct communication link to the transmission terminal (S171). Accordingly, the link for direct communication between the transmission terminal and the reception terminal is released. Here, the DM-DREG-REQ message may be used together with a DM-LREL(Link release)-REQ message, and the DM-DREG-RSP message may be used together with a DM-LREL(Link release)-RSP message.

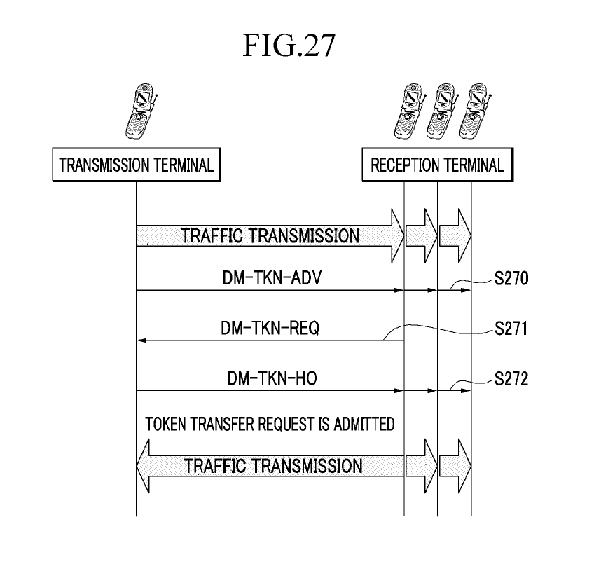

FIG. 18 is a flowchart illustrating a method for releasing a direct communication link in one-to-many direct communication according to an embodiment of the present invention.

With reference to FIG. 18, when a direct communication link is intended to be released while traffic is being transmitted between the transmission terminal and a plurality of reception terminals, the transmission terminal transmits a direct mode deregister command (DM-DREG-CMD) message for instructing about releasing the direct communication link to the plurality of reception terminals (S180). Here, the DM-DREG-CMD message may be used together with a DM-LREL(Link release)-CMD message.

Next, a method for measuring a channel in one-to-one direct communication will be described.

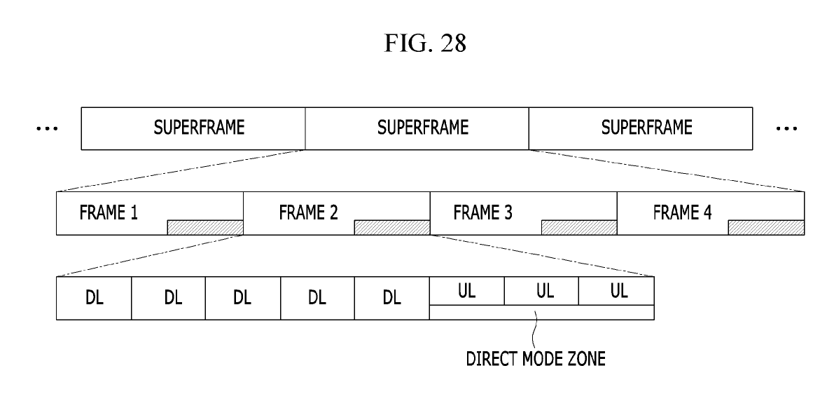

FIG. 19 is a flowchart illustrating a method for measuring a channel in one-to-one direct communication according to an embodiment of the present invention.

With reference to FIG. 19, the transmission terminal transmits a direct mode scan request (DM-SCN-REQ) message to the reception terminal (S190), and the reception terminal transmits a direct mode scan response (DN-SCN-RSP) message to the transmission terminal (S191). Here, the DM-SCN-REQ message may include measurement method information such as a measurement target, a measurement value, a measurement period, a report condition, and the like. The DM-SCN-RSP message, a response to the DM-SCN-REQ message, may include a measurement value. Meanwhile, when the transmission terminal instructs about measuring a channel periodically or conditionally through the transmitted DM-SCN-REQ message, the reception terminal may transmit a direct mode scan report (DM-SCN-REP) message to the transmission terminal (S192). Here, the DM-SCN-REQ message, the DM-SCN-RSP message, and the DM-SCN-REP message may be used together with a DM-MES(Measurement)-REQ message, a DM-MES-RSP message, and a DM-MES-REP message, respectively.

Next, a method for measuring a channel in one-to-many direct communication will be described.

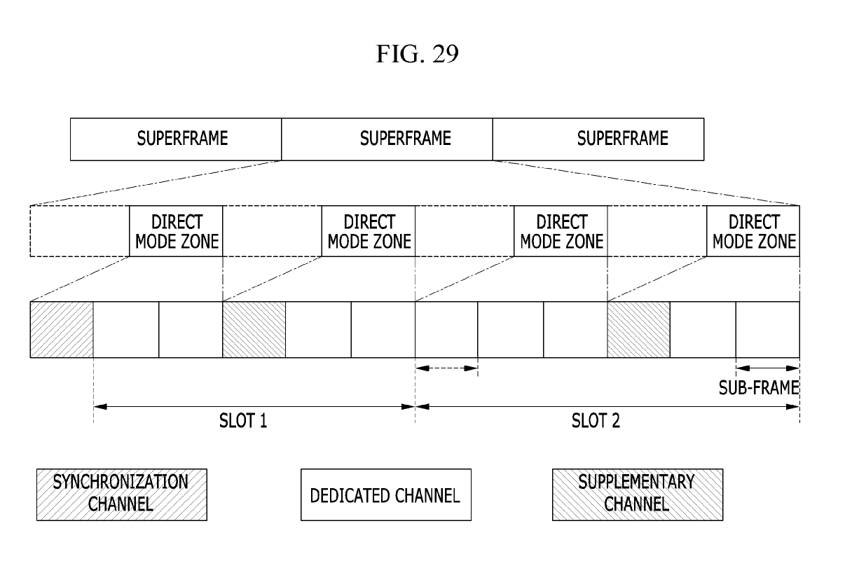

FIG. 20 is a flowchart illustrating a method for measuring a channel in one-to-many direct communication according to an embodiment of the present invention.

With reference to FIG. 20, the transmission terminal dedicatedly transmits a direct mode scan command (DM-SCN-CMD) message, a measurement instructing message instructing about measuring a channel, to a plurality of reception terminals (S200), and the plurality of reception terminals contendingly transmit a direct mode scan report (DM-SCN-REP) message reporting a channel measurement result to the transmission terminal (S201, S202). Here, the DM-SCN-CMD message, which is a message requesting a channel measurement from the plurality of terminals, may include measurement method information such as a measurement target, a measurement value, a measurement period, a report condition, and the like. The DM-SCN-CMD message may designate a resource by which the DM-SCN-REP message is transmitted. A reception terminal that satisfies the report requirements transmits a DM-SCN-REP message to the transmission terminal. The DM-SCN-REP message may be transmitted through the designated resource, or may be transmitted through a contending transmission resource in a contending transmission manner. Here, the DM-SCN-CMD message may be used together with a DM-MES-CMD message.

Next, a method for managing a resource in direct communication will be described.

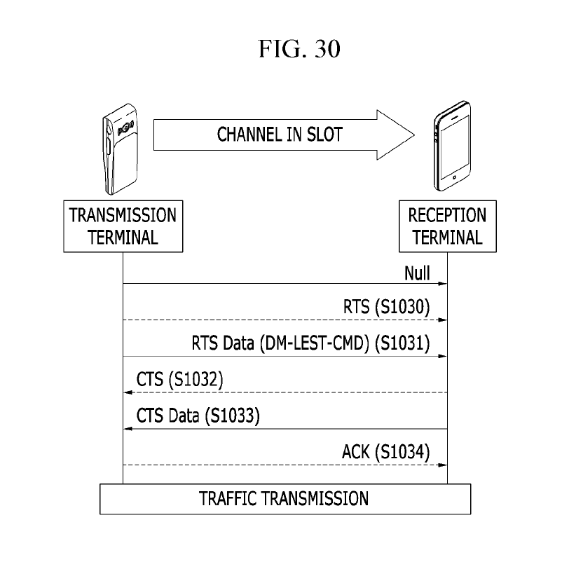

FIG. 21 is a flowchart illustrating a method for changing a resource in one-to-one direct communication according to an embodiment of the present invention.

With reference to FIG. 21, the reception terminal transmits a direct mode change request (DM-CHG-REQ(DM-RCHG-REQ)) message to the transmission terminal to request changing of the resource (S210), and the transmission terminal transmits a direct mode change response (DM-CHG-RSP(DM-RCHG-RSP)) message to the reception terminal in response thereto (S211). When the transmission terminal accepts the request from the reception terminal, the resource is changed. The changed resource may be configured on the same lane or a different lane.

The reception terminal may transmit an acknowledgment ACK with respect to the DM-CHG-RSP(DM-RCHG-RSP) message to the transmission terminal (S212).

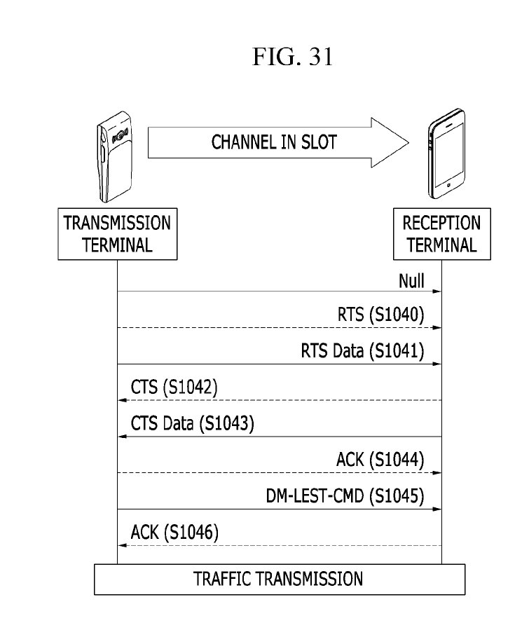

FIG. 22 is a flowchart illustrating a method for changing a resource in one-to-many direct communication according to an embodiment of the present invention.

With reference to FIG. 22, one of a plurality of reception terminals transmits a DM-CHG-REQ(DM-RCHG-REQ) message to the transmission terminal to request changing the resource (S220). Here, the DM-CHG-REQ(DM-RCHG-REQ) message may be transmitted in a contending transmission manner. The transmission terminal determines whether to change the resource based on the DM-CHG-REQ(DM-RCHG-REQ) message, and transmits a direct mode change command (DM-CHG-CMD(DM-RCHG-CMD)) message to the plurality of reception terminals in a multicast manner (S221). The DM-CHG-CMD(DM-RCHG-CMD) message may include resource change information.

Next, a method for broadcasting, by a terminal, a state of the terminal itself and a communication environment of a direct communication region will be described.

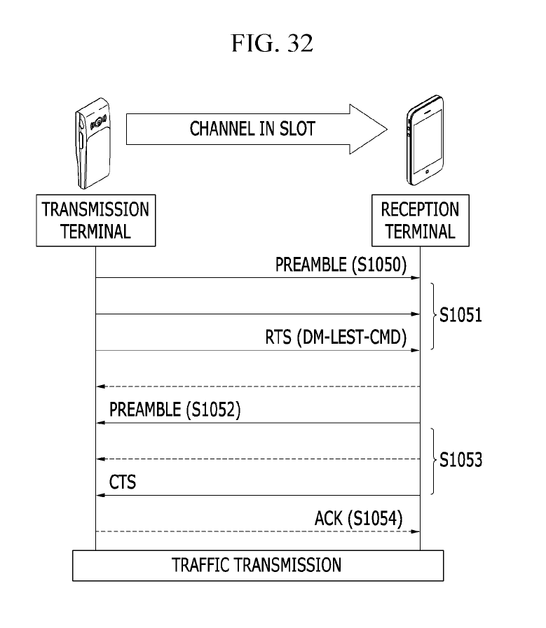

FIG. 23 is a flowchart illustrating a method for broadcasting information of a terminal in direct communication according to an embodiment of the present invention.

With reference to FIG. 23, the transmission terminal broadcasts a direct mode mobile station advertisement (DM-MS-ADV) to a plurality of reception terminals (S230). The DM-MS-ADV message may include information regarding a terminal state and a direct communication environment. The DM-MS-ADV message may be transmitted in a contending transmission manner. Here, a transmission period may be dynamically configured for each terminal in consideration of a traffic load of the contending transmission. Upon receiving the DM-MS-ADV message, the plurality of reception terminals may store and manage terminal state information from the DM-MS-ADV message transmitted from the adjacent transmission terminal.

Next, a method for managing a token in one-to-one direct communication will be described.

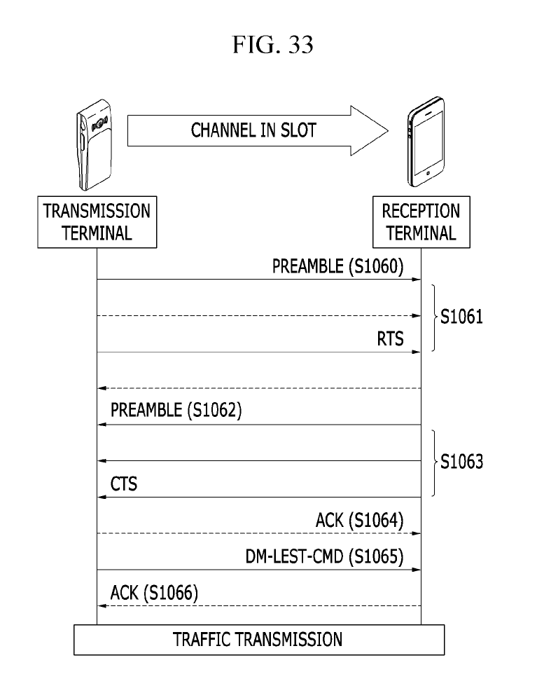

FIGS. 24 to FIG. 26 are flowcharts illustrating a method for managing a unicast transmission in a half-duplex manner according to an embodiment of the present invention.

With reference to FIG. 24, the transmission terminal, upon acquiring a token, transmits traffic to the reception terminal. When the transmission terminal wants to transfer the token to the reception terminal, the transmission terminal transmits a direct mode token handover (DM-TKN-HO) message instructing about transferring the token to the reception terminal (S240). The DM-TKN-HO message may include an address of the terminal, namely, the reception terminal, to which the token is to be transferred, and may be transmitted in a dedicated transmission manner.

Thereafter, upon receiving the token, the reception terminal transmits traffic to the transmission terminal. When the reception terminal wants to transfer the token to the transmission terminal, the reception terminal may transmit a DM-TKN-HO message to the transmission terminal (S241).

With reference to FIG. 25, upon acquiring the token, the transmission terminal transmits traffic to the reception terminal. When the reception terminal wants to acquire the token, the reception terminal transmits a direct mode token request (DM-TKN-REQ) message requesting a transfer of the token to the transmission terminal (S250). When the transmission terminal accepts the token transfer request from the reception terminal, the transmission terminal transmits a DM-TKN-HO message to the reception terminal (S251), and when the reception terminal acquires the token, it transmits traffic to the transmission terminal.

With reference to FIG. 26, the transmission terminal which has acquired the token transmits traffic to the reception terminal. When the reception terminal wants to acquire the token, the reception terminal transmits a DM-TKN-REQ (DM token request) message requesting a transfer of the token to the transmission terminal (S260). The transmission terminal transmits a DM-TKN-RSP (DM-Token Response) message to the reception terminal (S261). The DM-TKN-RSP message may include acceptance or rejection information with respect to the token transfer request. When the transmission terminal rejects the token transfer request from the reception terminal, the transmission terminal may still transmit traffic to the reception terminal.

Next, a method for managing a token in one-to-many direct communication will be described.

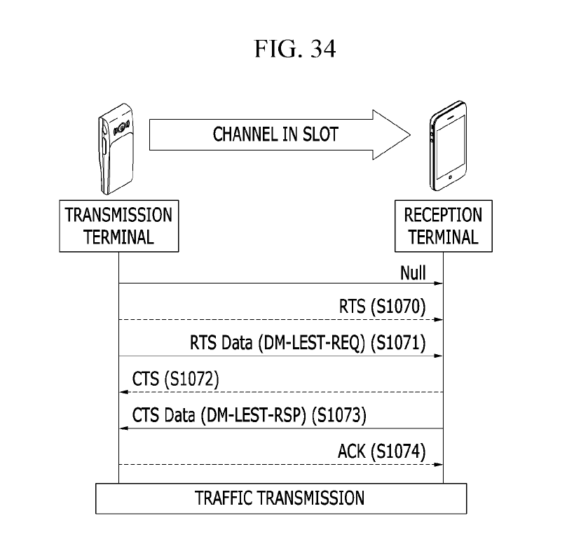

FIG. 27 is a flowchart illustrating a method for managing a multicast transmission in a half-duplex manner according to an embodiment of the present invention.

With reference to FIG. 27, the transmission terminal, which has acquired a token, transmits traffic to a plurality of reception terminals. When the transmission terminal completes a traffic transmission, it transmits a direct mode token advertisement (DM-TKN-ADV) message to the plurality of reception terminals to notify that the token will be transferred (S270).

When one of the plurality of reception terminals wants to request a transfer of the token, it transmits a DM-TKN-REQ message to the transmission terminal (S271). The DM-TKN-REQ message may be contendingly transmitted or dedicatedly transmitted. The reception terminal may transmit the DM-TKN-REQ message in order to request a token transfer even in a state in which the DM-TKN-ADV message is not received.

The transmission terminal receives the DM-TKN-REQ message, and in case of accepting the token transfer requested by the reception terminal, the transmission terminal multicasts a DM-TKN-HO message to the plurality of reception terminals (S272). Here, the DM-TKN-HO message may include an address of a terminal to which the token is to be transferred, and may be transmitted in a dedicated transmission manner.

Table 1 shows control messages required for signaling a basic procedure in direct communication as described above. The control messages may include a field indicating direct communication.

TABLE 1

| | | 1:n procedure |
|---|---|---|
| Procedure name | 1:1 procedure message | message |
| Link establishment | DM-RNG-REQ/RSP | DM-RNG-CMD |
| Flow management | DM-DSx-REQ/RSP/ACK | DM-DSx-CMD |
| Link release | DM-DREG-REQ/RSP | DM-DREG-CMD |
| Measurement | DM-SCN-RERQ/RSP/REP | DM-SCN-CMD |
| Resource management | DM-CHG-REQ/RSP | DM-CHG-CMD |
| Information broadcast | | DM-MS-ADV |
| Token management | DM-TKN-REQ/RSP/HO | DM-TKN-ADV |

Hereinafter, a method for signaling by dividing one-to-one direct communication into unidirectional communication and bi-directional communication will be provided. Also, a signaling method supporting unidirectional one-to-many direct communication will be provided. Here, signaling for direct communication is a procedure for exchanging a MAC (medium access control) control message for direct communication, which may be used together with a signal procedure or a MAC signal procedure. Also, a signaling method in consideration of an operation of a dedicated channel for direct communication and a corresponding auxiliary channel will be provided. Also, a signaling method that can be applicable even to a multi-hop environment relaying direct communication links as well as in a single hop environment by applying a signaling method will be provided.

To this end, first, a frame structure supporting the signaling method for direct communication according to an embodiment of the present invention will be described.

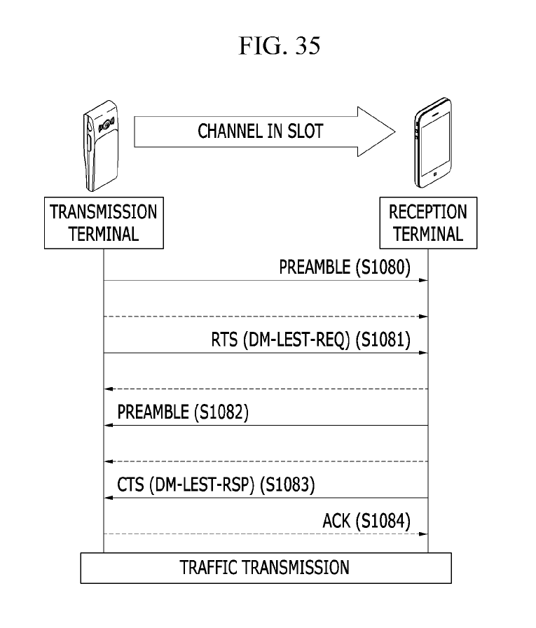

FIGS. 28 and 29 are views showing frame structures denoting a resource for direct communication according to an embodiment of the present invention.

With reference to FIGS. 28 and 29, a superframe includes a plurality of frames, and each frame includes a plurality of subframes. Some of the subframes in each frame may be allocated to an uplink (UL) resource region, and the remaining subframes may be allocated to a downlink (DL) resource region.

In the present disclosure, a portion of the uplink resource region is illustrated as a radio resource (direct mode zone) for direct communication, but the present invention is not limited thereto. A radio resource for direct communication may not be used in infrastructure communication between a base station and a terminal. Terminals participating in direct communication may perform direct communication by using a direct communication protocol and procedure through a radio resource for direct communication.

Meanwhile, a radio resource for direct communication may include a synchronization channel, a dedicated channel, and a supplementary channel. The synchronization channel may transfer a synchronization message including information for obtaining frequency or time synchronization between a transmission terminal and a reception terminal that want to perform direct communication therebetween. The dedicated channel may transfer a packet for direct communication between terminals. Here, the packet may include data and control information. The supplementary channel may transfer RTS (request to send) and CTS (clear to send) for reserving a dedicated channel, an ACK message indicating whether or not a packet has been successfully transferred, a control message with respect to a channel measurement value, a MAC control message for signaling, and the like. Radio resource for direct communication within a single superframe may be divided into a synchronization part and a data part. Here, the data part may be comprised of two slots, and each slot may be indicated as slot 1 and slot 2. Each slot may include a dedicated channel and a supplementary channel. Here, the dedicated channel and the supplementary channel are in a 1:1 relationship. For example, a supplementary channel of slot 1 may correspond to a dedicated channel of slot 2 of a previous superframe. A supplementary channel of slot 2 may correspond to a dedicated channel of slot 1 of the same superframe.

A signaling procedure for unidirectional one-to-one direct communication will be described.

A signaling procedure for unidirectional one-to-one direct communication may denote a signal procedure with respect to a communication connection of a direct communication link transmitting data in one direction. A single slot in a direct communication frame may be used for a unidirectional direct communication connection. Here, a transmission terminal for transmitting data and a reception terminal for receiving data may participate in communication. A dedicated channel and a corresponding supplementary channel may be used in the signaling procedure for unidirectional one-to-one direct communication.

First, a procedure for establishing a link in unit-directional one-to-one direct communication will be described.

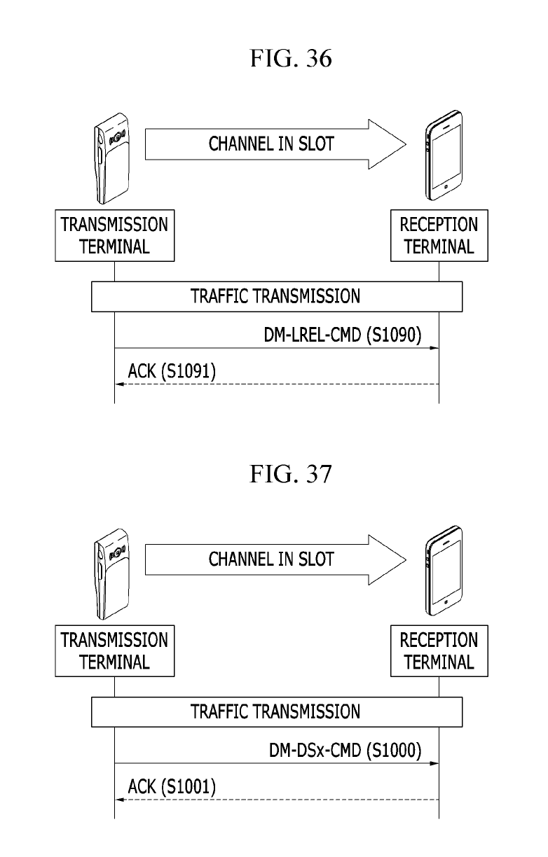

FIGS. 30 and 31 are flowcharts illustrating a procedure for establishing a link in unidirectional one-to-one direct communication according to an embodiment of the present invention.

With reference to FIG. 30, a resource allocation function and a link establishment function are collectively or integrally operated. A transmission terminal transmits RTS to a reception terminal (S1030), and transmits a direct mode link establishment command (DM-LEST-CMD) message for establishing a link through an RTS data part (S1031). Thereafter, the reception terminal transmits CTS to the transmission terminal (S1032), and transmits a CTS data part (S1033). After the transmission terminal transmits an ACK message to the reception terminal, the resource allocation procedure and the link establishment procedure are completed (S1034). Accordingly, traffic may be transmitted between the transmission terminal and the reception terminal.

With reference to FIG. 31, a resource allocation function and a link establishment function are independently operated. The transmission terminal transmits RTS to the reception terminal (S1040) and transmits an RTS data part to the reception terminal (S1041). Then, the reception terminal transmits CTS to the transmission terminal (S1042), and transmits a CTS data part to the transmission terminal (S1043). After the transmission terminal transmits ACK, the resource allocation procedure is completed (S1044). Thereafter, the transmission terminal transmits a DM-LEST-CMD message to the reception terminal (S1045), and when the transmission terminal receives an ACK message, the link establishment procedure is completed (S1046).

Here, the link establishment procedure may include a function for establishing a service flow in a link.

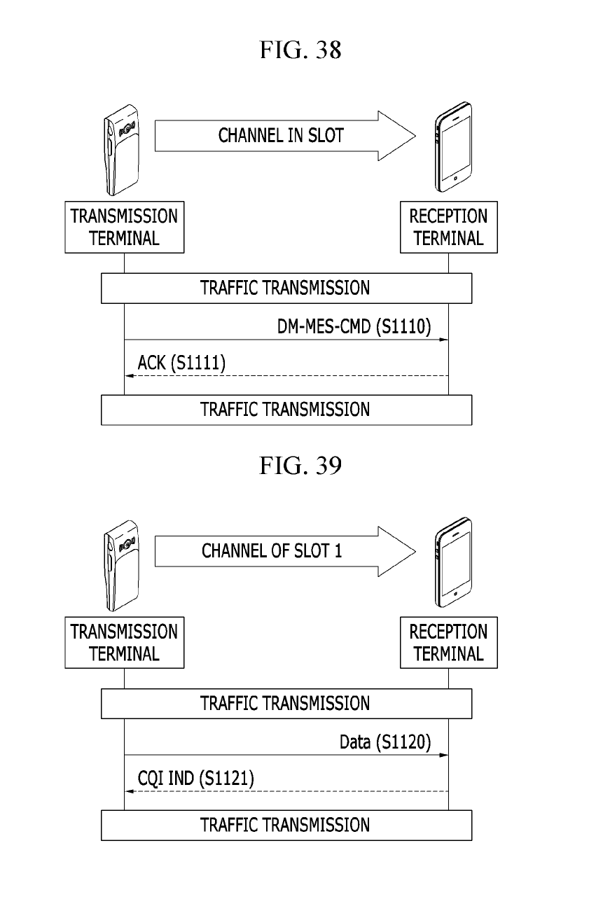

FIGS. 32 and 33 are flowcharts illustrating a procedure for establishing a link in unidirectional one-to-one direct communication according to another embodiment of the present invention.

With reference to FIG. 32, a resource allocation function and a link establishment function are collectively or integratedly operated. After the transmission terminal transmits a preamble to the reception terminal (S1050), it transmits RTS and transmits a DM-LEST-CMD message through an RTS data part (S1051). Thereafter, the reception terminal transmits a preamble (S1052), transmits CTS, and then transmits a CTS data part (S1053). The transmission terminal transmits ACK to the reception terminal (S1054). Accordingly, the resource allocation procedure and the link establishment procedure between the transmission terminal and the reception terminal are simultaneously completed.

With reference to FIG. 33, the resource allocation function and the link establishment function are independently operated. After the transmission terminal transmits a preamble to the reception terminal (S1060), it transmits RTS and transmits an RTS data part (S1061). Then, the reception terminal transmits a preamble to the transmission terminal (S1062), and then transmits CTS and a CTS data part (S1063). After the transmission terminal transmits ACK, the resource allocation procedure is completed (S1064). Thereafter, the transmission terminal transmits a DM-LEST-CMD message to the reception terminal (S1065), and when the reception terminal transmits ACK to the transmission terminal, the link establishment procedure is completed (S1066).

Here, the link establishment procedure may include a function for establishing a service flow in a link.

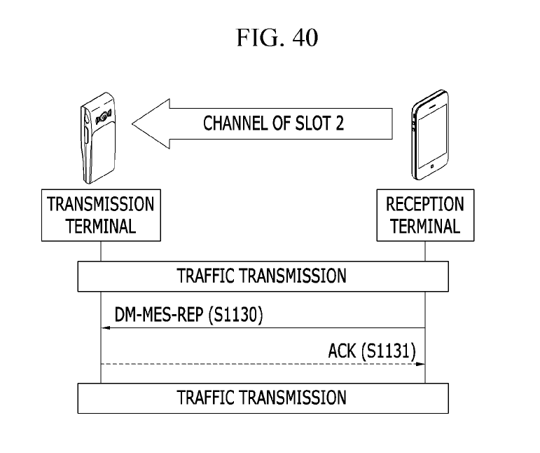

FIG. 34 is a flowchart illustrating a procedure for establishing a link in unidirectional one-to-one direct communication according to another embodiment of the present invention.

With reference to FIG. 34, a resource allocation function and a link establishment function are collectively or integrally operated. The transmission terminal transmits RTS to the reception terminal (S1070), and transmits a direct mode link establishment request (DM-LEST-REQ) message for establishing a direct communication link through an RTS data part (S1071). Thereafter, the reception terminal transmits CTS to the transmission terminal (S1072) and transmits a direct mode link establishment response (DM-LEST-RSP) message through the CTS data part (S1073). The DM-LEST-RSP message may include link establishment information. The transmission terminal transmits ACK to the reception terminal (S1074). Accordingly, the resource allocation procedure and the link establishment procedure between the transmission terminal and the reception terminal are simultaneously completed.

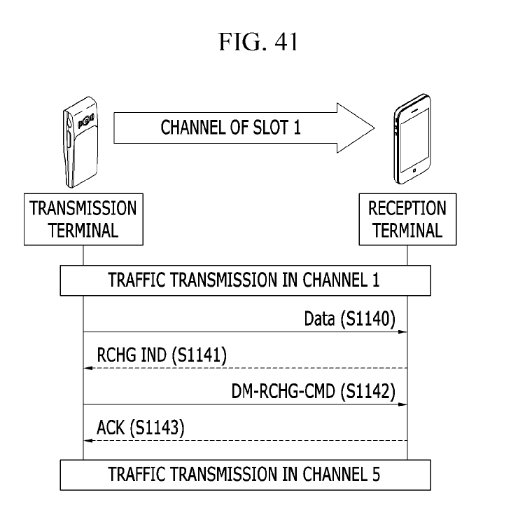

FIG. 35 is a flowchart illustrating a procedure for establishing a link in unidirectional one-to-one direct communication according to another embodiment of the present invention.

With reference to FIG. 35, a resource allocation function and a link establishment function are collectively or integrally operated. After the transmission terminal transmits a preamble to the reception terminal (S1080), the transmission terminal transmits RTS and transmits a DM-LEST-REQ message through the RTS data part (S1081). Thereafter, the reception terminal transmits a preamble to the transmission terminal (S1082), and then transmits CTS and transmits a DM-LEST-RSP message through the CTS data part (S1083). The DM-LEST-RSP message may include link establishment information. The transmission terminal transmits ACK to the reception terminal (S1084). Accordingly, the resource allocation procedure and the link establishment procedure are simultaneously completed. The preamble (S1080) and the preamble (S1082) may be selectively emitted.

A procedure for releasing a link in unidirectional one-to-one direct communication will be described.

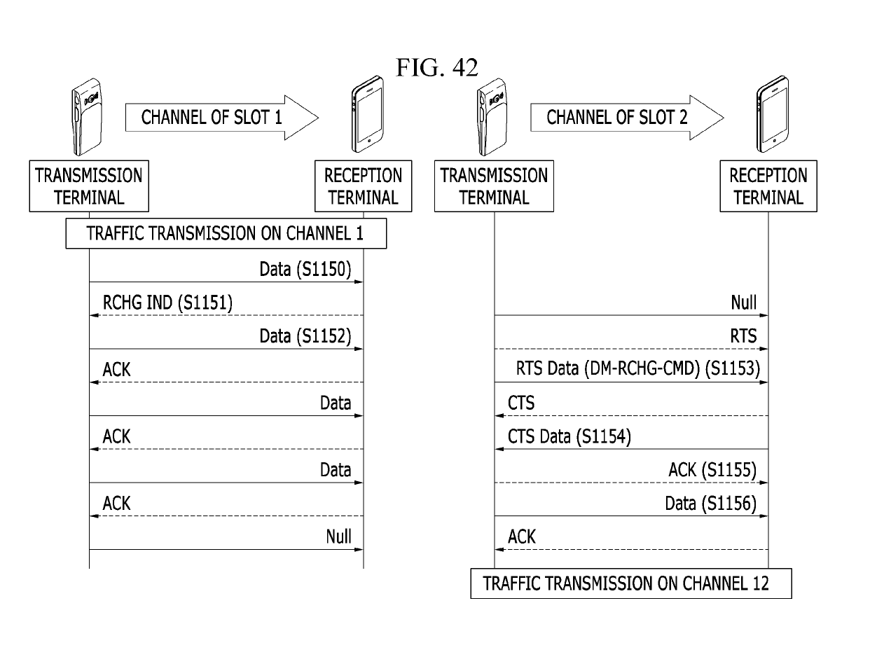

FIG. 36 is a flowchart illustrating a procedure for releasing a link in unidirectional one-to-one direct communication according to an embodiment of the present invention.

With reference to FIG. 36, when the transmission terminal determines to release a link while traffic is being transmitted between the transmission terminal and the reception terminal, the transmission terminal transmits a direct mode link release command (DM-LREL-CMD) message for releasing a direct communication link to the reception terminal (S1090), and receives an ACK message from the reception terminal (S1091). Accordingly, the unidirectional link for direct communication between the transmission terminal and the reception terminal is released.

Next, a procedure for managing a flow in unidirectional one-to-one direct communication will be described.

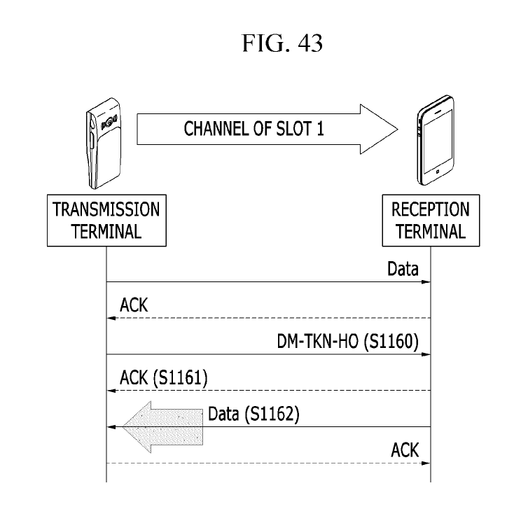

FIG. 37 is a flowchart illustrating a procedure for managing a flow in unidirectional one-to-one direct communication according to an embodiment of the present invention.

With reference to FIG. 37, when the transmission terminal determines to manage a flow while traffic is being transmitted between the transmission terminal and the reception terminal, the transmission terminal transmits a DM-DSx-CMD message to the reception terminal (S1100), and receives an ACK message from the reception terminal (S1101). Accordingly, the procedure for managing a service flow for direct communication between the transmission terminal and the reception terminal is completed. The service flow management procedure includes configuring/changing/releasing procedures. For the service flow configuring/changing/releasing procedure, DM-DSA-CMD (direct mode dynamic service addition command)/DM-DSC-CMD (direct mode dynamic service change command)/DM-DSD-CMD (direct mode dynamic service deletion command) messages may be used, respectively.

Next, a procedure for measuring a channel in unidirectional one-to-one direct communication will be described. The reception terminal may transmit a reception signal measurement value with respect to a dedicated channel resource to the transmission terminal.

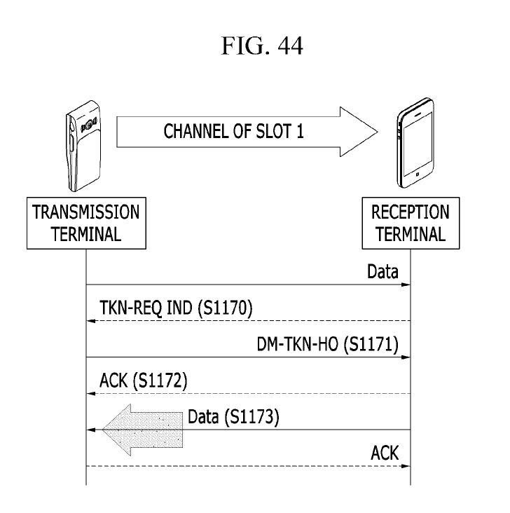

FIGS. 38 to 40 are flowcharts illustrating a procedure for measuring a channel in unidirectional one-to-one direct communication according to an embodiment of the present invention.

With reference to FIG. 38, the transmission terminal requests a channel measurement from the reception terminal. Namely, while traffic is being transmitted between the transmission terminal and the reception terminal, the transmission terminal transmits a direct mode measurement command (DM-MES-CMD) message instructing about a channel measurement to the reception terminal (S1110), and receives an ACK message from the reception terminal (S1111). The transmission terminal may request at least one of a channel measurement method, a channel measurement report period, and a channel measurement report method from the reception terminal through the DM-MES-CMD message.

With reference to FIG. 39, the reception terminal reports a channel measurement value through a supplementary channel. Namely, while traffic is being transmitted between the transmission terminal and the reception terminal, the transmission terminal transmits data to the reception terminal (S1120) and the reception terminal transmits a CQI code including a CQI through the supplementary channel to the transmission terminal (S1121). Here, the supplementary channel transmitting the CQI code corresponds to a dedicated channel as a measurement target, and a dedicated channel is positioned in a different slot from that of the dedicated channel as a measurement target.

With reference to FIG. 40, the reception terminal reports a channel measurement value through the dedicated channel. Namely, the reception terminal transmits a DM-MES-REP message to the transmission terminal (S1130), and receives an ACK message from the transmission terminal (S1131). This may be applied in case in which a unidirectional link from the reception terminal to the transmission terminal is established.

A procedure for changing a resource in unidirectional one-to-one direct communication will be described. Through this, a dedicated channel and a corresponding supplementary channel in unidirectional one-to-one direct communication may be changed.

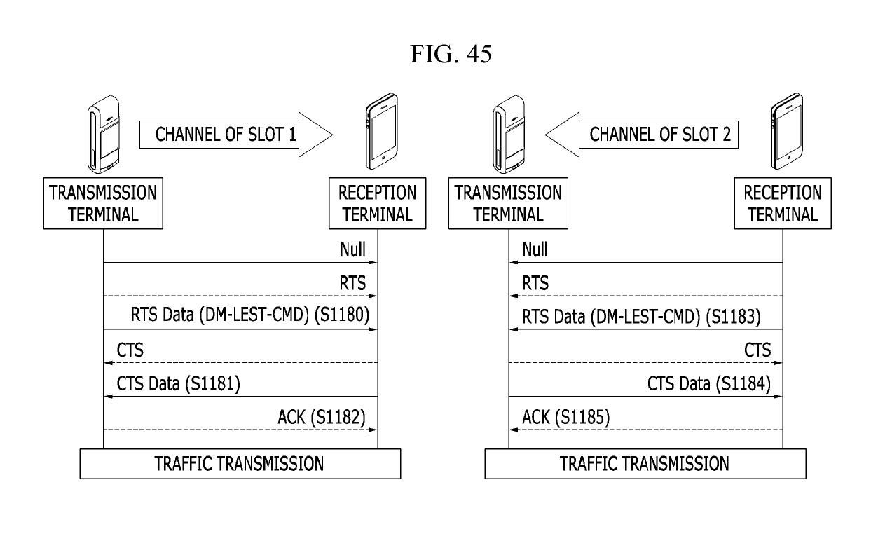

FIG. 41 is a flowchart illustrating a procedure for changing a resource in unidirectional one-to-one direct communication according to an embodiment of the present invention. A case in which a resource requested by the reception terminal belongs to the same slot as that of resource currently transmitting data is illustrated.

With reference to FIG. 41, it is assumed that traffic is transmitted through a channel 1 between the transmission terminal and the reception terminal. The reception terminal receives data from the transmission terminal (S1140), and transmits a resource change indication (RCHG IND) code to the transmission terminal based on a measured radio environment (S1141). The RCHG IND code may be transmitted through the supplementary code. The transmission terminal determines whether to change a resource, and then transmits a DM-RCHG-CMD message to the reception terminal (S1142). The DM-RCHG-CMD message may be transmitted through a new dedicated channel (e.g., channel 5) (S1143).

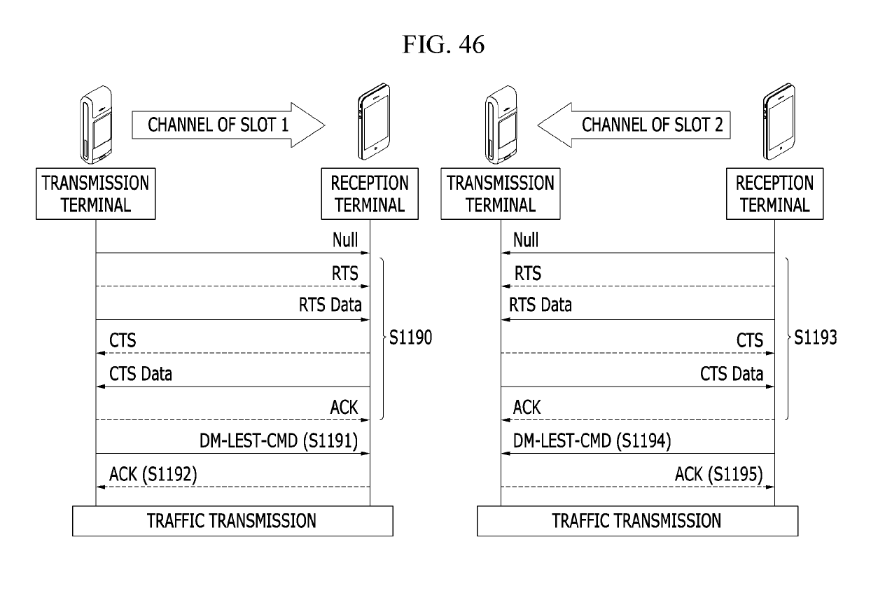

FIG. 42 is a flowchart illustrating a procedure for changing a resource in unidirectional one-to-one direct communication according to an embodiment of the present invention. A case in which a resource requested by the reception terminal belongs to a different slot from that of a resource currently transmitting data is illustrated.

With reference to FIG. 42, it is assumed that a procedure for changing a resource from a channel 1 of a slot 1 to a channel 12 of a slot 2 is used. In FIG. 15, when traffic is transmitted through the channel 1 between the transmission terminal and the reception terminal, the reception terminal receives data from the transmission terminal (S1150) and transmits a resource change indication (RCHG IND) code to the transmission terminal based on a measured radio environment (S1151). The RCHG IND code may be transmitted through a supplementary channel. Thereafter, the transmission terminal continuously transmits data to the reception terminal through the channel 1 of the slot 1 (S1152).

Meanwhile, the transmission terminal determines whether to change a resource, transmits RTS to the reception terminal through the slot 2, and transmits a DM-RCHG-CMD message through RTS data (S1153). Thereafter, the reception terminal transmits CTS to the transmission terminal and transmits CTS data (S1154), and the transmission terminal transmits ACK to the reception terminal, and then, transmits data (S1155). Here, the procedure through the slot 1 and the procedure through the slot 2 are carried out side by side. When the transmission terminal receives CTS data through the slot 2 while transmitting data through the slot 1, the transmission terminal transmits data to the reception terminal through the slot 2 (S1156).

Next, a procedure for managing a token in unidirectional one-to-one direct communication will be described. Through this, a data direction may be changed while using the same amount of radio resource in unidirectional one-to-one direct communication. A token refers to the authority to transmit a signal through a radio resource, and a terminal having a token is eligible to transmit a signal.

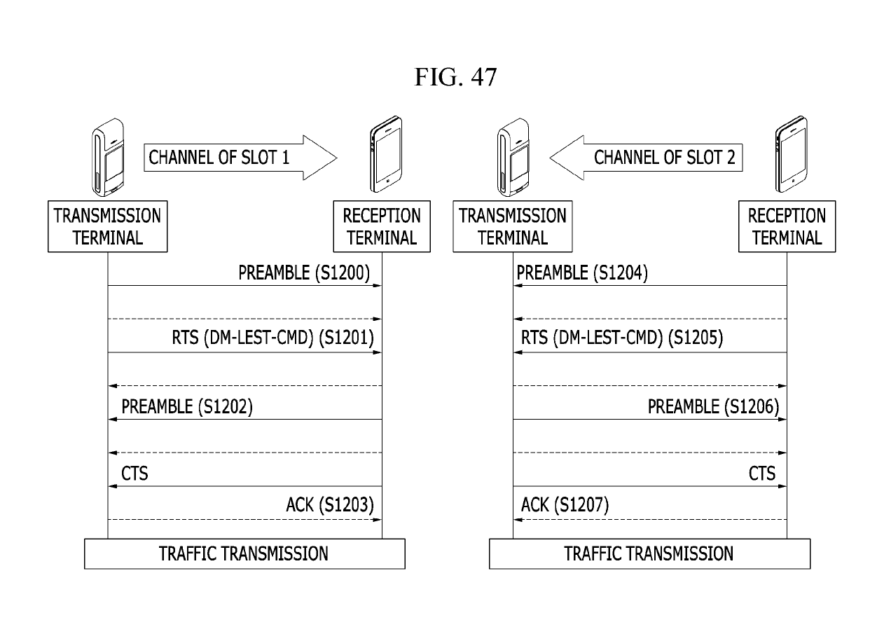

FIGS. 43 and 44 are flowcharts illustrating a procedure for managing a token in unidirectional one-to-one direct communication according to an embodiment of the present invention.

With reference to FIG. 43, the transmission terminal may transfer a token to the reception terminal. To this end, when the transmission terminal determines to transmit a token to the reception terminal, it transfers a direct mode token handover (DM-TKN-HO) message informing about a transfer of a token to the reception terminal (S1160). When the transmission terminal receives ACK from the reception terminal (S1161), the token transfer procedure may be completed. Here, ACK may be transmitted through a supplementary channel. Thereafter, a data direction is changed, and the reception terminal transmits data to the reception terminal (S1162).

With reference to FIG. 44, the reception terminal may request to transfer a token from the transmission terminal. To this end, the reception terminal transmits a token request indication (TKN-REQ IND) code requesting a transfer of a token to the transmission terminal through a supplementary channel (S1170). When the transmission terminal determines to transfer a token to the reception terminal, it transfers a DM-TKN-HO message to the reception terminal (S1171). When the transmission terminal receives ACK from the reception terminal, the token transfer procedure may be completed (S1172). Here, ACK may be transmitted via a supplementary channel. Thereafter, a data direction is changed, and the reception terminal transmits data to the transmission terminal (S1173).

Hereafter, bi-directional one-to-one direct communication will be described. A signal procedure with respect to a bi-directional communication connection of two terminals participating in direct communication is shown. Here, the procedure with respect to a communication connection transferred in both directions follows the unidirectional one-to-one procedure. A bi-directional communication connection is configured as two unidirectional communication connections, and it is possible for signal procedures of the unidirectional communication connections to be separately used. However, a traffic transmission and operation are simultaneously performed on the bi-directional communication connection.

Hereinafter, a procedure for establishing a link in bi-directional one-to-one direct communication which is independently operated will be described.

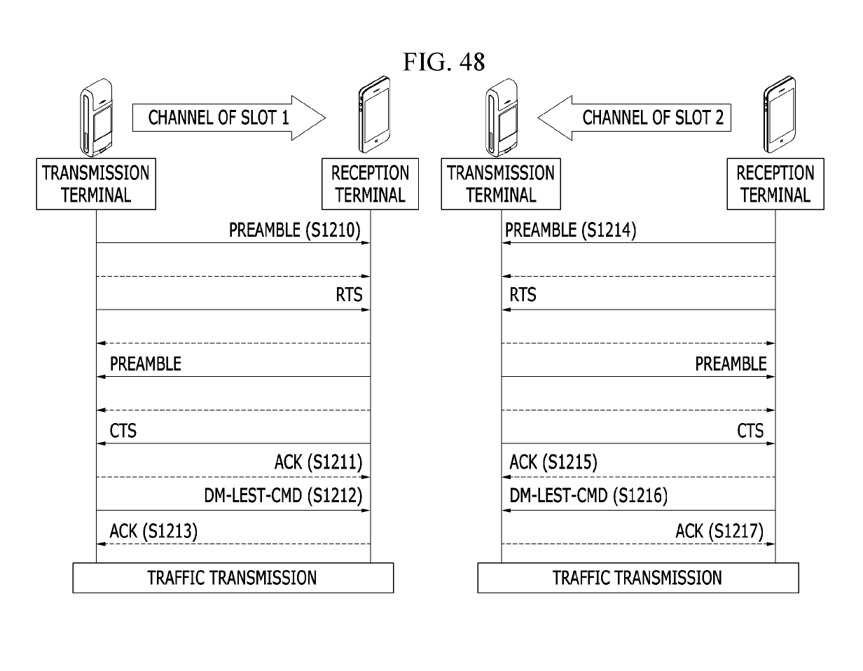

FIG. 45 is a flowchart illustrating a procedure for establishing a link in bi-directional one-to-one direct communication according to an embodiment of the present invention.

With reference to FIG. 45, the transmission terminal and the reception terminal perform a bi-directional connection by using the slot 1 and the slot 2. It is illustrated that a resource allocation procedure and a link establishment procedure are collectively, integratedly operated.

Namely, the transmission terminal transmits RTS to the reception terminal through the slot 1, and transmits a DM-LEST-CMD message through the RTS data part (S1180). Thereafter, the reception terminal transmits CTS to the transmission terminal through the slot 1 and transmits a CTS data part (S1181). After the transmission terminal transmits ACK to the reception terminal, the resource allocation procedure and the link establishment procedure from the transmission terminal to the reception terminal are completed (S1182).

Meanwhile, the reception terminal transmits RTS to the transmission terminal through the slot 2, and transmits a DM-LEST-CMD message through the RTS data part (S1183). Thereafter, the transmission terminal transmits CTS to the reception terminal through the slot 2 and transmits a CTS data part (S1184). After the reception terminal transmits ACK to the transmission terminal, the resource allocation procedure and the link establishment procedure from the reception terminal to the transmission terminal are completed (S1185).

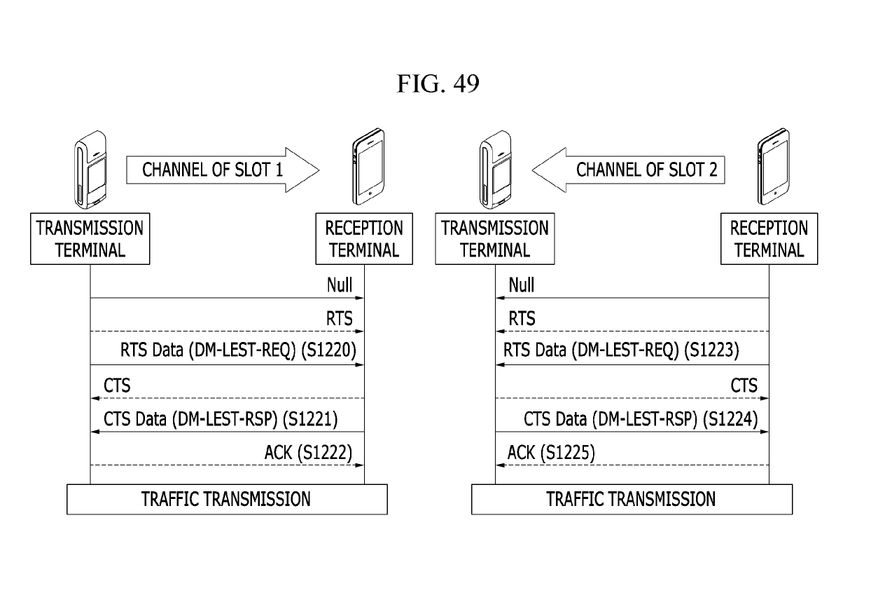

FIG. 46 is a flowchart illustrating a procedure for establishing a link in bi-directional one-to-one direct communication according to another embodiment of the present invention.

With reference to FIG. 46, the transmission terminal and the reception terminal perform bi-directional connection by using the slot 1 and the slot 2. Here, a case in which the resource allocation procedure and the link establishment procedure are independently operated is illustrated.

Namely, the transmission terminal transmits RTS to the reception terminal through the slot 1 and transmits the RTS data part. Thereafter, the reception terminal transmits CTS to the transmission terminal through the slot 1 and transmits the CTS data part. After the transmission transmits ACK to the reception terminal, the resource allocation procedure is completed (S1190). Thereafter, when the transmission terminal transmits a DM-LEST-CMD message to the reception terminal (S1191) and receives an ACK message from the reception terminal, the procedure for establishing a link from the transmission terminal to the reception terminal is completed (S1192).

Meanwhile, the reception terminal transmits RTS to the transmission terminal through the slot 2 and transmits the RTS data part. Thereafter, the transmission terminal transmits CTS to the reception terminal through the slot 2 and transmits the CTS data part. After the reception terminal transmits ACK message to the transmission terminal, the resource allocation procedure is completed (S1193). Thereafter, when the reception terminal transmits a DM-LEST-CMD message to the transmission terminal (S1194) and receives an ACK message from the transmission terminal, the procedure for establishing a link from the reception terminal to the transmission terminal is completed (S1195).

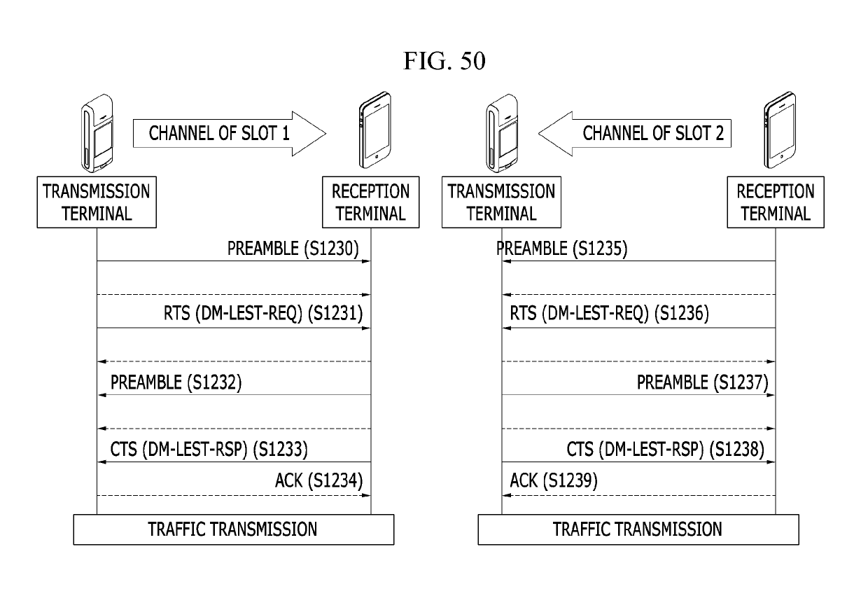

FIG. 47 is a flowchart illustrating a procedure for establishing a link in bi-directional one-to-one direct communication according to another embodiment of the present invention.

With reference to FIG. 47, the transmission terminal and the reception terminal perform a bi-directional connection by using the slot 1 and the slot 2. It is illustrated that the resource allocation procedure and the link establishment procedure are collectively, integratedly operated.

Namely, the transmission terminal transmits a preamble to the reception terminal through the slot 1 (S1200), transmits RTS, and then transmits a DM-LEST-CMD message through the RTS data part (S1201). Thereafter, the reception terminal transmits a preamble to the transmission terminal through the slot 1 (S1202), transmits CTS, and transmits the CTS data part. When the reception terminal receives an ACK message from the transmission terminal, the resource allocation procedure and the link establishment procedure from the transmission terminal to the reception terminal are completed (S1203).

Meanwhile, the reception terminal transmits a preamble to the transmission terminal through the slot 2 (S1204), transmits RTS, and then transmits a DM-LEST-CMD message through the RTS data part (S1205). Thereafter, the transmission terminal transmits a preamble to the reception terminal through the slot 2 (S1206), transmits CTS, and transmits the CTS data part. When the transmission terminal receives an ACK message from the reception terminal, the resource allocation procedure and the link establishment procedure from the reception terminal to the transmission terminal are completed (S1207).

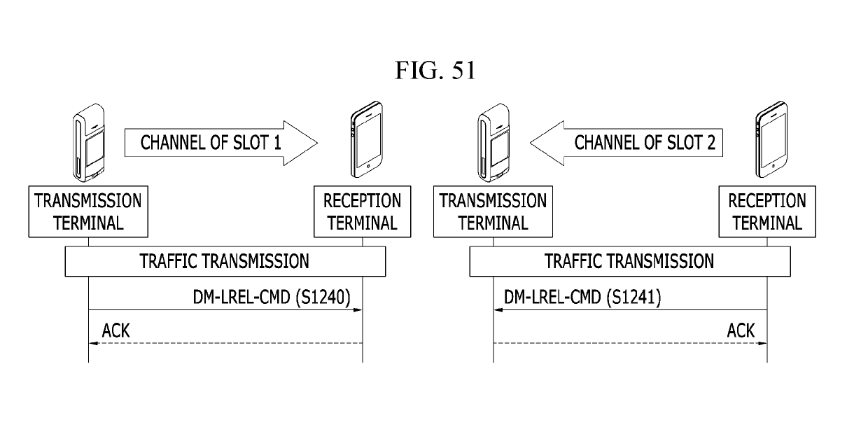

FIG. 48 is a flowchart illustrating a procedure for establishing a link in bi-directional one-to-one direct communication according to another embodiment of the present invention.

With reference to FIG. 48, the transmission terminal and the reception terminal perform a bi-directional connection by using the slot 1 and the slot 2. Here, It is illustrated that the resource allocation procedure and the link establishment procedure are independently operated.

Namely, the transmission terminal transmits a preamble to the reception terminal through the slot 1 (S1210), transmits RTS, and then transmits an RTS data part. Thereafter, the reception terminal transmits a preamble to the transmission terminal through the slot 1, transmits CTS, and transmits the CTS data part. When the reception terminal receives an ACK message from the transmission terminal, the resource allocation procedure from the transmission terminal to the reception terminal is completed (S1211). Thereafter, when the transmission terminal transmits a DM-LEST-CMD message to the reception terminal (S1212) and receives an ACK message from the reception terminal, the link establishment procedure from the transmission terminal to the reception terminal is completed (S1213).

Meanwhile, the reception terminal transmits a preamble to the transmission terminal through the slot 2 (S1214), transmits RTS, and transmits the RTS data part. Thereafter, the transmission terminal transmits a preamble to the reception terminal through the slot 2, transmits CTS, and transmits the CTS data part. When the transmission terminal receives the ACK message from the reception terminal, the resource allocation process toward the transmission terminal from the reception terminal is terminated (S1215).

Thereafter, when the reception terminal transmits a DM-LEST-CMD message to the transmission terminal (S1216) and receives an ACK message from the transmission terminal, the link establishment procedure from the reception terminal to the transmission terminal is completed (S1217).

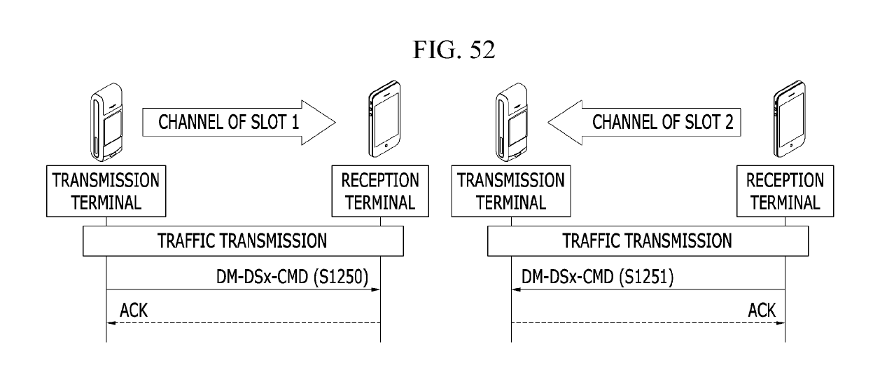

FIG. 49 is a flowchart illustrating a procedure for establishing a link in bi-directional one-to-one direct communication according to another embodiment of the present invention.

With reference to FIG. 49, the transmission terminal and the reception terminal perform a bi-directional connection by using the slot 1 and the slot 2. It is illustrated that the resource allocation procedure and the link establishment procedure are collectively, integratedly operated.

Namely, the transmission terminal transmits RTS to the reception terminal through the slot 1 and transmits a DM-LEST-REQ message through the RTS data part (S1220). Thereafter, the reception terminal transmits CTS to the transmission terminal through the slot 1 and transmits a DM-LEST-RSP message through the CTS data part (S1221). The DM-LEST-RSP message may include link establishment information. When the reception terminal receives an ACK message from the transmission terminal, the resource allocation procedure and the link establishment procedure from the transmission terminal to the reception terminal are completed (S1222).

Meanwhile, the reception terminal transmits RTS to the transmission terminal through the slot 2, and transmits a DM-LEST-REQ message through the RTS data part (S1223). Thereafter, the transmission terminal transmits CTS to the reception terminal through the slot 2 and transmits DM-LEST-RSP message through the CTS data part (S1224). The DM-LEST-RSP message may include link establishment information. When the transmission terminal receives an ACK message from the reception terminal, the resource allocation procedure and the link establishment procedure from the reception terminal to the transmission terminal are completed (S1225).

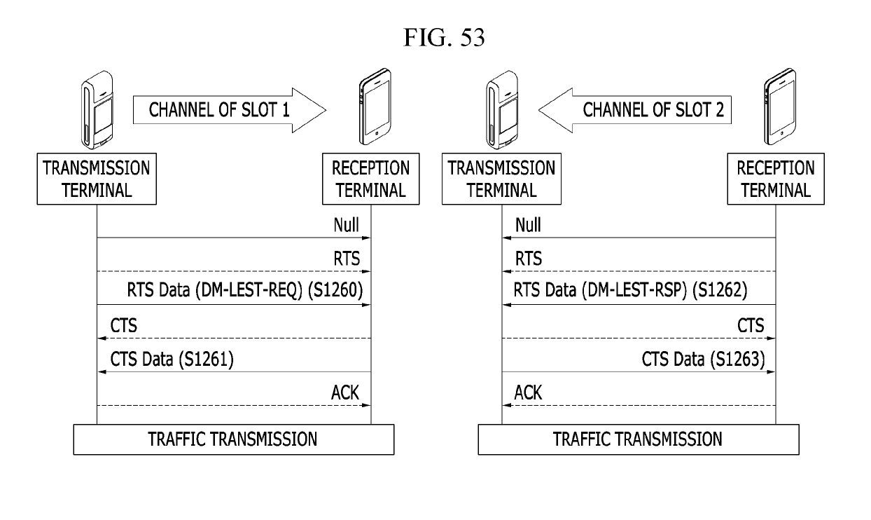

FIG. 50 is a flowchart illustrating a procedure for establishing a link in bi-directional one-to-one direct communication according to another embodiment of the present invention.

With reference to FIG. 50, the transmission terminal and the reception terminal perform bi-directional connection by using the slot 1 and the slot 2. It is illustrated that the resource allocation procedure and the link establishment procedure are collectively, integratedly operated.

Namely, the transmission terminal transmits a preamble to the reception terminal through the slot 1 (S1230), transmits RTS, and then transmits a DM-LEST-REQ message through the RTS data part (S1231). Thereafter, the reception terminal transmits a preamble to the transmission terminal through the slot 1 (S1232), transmits CTS, and transmits a DM-LEST-RSP message through the CTS data part (S1233). The DM-LEST-RSP message may include link establishment information. When the reception terminal receives an ACK message from the transmission terminal, the resource allocation procedure and the link establishment procedure from the transmission terminal to the reception terminal are completed (S1234). The preamble (S1230) and the preamble (S1232) may be selectively omitted.

Meanwhile, the reception terminal transmits a preamble to the transmission terminal through the slot 2 (S1235), transmits RTS, and then transmits a DM-LEST-REQ message through the RTS data part (S1236). Thereafter, the transmission terminal transmits a preamble to the reception terminal through the slot 2 (S1237), transmits CTS, and transmits a DM-LEST-RSP message through the CTS data part (S1238). The DM-LEST-RSP message may include link establishment information. When the transmission terminal receives an ACK message from the reception terminal, the resource allocation procedure and the link establishment procedure from the reception terminal to the transmission terminal are completed (S1239). The preamble (S1235) and the preamble (S1237) may be selectively omitted.

Next, a procedure for releasing a link in bi-directional one-to-one direct communication will be described.

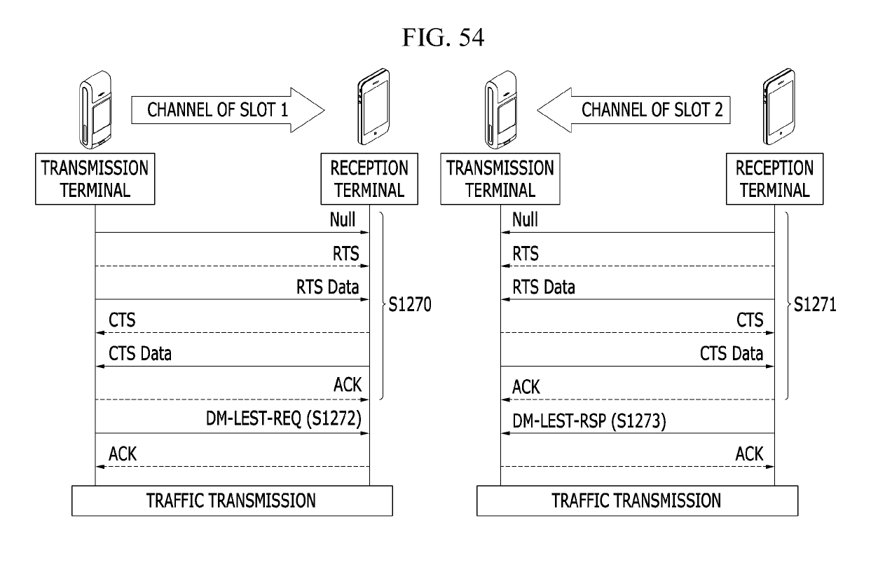

FIG. 51 is a flowchart illustrating a procedure for releasing a link in bi-directional one-to-one direct communication according to another embodiment of the present invention.

With reference to FIG. 51, when the transmission terminal determines to release a link while traffic is being transmitted between the transmission terminal and the reception terminal, the transmission terminal transmits a direct mode link release command (DM-LREL-CMD) message for releasing a link to the reception terminal through the slot 1 (S1240), and, upon receiving the DM-LREL-CMD message, the reception terminal transmits a DM-LREL-CMD message to the transmission terminal through the slot 2 (S1241). When the transmission terminal receives an ACK message from the reception terminal, the connection from the transmission terminal to the reception terminal is released, and when the reception terminal receives an ACK from the transmission terminal, the connection from the reception terminal to the transmission terminal is released. When the connection from the transmission terminal to the reception terminal and the connection from the reception terminal to the transmission terminal are both released, the releasing of the bi-directional connection is completed.

Next, a procedure for managing a flow in bi-directional one-to-one direct communication will be described.

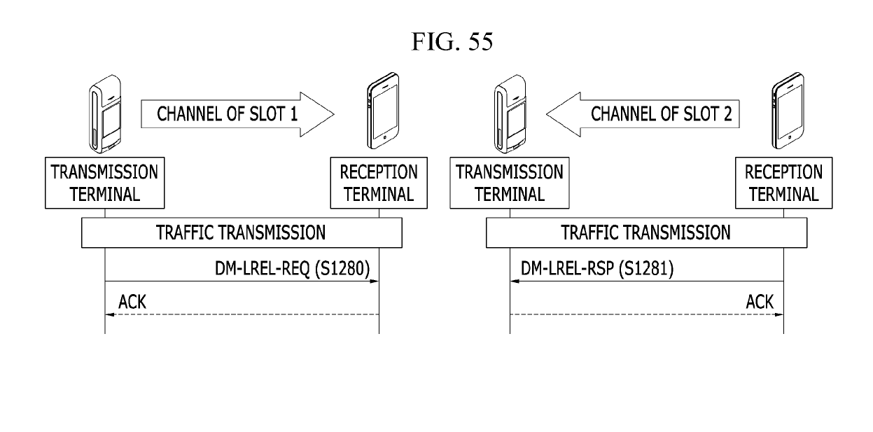

FIG. 52 is a flowchart illustrating a procedure for managing a flow in bi-directional one-to-one direct communication according to an embodiment of the present invention.

With reference to FIG. 52, when the transmission terminal determines to manage a flow while traffic is being transmitted between the transmission terminal and the reception terminal, the transmission terminal transmits a DM-DSx-CMD message to the reception terminal through the slot 1 (S1250), and upon receiving the DM-DXs-CMD message, the reception terminal transmits the DM-DSx-CMD message to the transmission terminal through the second slot (S1251). When the transmission terminal receives an ACK message from the reception terminal, the flow management of the connection from the transmission terminal to the reception terminal is completed, and when the reception terminal receives an ACK message from the reception terminal, the flow management of the connection from the reception terminal to the transmission terminal is completed. When the flow management of the connection from the transmission terminal to the reception terminal and the flow management of the connection from the reception terminal to the transmission terminal are both released, the flow management of the bi-directional connection is completed. The flow management procedure includes a configuring/changing/releasing procedure. For the flow configuring/changing/releasing procedure, DM-DSA-CMD (direct mode dynamic service addition command)/DM-DSC-CMD (direct mode dynamic service change command)/DM-DSD-CMD (direct mode dynamic service deletion command) message may be used, respectively.

Next, a measurement procedure in bi-directional one-to-one direct communication will be described.

In a direct communication bi-directional connection, the reception terminal measures a signal and transmits it to the transmission terminal, and a unidirectional one-to-one procedure is used. Here, a unidirectional measurement method is independently applied as the characteristics of a measurement function, so it is the same as the unidirectional measurement procedure.

Next, a procedure for changing a resource in bi-directional one-to-one direct communication will be described.

This is a MAC function of changing a dedicated channel used in a direct communication unidirectional connection transmitting data in a direct communication bi-directional connection and a corresponding supplementary channel, and uses a unidirectional one-to-one procedure. Here, a method for changing a resource of a unidirectional connection is independently applied as the characteristics of a resource change, so it is the same as the unidirectional resource change procedure.

A simultaneously operated bi-directional one-to-one direct communication procedure will be described. It shows a signal procedure for connecting two terminals participating in direct communication, for bi-directional communication. Here, a signal procedure in which a MAC signal message is closely associated is configured by using a bi-directionally transferred communication connection. One slot is used for each direction, so two slots are used.

Hereafter, a procedure for establishing a link in the simultaneously operated bi-directional one-to-one direct communication will be described.

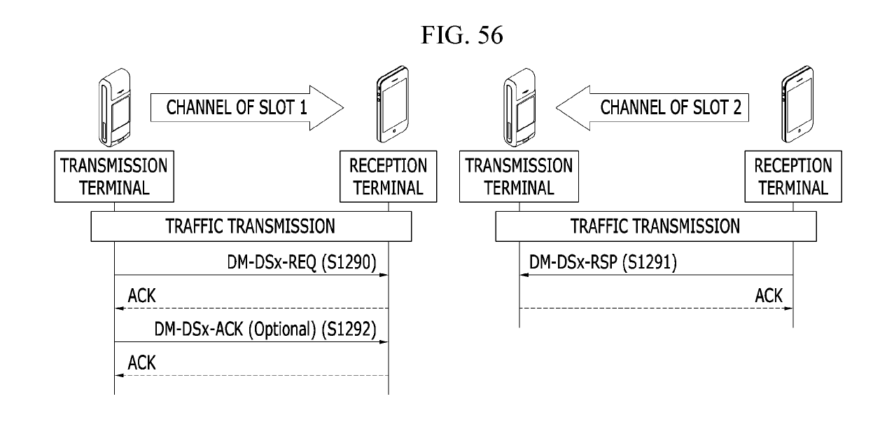

FIG. 53 is a flowchart illustrating a procedure for establishing a link in bi-directional one-to-one direct communication according to an embodiment of the present invention.

With reference to FIG. 53, the transmission terminal and the reception terminal perform a bi-directional connection by using the slot 1 and the slot 2. It is illustrated that a resource allocation procedure and a link establishment procedure are collectively, integratedly operated.

The transmission terminal transmits RTS to the reception terminal through the slot 1 and transmits a DM-LEST-REQ message through an RTS data region (S1260), and the reception terminal transmits CTS to the transmission terminal through the slot 1 and transmits a CTS data region (S1261).

Also, the reception terminal transmits RTS to the transmission terminal through the slot 2 and transmits a DM-LEST-RSP message through the RTS data region (S1262), and the transmission terminal transmits CTS to the reception terminal through the slot 2 and transmits a CTS data region (S1263).

In this manner, the transmission terminal transmits the DM-LEST-REQ message to the reception terminal through the slot 1, and upon receiving it, the reception terminal transmits a DM-LEST-REP message to the transmission terminal through the second slot.

Accordingly, the resource allocation procedure and the link establishment procedure from the transmission terminal to the reception terminal and the resource allocation procedure and the link establishment procedure from the reception terminal to the transmission terminal are completed.

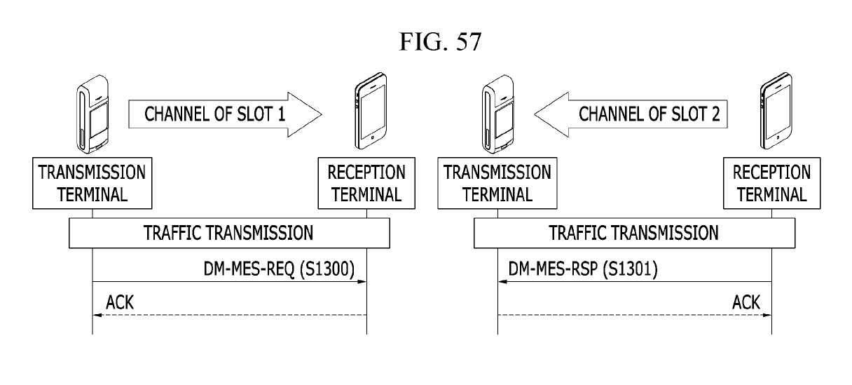

FIG. 54 is a flowchart illustrating a procedure for establishing a link in bi-directional one-to-one direct communication according to another embodiment of the present invention.

With reference to FIG. 54, the transmission terminal and the reception terminal perform a bi-directional connection by using the slot 1 and the slot 2. Here, it is illustrated that the resource allocation procedure and the link establishment procedure are independently operated.

The transmission terminal transmits RTS to the reception terminal through the slot 1 and transmits an RTS data region, and the reception terminal transmits CTS to the transmission terminal through the slot 1 and transmits a CTS data region.

Also, the reception terminal transmits RTS to the transmission terminal through the slot 2 and transmits an RTS data region, and the transmission terminal transmits CTS to the reception terminal through the slot 2 and transmits a CTS data region.

Accordingly, the resource allocation procedure (S1270) from the transmission terminal to the reception terminal and the resource allocation procedure (S1271) from the reception terminal to the transmission terminal are completed.

And, the transmission terminal transmits a DM-LEST-REQ message to the reception terminal through the slot 1 (S1272), and upon receiving it, the reception terminal transmits a DM-LEST-RSP message to the transmission terminal through the slot 2 (S1273).

Accordingly, the link establishment procedure from the transmission terminal to the reception terminal and the link establishment procedure from the reception terminal to the transmission terminal are completed.

Hereafter, a procedure for releasing a link in the simultaneously operated bi-directional one-to-one direct communication will be described.

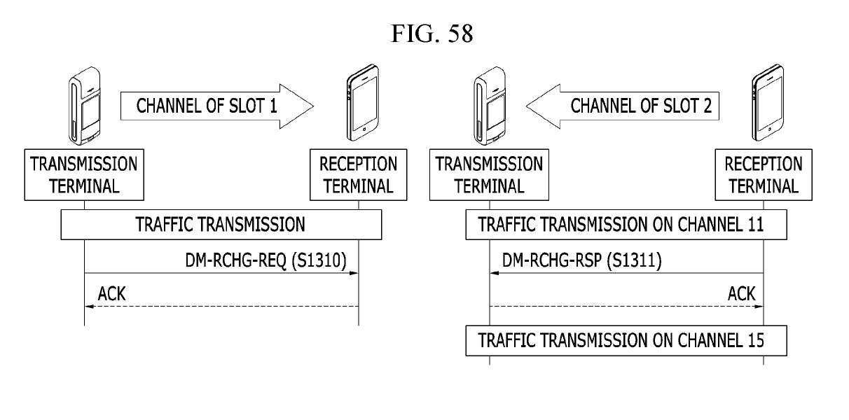

FIG. 55 is a flowchart illustrating a procedure for releasing a link in bi-directional one-to-one direct communication according to an embodiment of the present invention.

With reference to FIG. 55, when the transmission terminal determines to release a link while traffic is being transmitted between the transmission terminal and the reception terminal, the transmission terminal transmits a DM-LREL-REQ message to the reception terminal through the slot 1 (S1280), and upon receiving it, the reception terminal transmits a DM-LREL-REP message to the transmission terminal through the slot 2 (S1281). When the reception terminal receives an ACK message from the transmission terminal, the link release procedure is completed.

Hereafter, a procedure for managing a flow in simultaneously operated bi-directional one-to-one direct communication will be described.

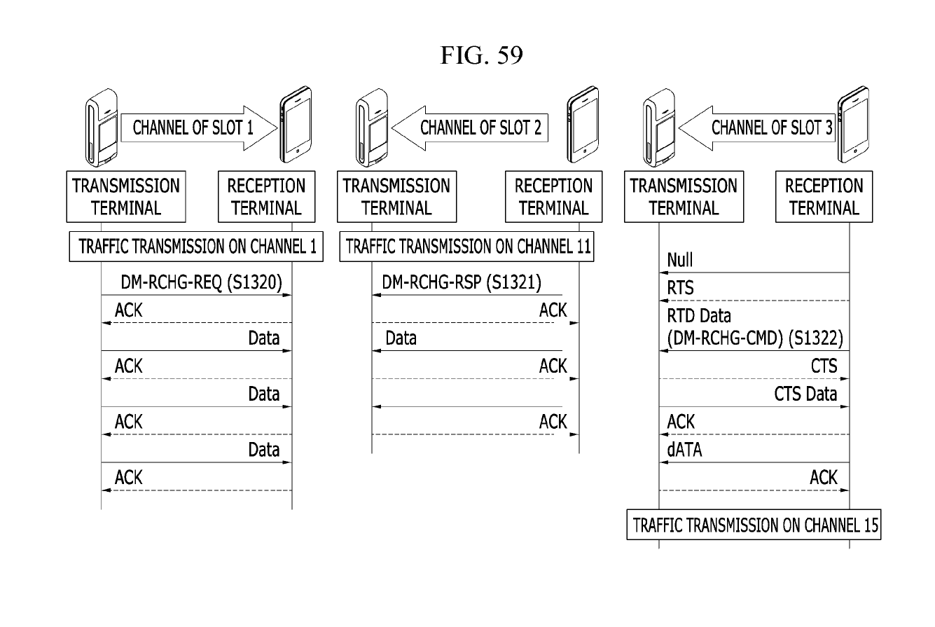

FIG. 56 is a flowchart illustrating a procedure for managing a flow in bi-directional one-to-one direct communication according to an embodiment of the present invention.

With reference to FIG. 56, when the transmission terminal determines to manage a flow while traffic is being transmitted between the transmission terminal and the reception terminal, the transmission terminal transmits a DM-DSx-REQ message to the reception terminal through the slot 1 (S1290), and upon receiving it, the reception terminal transmits a DM-DSx-REP message to the transmission terminal through the slot 2 (S1291). When the reception terminal receives an ACK message from the transmission terminal, the flow management procedure is completed. When a transmission terminal has selectively received the DM-DSx-RSP message, it may transmit a DM-DSx-ACK message to the reception terminal in response thereto (S1292). The flow management procedure includes a configuring/changing/releasing procedure, and each may use DM-DSA-REQ/RSP (direct mode dynamic service addition request/response)/DM-DSC-REQ/RSP (direct mode dynamic service change request/response)/DM-DSD-REQ/RSP (direct mode dynamic service deletion request/response) message.

Hereafter, a measurement procedure in simultaneously operated bi-directional one-to-one direct communication will be described.

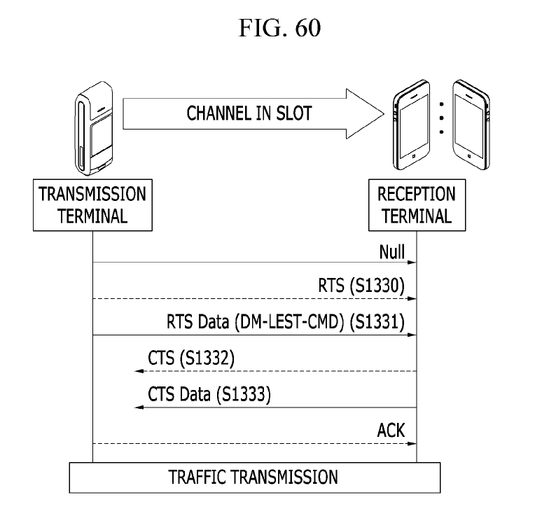

FIG. 57 is a flowchart illustrating a measurement process in bi-directional one-to-one direct communication according to an embodiment of the present invention.

With reference to FIG. 57, when the transmission terminal determines measurement while traffic is being transmitted between the transmission terminal and the reception terminal, the transmission terminal transmits a direct mode measurement request (DM-MES-REQ) message requesting a measurement to the reception terminal through the slot 1 (S1300), and upon receiving it, the reception terminal transmits a direct mode measurement response (DM-MES-RSP) message to the transmission terminal through the slot 2 (S1301).

Meanwhile, the measurement procedure in the bi-directional one-to-one direct communication may be the same as that in the unidirectional one-to-one direct communication.

Hereafter, a procedure for changing a resource in simultaneously operated bi-directional one-to-one direct communication will be described.

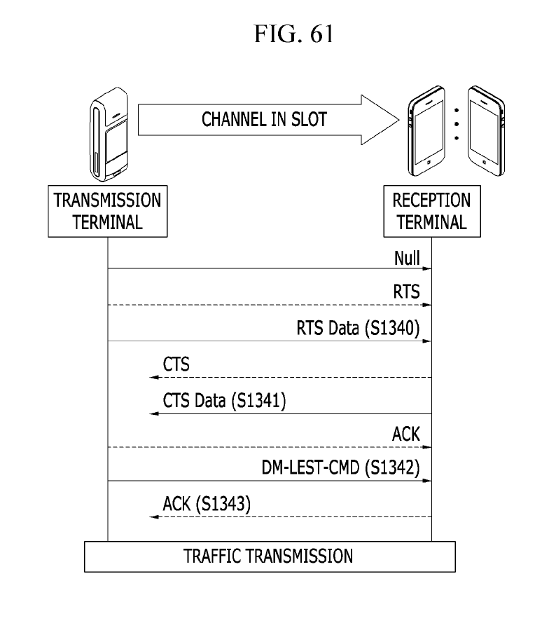

FIG. 58 is a flowchart illustrating a procedure for changing a resource in bi-directional one-to-one direct communication according to an embodiment of the present invention.

With reference to FIG. 58, when the transmission terminal determines to change a resource while traffic is being transmitted between the transmission terminal and the reception terminal, the transmission terminal transmits a DM-RCHG-REQ message requesting changing of a resource to the reception terminal through the slot 1 (S1310), and upon receiving it, the reception terminal transmits a direct mode resource change response (DM-RCHG-RSP) message to the transmission terminal through the slot 2 (S1311). The DM-RCHG-RSP message may include a changed radio resource or channel information.

FIG. 59 is a flowchart illustrating a procedure for changing a resource in bi-directional one-to-one direct communication according to another embodiment of the present invention.

With reference to FIG. 59, when the transmission terminal determines to change a resource while traffic is being transmitted between the transmission terminal and the reception terminal, the transmission terminal transmits a DM-RCHG-REQ message to the reception terminal through the slot 1 (S1320), and upon receiving it, the reception terminal transmits a DM-RCHG-RSP message to the transmission terminal through the slot 2 (S1321) and transmits a DM-RCHG-CMD message to the transmission terminal through a slot 3 (S1322). Here, the DM-RCHG-RSP message may include a changed radio resource or channel information, and the DM-RCHG-CMD message may include a radio resource change command. Accordingly, data transmitted by the reception terminal may be changed from a channel 11 of the slot 2 to a channel 15 of the slot 3.

Meanwhile, the measurement procedure in the bi-directional one-to-one direct communication may be the same as that in the unidirectional one-to-one direct communication.

Hereafter, unidirectional one-to-many direct communication will be described. A signal procedure of unidirectional one-to-many direct communication refers to a signal procedure in which a plurality of terminals (e.g., three or more) participate in a connection for transmitting data in one direction. In a direct communication frame, a slot is used for unidirectional communication connection, and a transmission terminal transmitting data and a plurality of reception terminals receiving data participate in direct communication are used. In the unidirectional communication connection, a dedicated channel and a corresponding supplementary channel may be used. A signal transmitted by the transmission terminal may be received by a plurality of reception terminals. Meanwhile, when a plurality of reception terminals respond through the same resource, the transmission terminal cannot receive them. The transmission terminal may know the presence or absence of a response signal from a resource in which the response signal is positioned. When the transmission terminal receives a response signal, the procedure may be performed based upon determination that the response signal has been properly received.

Hereinafter, a procedure for establishing a link in unidirectional one-to-many direct communication will be described.

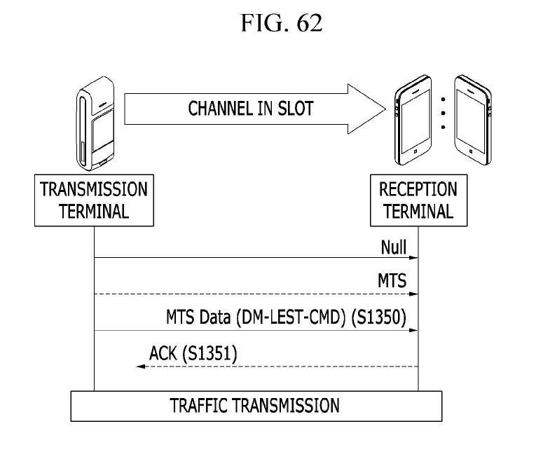

FIG. 60 is a flowchart illustrating a procedure for establishing a link in unidirectional one-to-many direct communication according to an embodiment of the present invention.

With reference to FIG. 60, the transmission terminal transmits RTS to a plurality of reception terminals (S1330) and multicasts a DM-LEST-CMD message through an RTS data region (S1331). Thereafter, the reception terminals transmit CTS to the transmission terminal (S1332) and transmit a CTS data region (S1333). When the transmission terminal receives CTS and a CTS data region from at least one reception terminal, the transmission terminal may determine that at least one of a plurality of reception terminals has received the multicast DM-LEST CMD message.

Accordingly, the resource allocation procedure and the link establishment procedure between the transmission terminal and the reception terminals are completed.

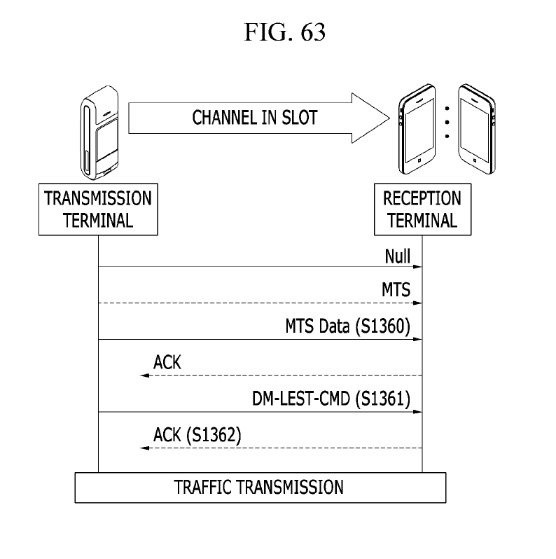

FIG. 61 is a flowchart illustrating a procedure for establishing a link in unidirectional one-to-many direct communication according to another embodiment of the present invention.

With reference to FIG. 61, the transmission terminal transmits RTS to a plurality of reception terminals and multicasts an RTS data region (S1340). Thereafter, the reception terminals transmit CTS to the transmission terminal and transmit the CTS data region (S1341). Accordingly, the resource allocation procedure between the transmission terminal and the reception terminals may be completed.

And, the transmission terminal multicasts a DM-LEST-CMD message to the plurality of reception terminals (S1342), and receives an ACK message from at least one reception terminal (S1343). Accordingly, a link establishment procedure between the transmission terminal and the reception terminals may be completed.

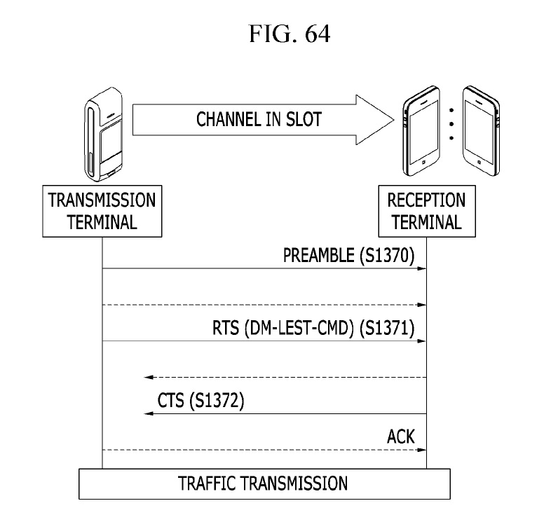

FIG. 62 is a flowchart illustrating a procedure for establishing a link in unidirectional one-to-many direct communication according to another embodiment of the present invention.

With reference to FIG. 62, the transmission terminal transmits SEND IND to a plurality of reception terminals, transmits MTS, and multicasts a DM-LEST-CMD message through an MTS data region (S1350). Thereafter, when the transmission terminal receives an ACK message (S1351), the transmission terminal may determine that at least one of the plurality of reception terminals has received the multicast DM-LEST-CMD message.

Accordingly, the resource allocation procedure and the link establishment procedure between the transmission terminal and the reception terminals may be completed.

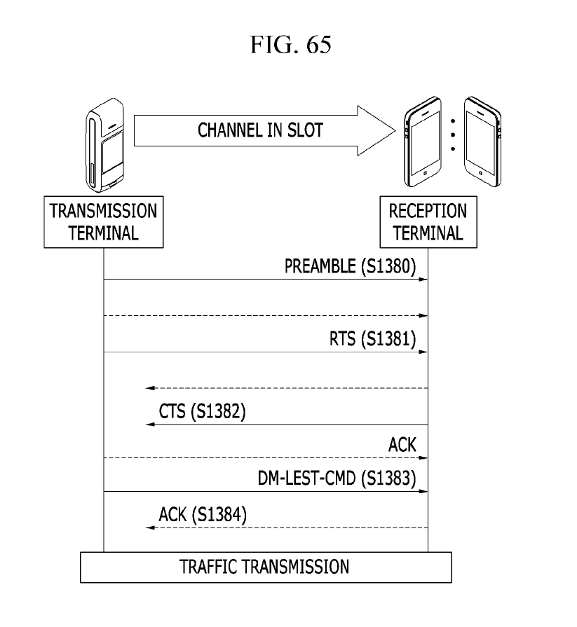

FIG. 63 is a flowchart illustrating a procedure for establishing a link in unidirectional one-to-many direct communication according to another embodiment of the present invention.

With reference to FIG. 63, the transmission terminal transmits MTS to a plurality of reception terminals and multicasts an MTS data region (S1360). When the transmission terminal receives an ACK message, the transmission terminal may determine that at least one of the plurality of reception terminals has received the multicast MTS data region. Accordingly, the resource allocation procedure between the transmission terminal and the reception terminals may be completed.

And, the transmission terminal multicasts a DM-LEST-CMD message to the plurality of reception terminals (S1361). Thereafter, when the transmission terminal receives an ACK message (S1362), the transmission terminal may determine that at least one of the plurality of reception terminals has received the multicast DM-LEST-CMD message.

Accordingly, the link establishment procedure between the transmission terminal and the reception terminals may be completed.

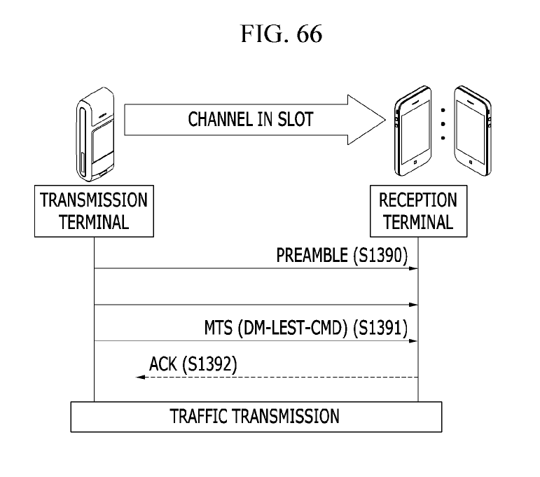

FIG. 64 is a flowchart illustrating a procedure for establishing a link in unidirectional one-to-many direct communication according to another embodiment of the present invention.

With reference to FIG. 64, the transmission terminal transmits a preamble to a plurality of reception terminals (S1370), transmits RTS, and multicasts a DM-LEST-CMD message through an RTS data region (S1371). Thereafter, when the transmission terminal receives CTS (S1372), the transmission terminal may determine that at least one of the plurality of reception terminals has received the multicast DM-LEST-CMD message.

Accordingly, the resource allocation procedure and the link establishment procedure between the transmission terminal and the reception terminals may be completed.

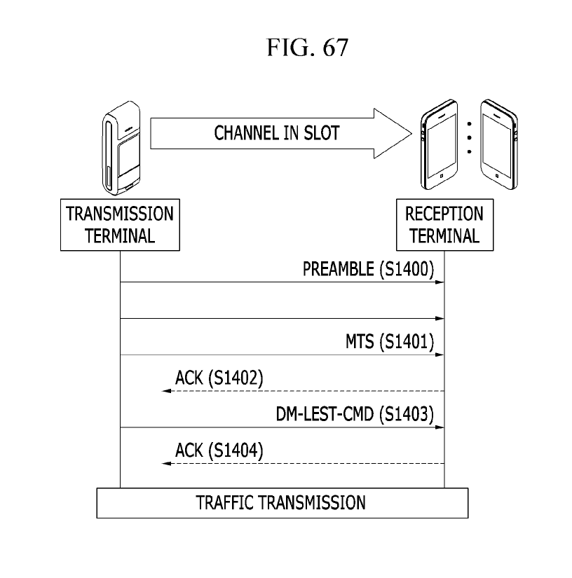

FIG. 65 is a flowchart illustrating a procedure for establishing a link in unidirectional one-to-many direct communication according to another embodiment of the present invention.

With reference to FIG. 65, the transmission terminal transmits a preamble to a plurality of reception terminals (S1380), transmits RTS, and multicasts an RTS data region (S1381). Thereafter, when the transmission terminal receives CTS (S1382), the transmission terminal may determine that at least one of the plurality of reception terminals has received the RTS data region. Accordingly, the resource allocation procedure between the transmission terminal and the reception terminals may be completed.

And, the transmission terminal multicasts a DM-LEST-CMD message to the plurality of reception terminals (S1383). Thereafter, when the transmission terminal receives an ACK message (S1384), the transmission terminal may determine that at least one of the plurality of reception terminals has received the multicast DM-LEST-CMD message.

Accordingly, the link establishment procedure between the transmission terminal and the reception terminals may be completed.

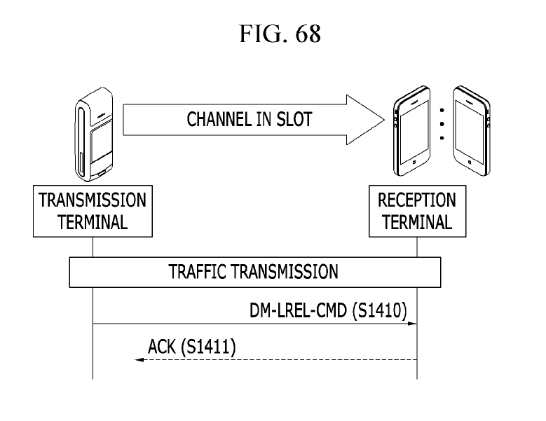

FIG. 66 is a flowchart illustrating a procedure for establishing a link in unidirectional one-to-many direct communication according to another embodiment of the present invention.

With reference to FIG. 66, the transmission terminal transmits a preamble to a plurality of reception terminals (S1390), transmits MTS, and multicasts a DM-LEST-CMD message through an MTS data region (S1391). The MTS message may use an RTS message and may be expressed by an identifier indicating a reception terminal group or an address in an RTS message internal field. Thereafter, when the transmission terminal receives an ACK message (S1392), the transmission terminal may determine that at least one of the plurality of reception terminals has received the multicast DM-LEST-CMD message. The preamble (S1390) may be selectively omitted.

Accordingly, the resource allocation procedure and the link establishment procedure between the transmission terminal and the reception terminals may be completed.

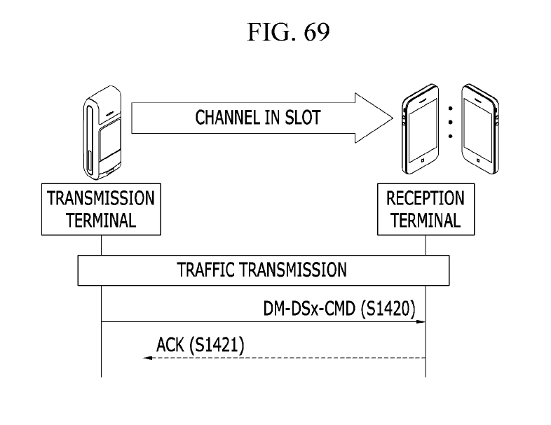

FIG. 67 is a flowchart illustrating a procedure for establishing a link in unidirectional one-to-many direct communication according to another embodiment of the present invention.

With reference to FIG. 67, the transmission terminal transmits a preamble to a plurality of reception terminals (S1400), transmits MTS, and multicasts an MTS data region (S1401). The MTS message may use an RTS message and may be expressed by an identifier indicating a reception terminal group or an address in an RTS message internal field. Thereafter, when the transmission terminal receives an ACK message (S1402), the transmission terminal may determine that at least one of the plurality of reception terminals has received the multicast MTS data region. Accordingly, the resource allocation procedure between the transmission terminal and the reception terminals may be completed. The preamble (S1400) may be selectively omitted.

And, the transmission terminal multicasts a DM-LEST-CMD message to the plurality of reception terminals (S1403)

Thereafter, when the transmission terminal receives an ACK message (S1404), the transmission terminal may determine that at least one of the plurality of reception terminals has received the multicast DM-LEST-CMD message.

Accordingly, the link establishment procedure between the transmission terminal and the reception terminals may be completed.

Next, a procedure for releasing a link in unidirectional one-to-many direct communication will be described.

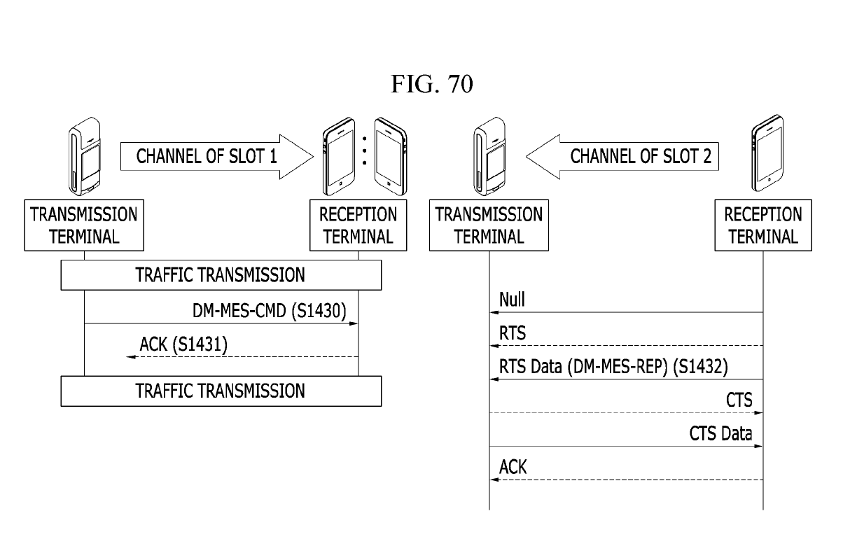

FIG. 68 is a flowchart illustrating a procedure for releasing a link in unidirectional one-to-many direct communication according to another embodiment of the present invention.

With reference to FIG. 68, when the transmission terminal determines to release a link while traffic is being transmitted between the transmission terminal and a plurality of reception terminals, the transmission terminal multicasts a direct mode link release command (DM-LREL-CMD) message instructing about releasing a link to the plurality of reception terminals (S1410). When the transmission terminal receives an ACK message (S1411), the transmission terminal may determine that at least one of the plurality of reception terminals has received the multicast DM-LREL-CMD message. Accordingly, the link establishment procedure between the transmission terminal and the reception terminals may be completed.

Next, a procedure for managing a flow in unidirectional one-to-many direct communication will be described.

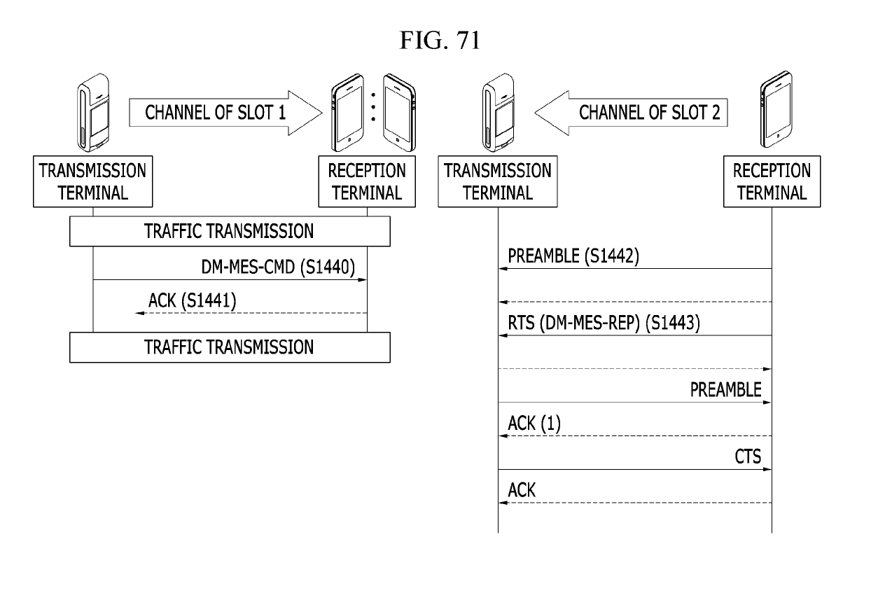

FIG. 69 is a flowchart illustrating a procedure for managing a flow in unidirectional one-to-many direct communication according to an embodiment of the present invention.

With reference to FIG. 69, when the transmission terminal determines to manage a flow while traffic is being transmitted between the transmission terminal and a plurality of reception terminals, the transmission terminal multicasts a DM-DSx-CMD message to the plurality of reception terminals (S1420). When the transmission terminal receives an ACK message (S1421), the transmission terminal may determine that at least one of the plurality of reception terminals has received the multicast DM-DSx-CMD message. Accordingly, the procedure for managing a flow between the transmission terminal and the reception terminals may be completed. The flow management procedure includes configuring/changing/releasing procedure. For the flow configuring/changing/releasing procedure, DM-DSA-CMD (direct mode dynamic service addition command)/DM-DSC-CMD (direct mode dynamic service change command)/DM-DSD-CMD (direct mode dynamic service deletion command) message may be used, respectively.

Next, a procedure for measuring a channel in unidirectional one-to-many direct communication will be described. A reception terminal may transmit a reception signal measurement value with respect to a dedicated channel resource to the transmission terminal.

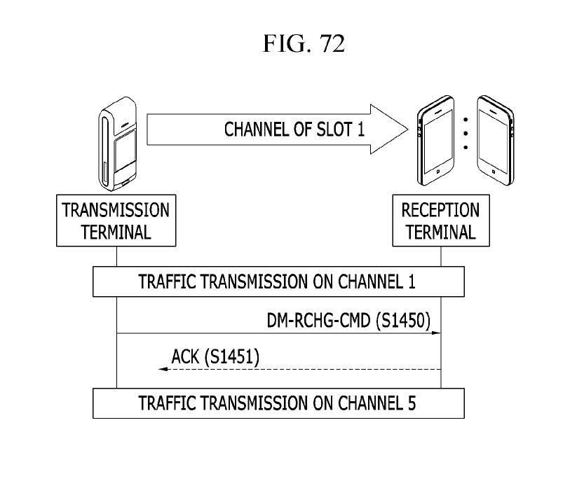

FIG. 70 is a flowchart illustrating a procedure for measuring a channel in unidirectional one-to-many direct communication according to an embodiment of the present invention.

With reference to FIG. 70, the transmission terminal requests a channel measurement from a plurality of reception terminals. Namely, while traffic is being transmitted between the transmission terminal and the reception terminal, the transmission terminal transmits a direct mode measurement command (DM-MES-CMD) message instructing about a channel measurement to the plurality of reception terminals (S1430). When the transmission terminal receives an ACK message (S1431), the transmission terminal may determine that at least one of the plurality of reception terminals has received the multicast DM-MES-CMD message. The transmission terminal may request at least one of a channel measurement method, a channel measurement report period, and a channel measurement report method from the reception terminals through the DM-MES-CMD message.

Meanwhile, each of the reception terminals reports a measurement value through a different slot from the slot through which the transmission terminal has transmitted. Namely, each of the reception terminals transmits RTS to the transmission terminal, and transmits a DM-MES-REP message for a measurement report through the RTS data region (S1432). The DM-MES-REP message may include a measurement value of each channel. The transmission terminal may receive a signal amplitude measurement value of each channel from the plurality of reception terminals.

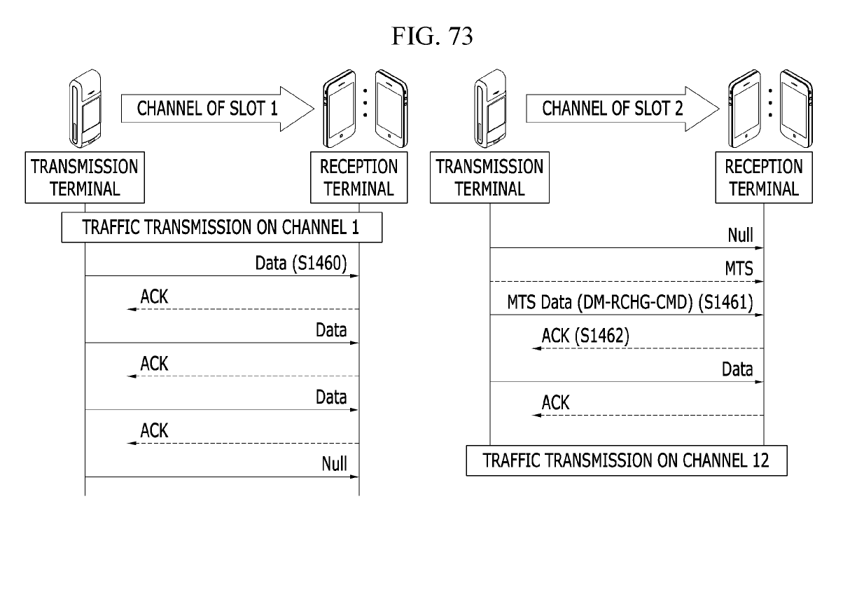

FIG. 71 is a flowchart illustrating a procedure for measuring a channel in unidirectional one-to-many direct communication according to another embodiment of the present invention.

With reference to FIG. 71, a channel measurement is requested from a plurality of reception terminals. Namely, while traffic is being transmitted between the transmission terminal and the reception terminals, the transmission terminal transmits a DM-MES-CMD message to the plurality of reception terminals (S1440). When the transmission terminal receives an ACK message (S1441), the transmission terminal may determine that at least one of the plurality of reception terminals has received the multicast DM-LEST-CMD message. The transmission terminal may request at least one of a channel measurement method, a channel measurement report period, and a channel measurement report method from the reception terminals through the DM-MES-CMD message.

Meanwhile, each of the reception terminals reports a measurement value through a different slot from the slot through which the transmission terminal has transmitted. Namely, each of the reception terminals transmits a preamble to the transmission terminal (S1442), transmits RTS, and transmits a DM-MES-REP message through the RTS data region (S1443). The DM-MES-REP message may include a measurement value of each channel. The transmission terminal may receive a signal amplitude measurement value of each channel from the plurality of reception terminals. The preamble (S1442) may be selectively omitted.

Next, a procedure for changing a resource in unidirectional one-to-many direct communication will be described. Through this, a dedicated channel and a corresponding supplementary channel used in unidirectional connection may be changed. The change of the transport channels may be determined by the transmission terminal. To this end, the reception terminal may request a DM-RCHG-REQ/RSP message including a new dedicated channel from the transmission terminal by using a bi-directional 1:1 resource change procedure in a different slot in consideration of a measured radio environment.

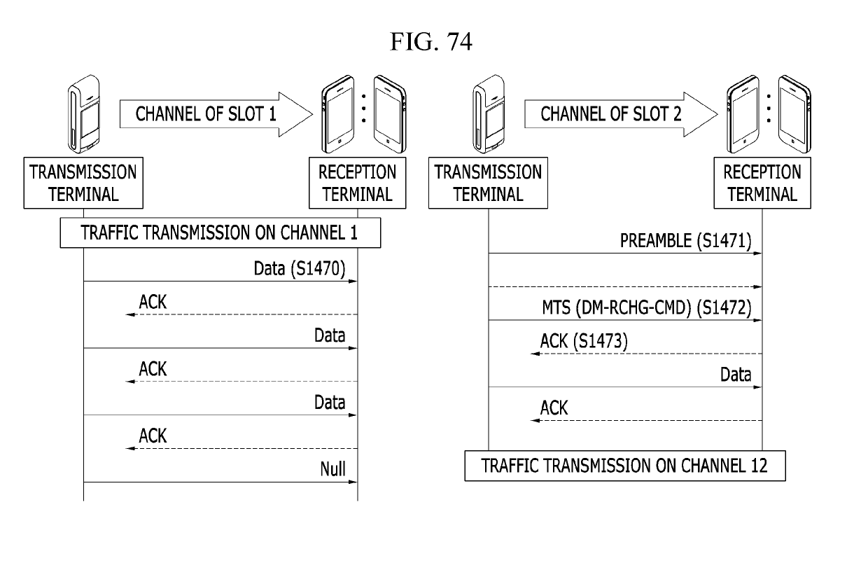

FIG. 72 is a flowchart illustrating a procedure for changing a resource in unidirectional one-to-many direct communication according to an embodiment of the present invention. Here, a change of a dedicated channel within the same slot is illustrated.

With reference to FIG. 72, when the transmission terminal determines to change a resource while traffic is being transmitted between the transmission terminal and reception terminals, the transmission terminal multicasts a direct mode resource change command (DM-RCHG-CMD) message for instructing about changing a resource to the plurality of reception terminals (S1450). The DM-RCHG-CMD message may include information regarding a new dedicated channel. When the transmission terminal receives an ACK message (S1451), the transmission terminal may determine that at least one of the plurality of reception terminals has received the multicast DM-RCHG-CMD message. Accordingly, the resource change (from channel 1 to channel 5) procedure within the same slot is completed.

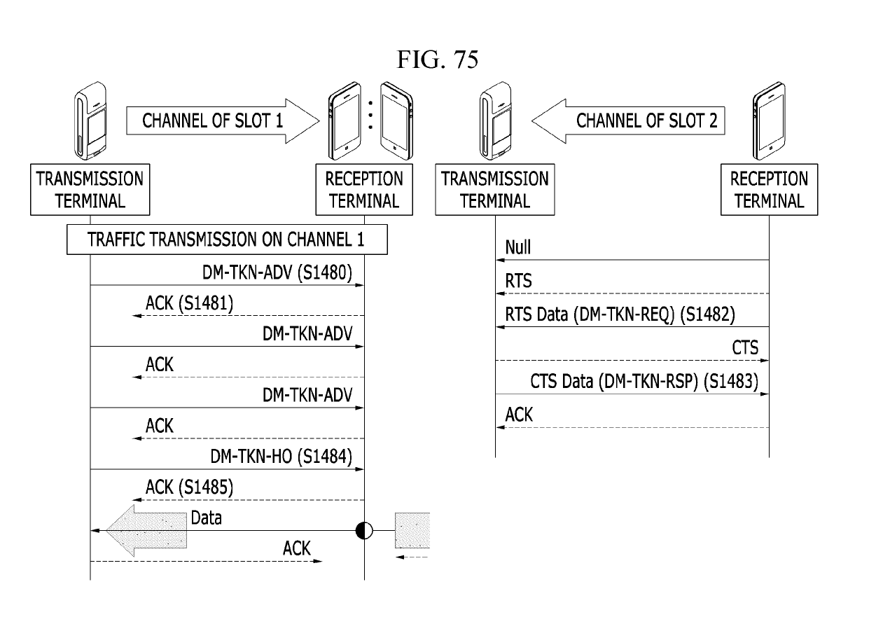

FIG. 73 is a flowchart illustrating a procedure for changing a resource in unidirectional one-to-many direct communication according to another embodiment of the present invention. Here, a change of a dedicated channel when a dedicated channel requested by a reception terminal is positioned in a different slot from that of a dedicated channel in which data is currently transmitted is illustrated. Here, a data transmission procedure and a resource change procedure may be carried out side by side.

With reference to FIG. 73, the transmission terminal multicasts data to a plurality of reception terminals through a channel 1 of the slot 1 (S1460).

At the same time, the transmission terminal multicasts MTS to the plurality of reception terminals through the slot 2, and multicasts a DM-RCHG-CMD message through the MTS data region (S1461). When the transmission terminal receives an ACK message (S1462), the transmission terminal may determine that at least one of the plurality of reception terminals has received the multicast DM-RCHG-CMD message. Accordingly, the resource change (from channel 1 of slot 1 to channel 12 of slot 2) procedure within the same slot is completed.

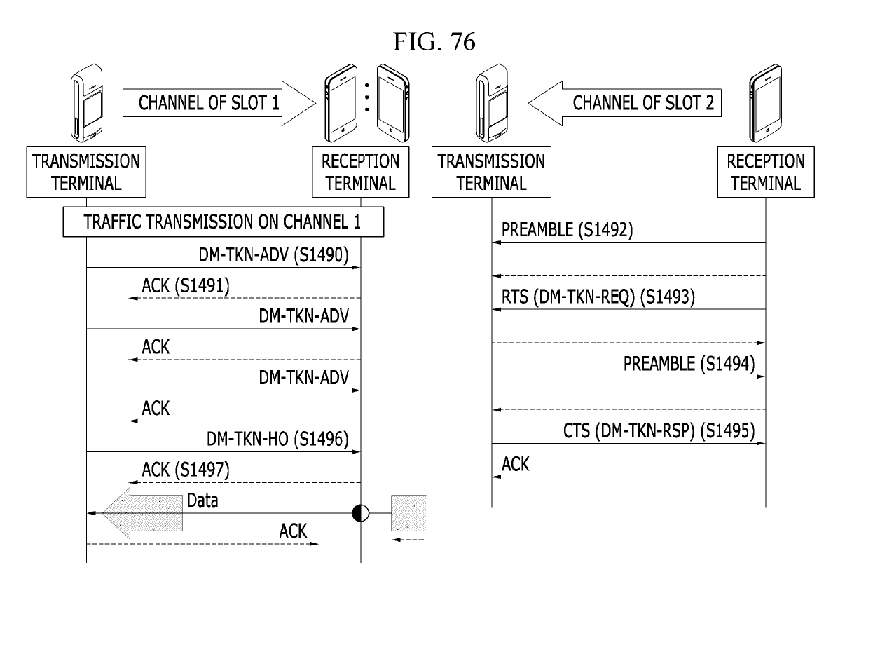

FIG. 74 is a flowchart illustrating a procedure for changing a resource in unidirectional one-to-many direct communication according to another embodiment of the present invention. Here, a change of a dedicated channel when a dedicated channel requested by a reception terminal is positioned in a different slot from that of a dedicated channel in which data is currently transmitted is illustrated. Here, a data transmission procedure and a resource change procedure may be carried out side by side.

With reference to FIG. 74, the transmission terminal multicasts data to a plurality of reception terminals through the channel 1 of the slot 1 (S1470).

At the same time, the transmission terminal transmits a preamble to the plurality of reception terminals through the slot 2 (S1471), and multicasts a DM-RCHG-CMD message through the MTS data region (S1472). When the transmission terminal receives an ACK message (S1473), the transmission terminal may determine that at least one of the plurality of reception terminals has received the multicast DM-RCHG-CMD message. Accordingly, the resource change (from channel 1 of slot 1 to channel 12 of slot 2) procedure within the same slot is completed. The preamble (S1471) may be selectively omitted. The MTS message may use an RTS message and may be expressed by an identifier indicating a reception terminal group or an address in an RTS message internal field.

Next, a procedure for managing a token in unidirectional one-to-many direct communication will be described. The token management procedure is a procedure for changing a transmission and reception direction of data while using allocated radio resource as it is for a unidirectional direct communication connection. The authority to transmit a signal through radio resource refers to a token. A terminal having a token is eligible to transmit a signal. The token can be owned by a single terminal, and the remaining terminals receive a signal through a radio resource.

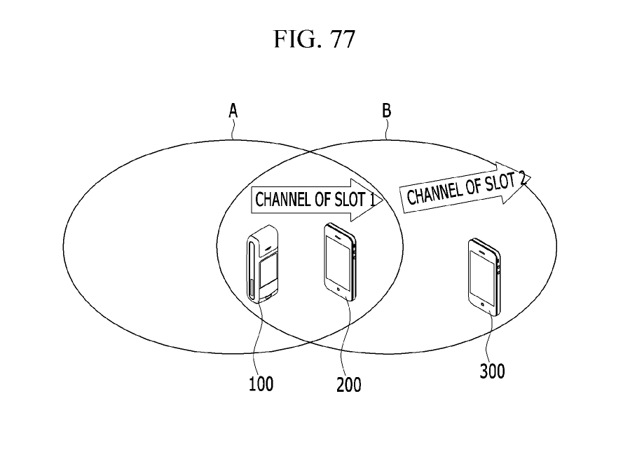

FIG. 75 is a flowchart illustrating a procedure for managing a token according to an embodiment of the present invention.

With reference to FIG. 75, a transmission terminal having a token announces token information to a plurality of reception terminals through a direct mode token advertisement (DM-TKN-ADV) message for announcing a token (S1480), thus informing that the token is available. When the transmission terminal receives an ACK message (S1481), the transmission terminal may determine that at least one of the plurality of reception terminals has received the multicast DM-TKN-ADV message.

Meanwhile, a terminal that wants to have the token, among the plurality of reception terminals, transmits a direct mode token request (DM-TKN-REQ) message requesting a token to the transmission terminal (S1482) and receives a DM-TKN-RSP message from the transmission terminal (S1483). Here, the reception terminal may use a different slot from the slot in which the DM-TKN-ADV message is transmitted. Namely, the procedure for requesting a token may be performed as a unidirectional one-to-one procedure through a slot other than the slot 1 set for unidirectional one-to-many connection. To this end, the reception terminal may transmit a DM-TKN-REQ message through an RTS data region and receive the DM-TKN-RSP message through a CTS data region.

Then, the transmission terminal determines a reception terminal to which the token is to be transferred, and announces token information to the plurality of reception terminals through a direct mode token handover (DM-TKN-HO) message informing about the token transfer (S1484). When an ACK message is received (S1485), the token management procedure may be completed.

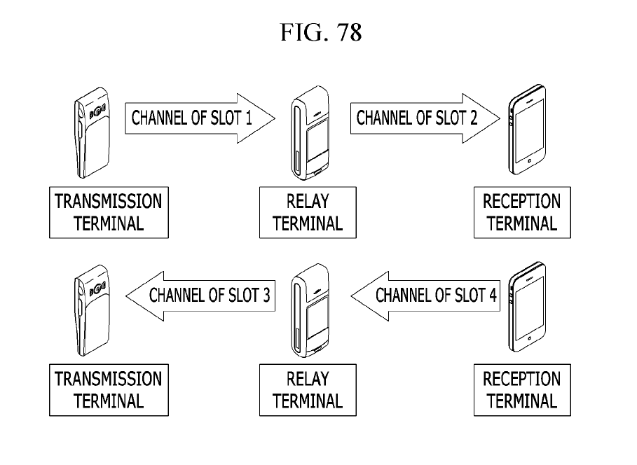

FIG. 76 is a flowchart illustrating a procedure for managing a token according to another embodiment of the present invention.

With reference to FIG. 76, a transmission terminal having a token announces token information to a plurality of reception terminals through a DM-TKN-ADV message (S1490), thus informing that the token is available. When the transmission terminal receives an ACK message (S1491), the transmission terminal may determine that at least one of the plurality of reception terminals has received the multicast DM-TKN-ADV message.

Meanwhile, a terminal that wants to have the token, among the plurality of reception terminals, transmits a preamble to the transmission terminal (S1492), transmits a DM-TKN-REQ message through RTS (S1493), receives a preamble from the transmission terminal (S1494), and receives a DM-TKN-RSP message through CTS (S1495). Here, the reception terminal may use a different slot from the slot in which the DM-TKN-ADV message is transmitted. Namely, the procedure for requesting a token may be performed as a unidirectional one-to-one procedure through a slot other than the slot 1 set for unidirectional one-to-many connection. The preamble (S1492) may be selectively omitted.

Then, the transmission terminal determines a reception terminal to which the token is to be transferred, and announces token information to the plurality of reception terminals through a DM-TKN-HO message (S1496). When an ACK message is received (S1497), the token management procedure may be completed.

Next, content of relaying two or more direct communication links by a terminal will be described.

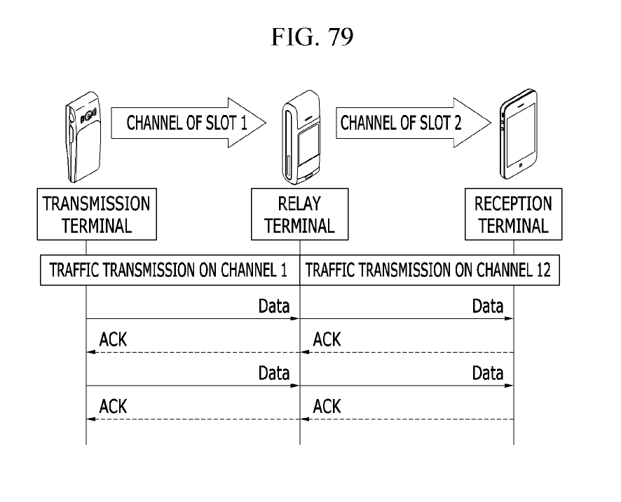

FIGS. 77 and 78 are views showing an environment in which a terminal relays a direct communication link, and FIG. 79 is a flowchart illustrating a procedure for relaying a direct communication link.

With reference to FIG. 77, a direct communication link (channel of slot 1) for a relay terminal 100 is established in relation to a transmission terminal 200, and a direct communication link (channel of slot 2) for the relay terminal 100 is established in relation to a reception terminal 300. The relay terminal may be positioned in a region under coverage A of the transmission terminal and coverage B of the reception terminal. As shown in FIG. 79, the relay terminal receives data transmitted by the transmission terminal through the direct communication link and transmits the data to the reception terminal through a different direct communication link. In this manner, two direct communication links may be established in the direct communication environment in which the relay terminal participates. The two direct communication links in the communication environment in which the relay terminal participates may be operated in exclusive slots. A link establishment, a link release, a flow management, a measurement, a resource change, and a token management are independent for each of the direct communication links, but when the procedures are cooperatively operated, performance (time delay and resource usage) of the relay function can be enhanced.

The direct communication environment in which the relay terminal participates may have at least one transmission characteristic among one-to-one relay unidirectional transmission (a unidirectional one-to-one direct communication link and a unidirectional one-to-one direct communication link), one-to-one relay bi-directional transmission (a bi-directional one-to-one direct communication link and a bi-directional one-to-one direct communication link), and one-to-many relay unidirectional transmission (a unidirectional one-to-one direct communication link and a unidirectional one-to-many direct communication link, or a unidirectional one-to-many direct communication link and a unidirectional one-to-many direct communication link). FIG. 78 illustrates one-to-one relay bi-directional transmission characteristics. As shown in FIG. 78, transmission directions of a total of four slots can be known. Data may be transmitted in one direction through each slot.

Hereinafter, a procedure for broadcasting and obtaining relay information in the direct communication environment in which the relay terminal participates is described.

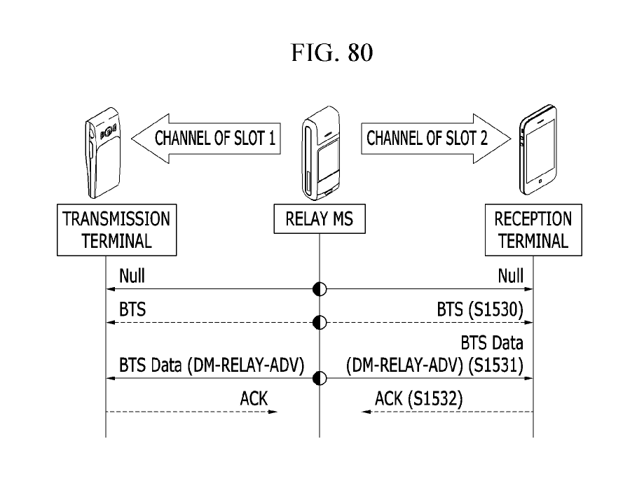

FIG. 80 is a flowchart illustrating a procedure for broadcasting relay information according to an embodiment of the present invention.

With reference to FIG. 80, the relay terminal transmits BTS to the transmission terminal and the reception terminal (S1530) and transmits a direct mode relay advertisement (DM-RELAY-ADV) message including relay information through a BTS data region (S1531). When the transmission terminal and the reception terminal transmit an ACK message with respect to the DM-RELAY-ADV message (S1532), the relay information broadcast procedure is completed.

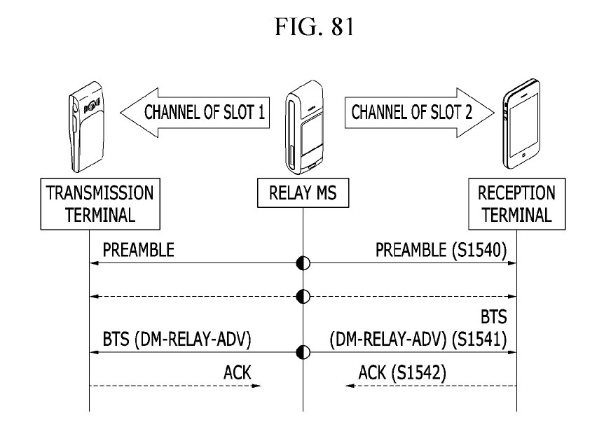

FIG. 81 is a flowchart illustrating a procedure for broadcasting relay information according to another embodiment of the present invention.

With reference to FIG. 81, the relay terminal transmits a preamble to the transmission terminal and the reception terminal (S1540), transmits BTS, and transmits a DM-RELAY-ADV message including relay information through a BTS data region (S1541). When the transmission terminal and the reception terminal transmit an ACK message with respect to the DM-RELAY-ADV message (S1542), the relay information broadcast procedure is completed. The BTS message may use an RTS message and may be expressed by an identifier indicating a reception terminal group or an address in an RTS message internal field. The preamble (S1540) may be selectively omitted.

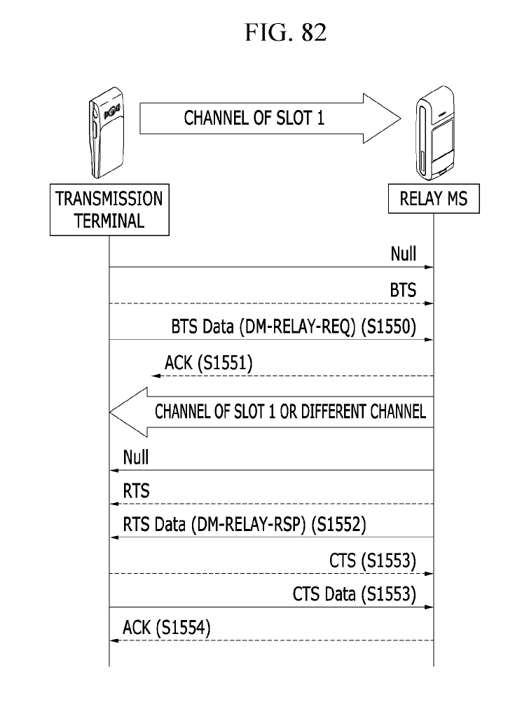

FIG. 82 is a flowchart illustrating a procedure for obtaining relay information according to an embodiment of the present invention.

With reference to FIG. 82, the transmission terminal or the reception terminal transmits BTS, and broadcasts or multicasts a direct mode relay request (DM-RELAY-REQ) message requesting relay information through the BTS data region (S1550). When the transmission terminal or the reception terminal receives an ACK message (S1551), it may be considered that the DM-RELAY-REQ message has been successfully transmitted to at least one relay terminal.

Thereafter, the relay terminal transmits RTS to the terminal which has transmitted the DM-RELAY-REQ message, and transmits a direct mode relay response (DM-RELAY-RSP) message through the RTS data region (S1552). In this manner, the DM-RELAY-RSP message may be transmitted in a unicast manner. When a plurality of relay terminals receive the DM-RELAY-REQ message from the transmission terminal and the reception terminal, each of the relay terminals may transmit the DM-RELAY-RSP message according to a one-to-one procedure. When the transmission terminal or the reception terminal transmits CTS to the relay terminal (S1553) and receives an ACK message (S1554), the relay information requesting and obtaining procedure may be completed.

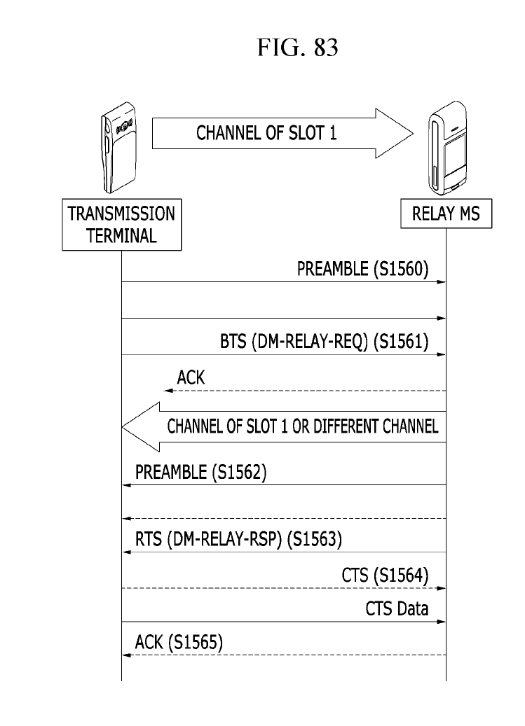

FIG. 83 is a flowchart illustrating a procedure for obtaining relay information according to another embodiment of the present invention.

With reference to FIG. 83, the transmission terminal or the reception terminal transmits a preamble to the relay terminal (S1560), transmits BTS, and transmits a DM-RELAY-REQ message requesting relay information through the BTS data region (S1561). The DM-RELAY-REQ message may be broadcast or multicast. Then, the relay terminal transmits a preamble to the terminal which has transmitted the DM-RELAY-REQ message (S1562), transmits RTS, and transmits a DM-RELAY-RSP message through the RTS data region (S1563). In this manner, the DM-RELAY-RSP message may be transmitted in a unicast manner.

When a plurality of relay terminals receive the DM-RELAY-REQ message from the transmission terminal and the reception terminal, each of the relay terminals may transmit the DM-RELAY-RSP message according to a one-to-one procedure. When the transmission terminal or the reception terminal transmits CTS to the relay terminal (S1564) and receives an ACK message (S1565), the relay information requesting and obtaining procedure may be completed. The BTS message may use an RTS message and may be expressed by an identifier indicating a reception terminal group or an address in an RTS message internal field. The preamble (S1560) may be selectively omitted.

Next, a relay signal procedure in a direct communication environment in which the relay terminal participates will be described. Direct communication links in the direct communication environment in which the relay terminal participates are independently configured. Accordingly, a signal procedure and a traffic transmission are independently configured for each direct communication link. Types of applied direct communication links include links described in a unidirectional one-to-one procedure, a bi-directional one-to-one procedure, and a unidirectional one-to-many procedure, and a corresponding signal procedure may be applied to each link.

Hereinafter, a procedure for managing a token by the relay terminal will be described.

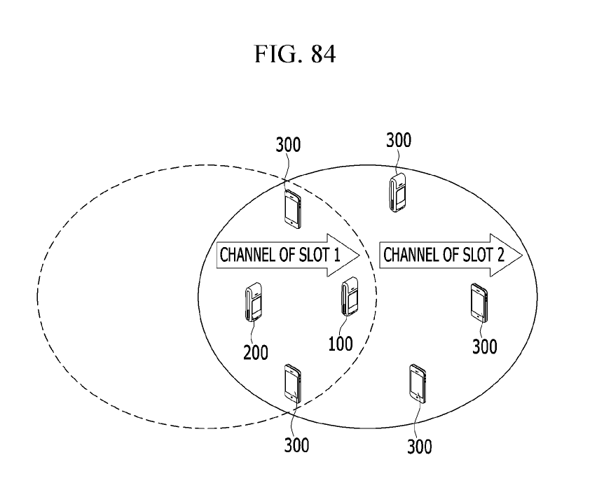

To this end, a unidirectional one-to-many relay environment, in which the direct communication link between the transmission terminal and the relay terminal is a unidirectional one-to-one direct communication link, and the direct communication link between the relay and the plurality of reception terminals is a unidirectional one-to-many direct communication link, is assumed. FIG. 84 is a view showing an example of a unidirectional one-to-many relay environment. With reference to FIG. 84, when the transmission terminal 200 transmits data to the relay terminal 100, the relay terminal broadcasts or multicasts the data received from the transmission terminal 200 to the plurality of reception terminals 300. However, the present invention is not limited thereto, and a broadcasting or multicasting environment may be configured between the transmission terminal and the relay terminal.

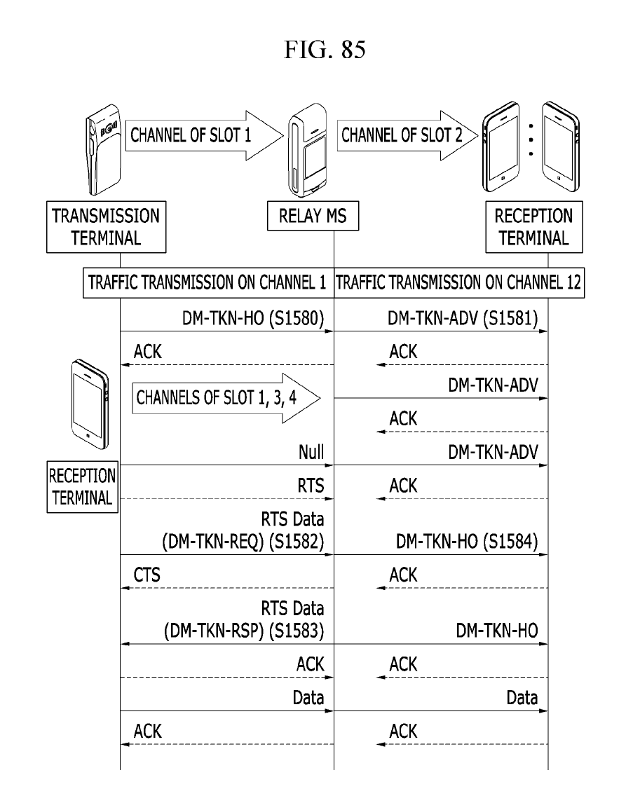

FIG. 85 is a flowchart illustrating a procedure for managing a token by a relay terminal according to an embodiment of the present invention.

With reference to FIG. 85, when the transmission terminal wants to return a token, the transmission terminal transmits a direct mode token handover (DM-TKN-HO) message informing about a token transfer to the relay terminal (S1580). Then, the relay terminal continuously transmits a direct mode token advertisement (DM-TKN-ADV) message announcing that the token is available to the plurality of reception terminals (S1581). In this case, the slot between the transmission terminal and the relay terminal and that between the relay terminal and the reception terminal may be different. Thereafter, a reception terminal that wants to have the token exchanges DM-TKN-REQ/RSP messages with the relay terminal (S1582, S1583)

Here, the reception terminal may use a different slot from the slot through which the relay terminal transmits the DM-TKN-ADV to the other reception terminals. To this end, the DM-TKN-REQ message and the DM-TKN-RSP message may be transmitted through the RTS data region and the CTS data region, respectively. Meanwhile, upon receiving the DM-TKN-REQ message from the reception terminal, when the relay terminal determines to transfer the token, the relay terminal transmits a DM-TKN-HO message informing about the token transfer to the plurality of reception terminals (S1584), thus completing the token management procedure. Thereafter, a terminal, which has received the token, transmits data to the relay terminal, and the relay terminal transmits the data to the other terminals.

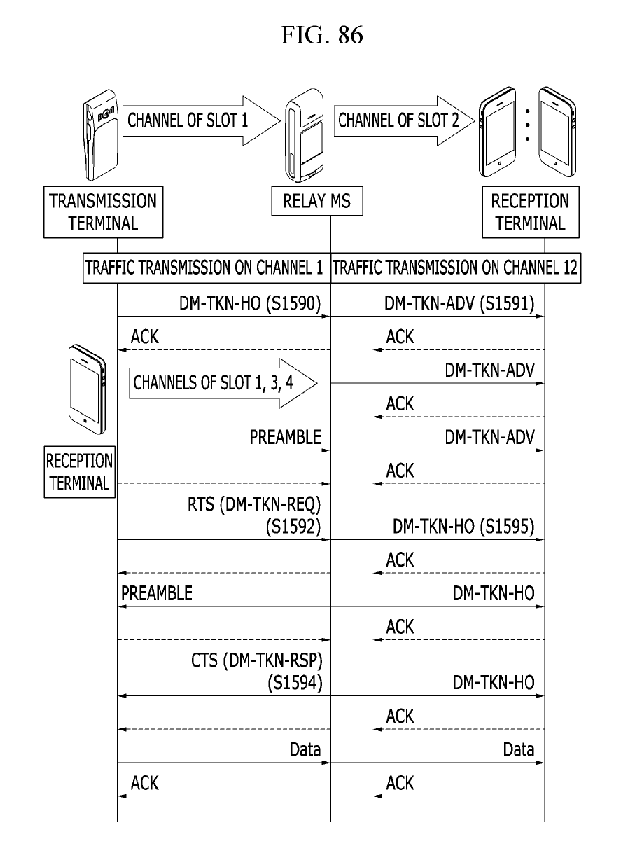

FIG. 86 is a flowchart illustrating a procedure for managing a token by a relay terminal according to another embodiment of the present invention.

With reference to FIG. 86, when the transmission terminal wants to return a token, the transmission terminal transmits a DM-TKN-HO message to the relay terminal (S1590). Then, the relay terminal continuously transmits a DM-TKN-ADV message to the plurality of reception terminals (S1591). In this case, the slot between the transmission terminal and the relay terminal and that between the relay terminal and the reception terminal may be different. Thereafter, a reception terminal that wants to have the token transmits a preamble to the relay terminal (S1592) and exchanges DM-TKN-REQ/RSP messages with the relay terminal (S1593, S1594). Here, the reception terminal may use a different slot from the slot through which the relay terminal transmits the DM-TKN-ADV to the other reception terminals. The relay terminal transmits a DM-TKN-HO message to the plurality of reception terminals (S1595), thus completing the token management procedure. Thereafter, a terminal, which has received the token, transmits data to the relay terminal, and the relay terminal transmits the data to the other terminals. The preamble may be selectively omitted.

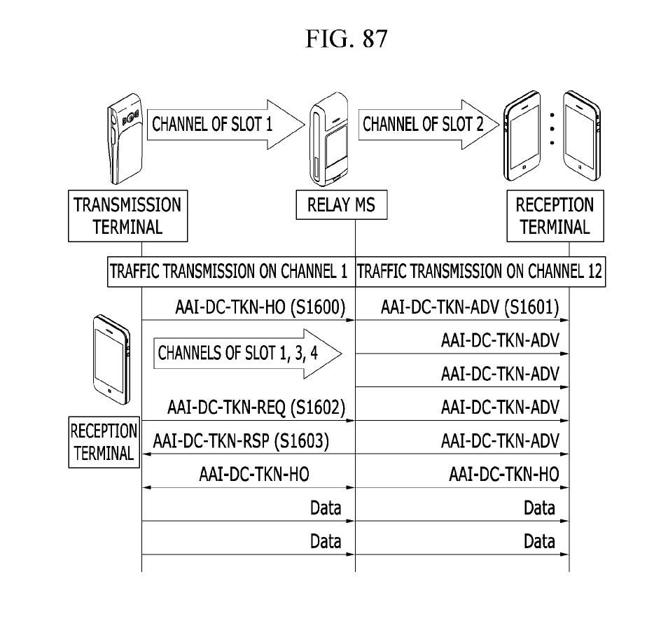

FIG. 87 is a flowchart illustrating a procedure for managing a token by a relay terminal according to another embodiment of the present invention.

With reference to FIG. 87, when the transmission terminal wants to terminate a data transmission and return a token, the transmission terminal transmits a token handover (AAI-DC-TKN-HO) message for transferring the token to the relay terminal (S1600). Here, the AAI-DC-TKN-HO (direct communication token handover) message may be used together with the DM-TKN-HO message. Then, the relay terminal manages the token. In this state, no terminal has a token, so none of the terminals can transmit data. The relay terminal continuously transmits a token advertisement (AAI-DC-TKN-ADV) message announcing that the token is available to the plurality of reception terminals (S1601), thus informing about the availability of the token. Here, the AAI-DC-TKN-ADV (direct communication token advertisement) message may be used together with the DM-TKN-ADV message. Thereafter, a reception terminal that wants to have the token exchanges AAI-DC-TKN-REQ/RSP messages (or DM-TKN-REQ/RSP messages) with the relay terminal (S1602, S1603). Here, the reception terminal may use a different slot from the slot through which the relay terminal transmits the AAI-DC-TKN-ADV to the other reception terminals. And, the relay terminals transmits the AAI-DC-TKN-HO message to the plurality of reception terminals (S1604), thus informing that the token has been transferred. The DM-TKN-HO message may include an identifier of the terminal which has acquired the token. Thereafter, the terminal, which has received the token, transmits data to the relay terminal, and the relay terminal transmits the data to the other terminals.

Further, the relay terminal may manage the token in a bypass manner. This may be applied to a case in which the relay terminal relaying two hops supports only two terminals. For example, when the transmission terminal transmits the AAI-DC-TKN-HO message to the relay terminal, the relay terminal transmits it to the reception terminal, whereby the reception terminal acquires the token. Accordingly, the terminal which has acquired the token can transmit data.

Meanwhile, the relay terminal may transmit an AAI-DC-RELAY-ADV message to the terminals by T_{relayadv} period. In this case, the AAI-DC-RELAY-ADV message may include an identifier (DCTID) of the relay terminal. The terminal determines whether to request relaying from the relay terminal according to a Relay Status field included in the AAI-DC-RELAY-ADV message. A Relay Traffic Priority field controls priority of the relay terminal requested by the terminal. Only when the priority is high may the terminal transmit data to the relay terminal.

Meanwhile, the terminal, which requests relaying, may transmit AAI-DC-RELAY-REQ to the relay terminal, and when the relay terminal receives the AAI-DC-RELAY-REQ, it may transmit an AAI-DC-RELAY-RSP message. The relay terminal may establish a relay link by using an AAI-DC-LEST-REQ/RSP message or AAI-DC-LEST-CMD message with a target terminal.

In order to release the link, the AAI-DC-LREL-CMD message is used and can be applied to the two direct communication links relayed by the relaying HR-MS.

Hereinafter, message formats of control messages for a direct communication signal procedure will be described. Table 2 shows outlines of messages defined in the signaling procedure for unidirectional one-to-one direct communication, the signaling procedure for bi-directional one-to-one direct communication, and the signaling procedure for unidirectional one-to-many direct communication described in the present disclosure.

TABLE 2

| | Unidirectional | Bi-directional | Unidirectional |
|---|---|---|---|
| Procedure | procedure | procedure | procedure |
| name | message (1:1) | message (1:1) | message (1:N) |
| Link | DM-LEST-CMD | DM-LEST- | DM-LEST-CMD |
| establishment | DM-LEST- | REQ/RSP | |
| | REQ/RSP | | |
| Link release | DM-LREL-CMD | DM-LREL- | DM-LREL-CMD |
| | | REQ/RSP | |
| Flow | DM-DSx-CMD | DM-DSx-REQ/ | DM-DSx-CMD |
| management | | RSP/ACK | |
| Measurement | DM-SCN- | DM-SCN- | DM-SCN-CMD |
| | CMD+CQIIND | REQ/RSP | |
| | DM-SCN-REP | | |
| Resource | RCHGIND+DM- | DM-RCHG- | DM-RCHG-CMD |
| management | RCHG-CMD | REQ/RSP | |
| Information | | | DM-MS-ADV |
| broadcast | | | |
| Token | DM-TKN-HO | DM-TKN- | DM-TKN-HO |
| management | DM-TKN- | REQ/RSP | DM-TKN-ADV |
| | REQIND/HO | | |

Table 3 describes fields of a DM-LEST-REQ (which may be used together with AAI-DC-LEST-REQ) message.

TABLE 3

| | Size | | |
|---|---|---|---|
| Field | (bits) | Value/Description | Condition |
| Link Change | 4 | The change count of this | Shall always |
| Count | | transaction assigned by the | be present |
| | | sender. If new transaction | |
| | | is started, Link Change | |
| | | Count is incremented by | |
| | | one (modulo 16) by the | |
| | | sender. | |
| For (i = 0; | | N Flow Est is the number | |
| i < N Flow Est; | | of flows on which the | |
| i++) { | | sender of this message | |
| | | sends MAC PDUs. | |
| | | Range [0 . . . 1] | |
| FID | 4 | Flow identifier assigned | |
| | | by the sink of packets on | |
| | | the flow | |
| Traffic Priority | 3 | 0 to 7: Higher numbers | |
| | | indicate higher priority | |
| | | Default: 0 | |
| CS Specification | 8 | 0-15: Reserved | |
| Parameters | | 16: Voice Codec G.729A | |
| | | 17: Voice Codec AMR | |
| | | 18-255: Reserved | |
| MAC Header | 1 | Indicates whether AGMH | |
| Type | | or SPMH is presented at | |
| | | the start of MAC PDUs of | |
| | | the service flow. | |
| | | 0: AGMH (Advanced | |
| | | Generic MAC Header) | |
| | | 1: SPMH (Short-Packet | |
| | | MAC header) | |
| | | default value is 0. | |
| } | | | |

Table 4 describes fields of a DM-LEST-RSP (which may be used together with AAI-DC-LEST-RSP) message.

TABLE 4

| | Size | | |
|---|---|---|---|
| Field | (bits) | Value/Description | Condition |
| Link Change | 4 | Link Change Count from | Shall always |
| Count | | corresponding the | be present |
| | | AAI-DM-LEST-REQ | |
| Confirmation | 4 | Zero indicates the request | Shall always |
| Code | | was successful. Nonzero | be present |
| | | indicates failure. | |
| | | 0x0: accept | |
| | | 0x1: reject with a | |
| | | recommended DCH | |
| | | 0x2: reject | |
| | | 0x3 to 0xF: reserved | |
| Direct Mode | 2 | Direct mode zone type of | Present if |
| Zone Type | | a recommended DCH | Confirmation |
| | | 0x0: Common direct | Code == 0x1 |
| | | mode zone (CDMZ) | |
| | | 0x1: Common direct mode | |
| | | zone extended (CDMZ-E) | |
| | | 0x2: Cell specific direct | |
| | | mode zone (CSDMZ) | |
| | | 0x3 to 0xF: Reserved. | |
| DCH Number | 6 | Recommended DCH | Present if |
| | | number on the zone of | Confirmation |
| | | Direct Mode Zone Type | Code == 0x1 |

Table 5 describes fields of a DM-MES-REP (which may be used together with an AAI-DC-MES-REP) message.

TABLE 5

| | Size | | |
|---|---|---|---|
| Field | (bits) | Value/Description | Condition |
| For (i = 0; | | N DCH CINR is the number | Present if |
| i < N DCH CINR; | | of dedicated channels which | 0 < N |
| i++) { | | are used for receiving packets | DCH |
| | | and selected for CINR report | CINR |
| Direct Mode Zone | 2 | Direct mode zone type for | |
| Type | | measurement | |
| | | 0x0: Common direct mode | |
| | | zone (CDMZ) | |
| | | 0x1: Common direct mode | |
| | | zone extended (CDMZ-E) | |
| | | 0x2: Cell specific direct | |
| | | mode zone (CSDMZ) | |
| | | 0x3: Reserved. | |
| DCH number | 6 | DCH number for | |
| | | measurement | |
| DCH CINR mean | 8 | CINR mean of the dedicated | |
| | | channel | |
| } | | | |
| For (i = 0; | | N DCH NI is the number of | Present if |
| i< N DCH | | dedicated channels which are | 0 < N |
| NI; i++) { | | not used for receiving and | DCH NI |
| | | packets and selected for NI | |
| | | report | |
| Direct Mode Zone | 2 | Direct mode zone type for | |
| Type | | measurement | |
| | | 0x0: Common direct mode | |
| | | zone (CDMZ) | |
| | | 0x1: Common direct mode | |
| | | zone extended (CDMZ-E) | |
| | | 0x2: Cell specific direct | |
| | | mode zone (CSDMZ) | |
| | | 0x3 to 0xF: Reserved. | |
| DCH Number | 6 | DCH number for | |
| | | measurement | |
| Noise and | 8 | Noise and Interference mean. | |
| Interference Level | | This is noise plus interference | |
| Mean | | power level that is divided by | |
| | | the number of subcarriers in | |
| | | the frequency domain and | |
| | | averaged over the dedicated | |
| | | channel. | |
| | | −134 dBm to −30 dBm in | |
| | | units of 1 dB. | |
| | | −134 dBm is encoded as 0x00, | |
| | | −30 dB is encoded as 0x69, | |
| | | 0x69 to 0xFF is reserved. | |
| Noise and | 4 | Noise and Interference | |
| Interference Level | | variance. | |
| Variance | | 0 dB to 15 dB in units | |
| | | of 1 dB. | |
| } | | | |

Table 6 describes fields of a DM-RCHG-REQ (which may be used together with an AAI-DC-RCHG-REQ) message.

TABLE 6

| | Size | | |
|---|---|---|---|
| Field | (bits) | Value/Description | Condition |
| For (i = 0; | | N DCH is the number of | |
| i < N DCH; | | dedicated channels | |
| i++) { | | | |
| Old Direct Mode | 2 | Direct mode zone type for | |
| Zone Type | | old DCH | |
| | | 0x0: Common direct mode | |
| | | zone (CDMZ) | |
| | | 0x1: Common direct mode | |
| | | zone extended (CDMZ-E) | |
| | | 0x2: Cell specific direct | |
| | | mode zone (CSDMZ) | |
| | | 0x3 to 0xF: Reserved. | |
| Old DCH Number | 4 | Indicates old DCH number. | |
| New Direct Mode | 2 | Direct mode zone type | |
| Zone Type | | for new DCH | |
| | | 0x0: Common direct | |
| | | mode zone (CDMZ) | |
| | | 0x1: Common direct mode | |
| | | zone extended (CDMZ-E) | |
| | | 0x2: Cell specific direct | |
| | | mode zone (CSDMZ) | |
| | | 0x3: Reserved. | |
| New DCH | 4 | Indicates new DCH number. | |
| Number | | | |
| } | | | |
| For (i = 0; | | N DCH NI is the number | Present if |
| i < N DCH | | of recommended dedicated | 0 < N |
| NI; i++) | | channels for candidates of | DCH NI |
| { | | new DCHs | |
| Direct Mode Zone | 2 | Direct mode zone type of a | |
| Type | | recommended DCH | |
| | | 0x0: Common direct | |
| | | mode zone (CDMZ) | |
| | | 0x1: Common direct mode | |
| | | zone extended (CDMZ-E) | |
| | | 0x2: Cell specific direct | |
| | | mode zone (CSDMZ) | |
| | | 0x3: Reserved. | |
| DCH Number | 6 | DCH number of a candidate | |
| Noise and | 8 | Noise and Interference mean. | |
| Interference Level | | This is noise plus | |
| Mean | | interference power level that | |
| | | is divided by the number of | |
| | | subcarriers in the frequency | |
| | | domain and averaged over | |
| | | the dedicated channel. | |
| | | −134 dBm to −30 dBm in | |
| | | units of 1 dB. | |
| | | −134 dBm is encoded as 0x00, | |
| | | −30 dB is encoded as 0x69, | |
| | | 0x69 to 0xFF is reserved. | |
| Noise and | 4 | Noise and Interference | |
| Interference Level | | variance. | |
| Variance | | 0 dB to 15 dB in units of 1dB. | |
| } | | | |

Table 7 describes fields of a DM-RCHG-RSP (which may be used together with an AAI-DC-RCHG-RSP) message.

TABLE 7

| | Size | | |
|---|---|---|---|
| Field | (bits) | Value/Description | Condition |
| Confirmation Code | 4 | Zero indicates the request | Shall always |
| | | was successful. Nonzero | be present |
| | | indicates failure. | |
| | | 0x0: accept with new | |
| | | mapping of DCHs | |
| | | 0x1: reject (continue to | |
| | | use current DCHs) | |
| | | 0x2 to 0xF: reserved | |
| For (i = 0; | | N DCH is the number of | Present if |
| i < N DCH; | | DCHs which are | Confirmation |
| i++) { | | changed to new DCHs | Code == 0x0 |
| Old Direct Mode | 2 | Direct mode zone type | |
| Zone Type | | for old DCH | |
| | | 0x0: Common direct | |
| | | mode zone (CDMZ) | |
| | | 0x1: Common direct mode | |
| | | zone extended (CDMZ-E) | |
| | | 0x2: Cell specific direct | |
| | | mode zone (CSDMZ) | |
| | | 0x3: Reserved. | |
| Old DCH Number | 4 | Indicates old DCH number. | |
| New Direct Mode | 2 | Direct mode zone type for | |
| Zone Type | | new DCH | |
| | | 0x0: Common direct | |
| | | mode zone (CDMZ) | |
| | | 0x1: Common direct mode | |
| | | zone extended (CDMZ-E) | |
| | | 0x2: Cell specific direct | |
| | | mode zone (CSDMZ) | |
| | | 0x3: Reserved. | |
| New DCH Number | 4 | Indicates new DCH number. | |
| } | | | |

Table 8 describes fields of a DM-TAN-REQ (which may be used together with an AAI-DC-TKN-REQ) message.

TABLE 8

| | Size | | |
|---|---|---|---|
| Field | (bits) | Value/Description | Condition |
| Direct Mode Zone | 2 | Direct mode zone type of | |
| Type | | a recommended DCH | |
| | | 0x0: Common direct | |
| | | mode zone (CDMZ) | |
| | | 0x1: Common direct mode | |
| | | zone extended (CDMZ-E) | |
| | | 0x2: Cell specific direct | |
| | | mode zone (CSDMZ) | |
| | | 0x3 to 0xF: Reserved. | |
| DCH Number | 4 | Indicates a number of | |
| | | dedicated channels with | |
| | | DCH Number. | |

Table 9 describes fields of a DM-TKN-RSP (which may be used together with an AAI-DC-TKN-RSP) message.

TABLE 9

| | Size | | |
|---|---|---|---|
| Field | (bits) | Value/Description | Condition |
| Confirmation | 4 | Zero indicates the request | Shall always be |
| Code | | was successful. | present |
| | | Nonzero indicates failure. | |
| | | 0x0: accept | |
| | | 0x1: reject | |
| | | 0x2 to 0xF: reserved | |

Table 10 describes fields of a DM-TKN-HO (which may be used together with an AAI-DC-TKN-HO).

TABLE 10

| | Size | | |
|---|---|---|---|
| Field | (bits) | Value/Description | Condition |
| DCTID | 24 | DC Terminal Identifier. | Shall always |
| | | Indicate the HR-MS which takes a | be present |
| | | PTT token. | |
| DC Frame | 4 | Indicates a DC frame number in which | |
| Number | | the HR-MS receiving AAI-DC-TKN-HO | |
| | | message sends packets on the DCH | |

Table 11 describes fields of a DM-LEST-CMD (which may be used together with an AAI-DC-LEST-CMD) message.

TABLE 11

| | Size | | |
|---|---|---|---|
| Field | (bits) | Value/Description | Condition |
| Link Change | 4 | The change count of this transaction | Shall |
| Count | | assigned by the sender. If new | always |
| | | transaction is started, Link Change | be present |
| | | Count is incremented by one | |
| | | (modulo 16) by the sender. | |
| For (i = 0; | | N Flow Est is the number of flows | |
| i < N Flow Est; | | on which the sender of this message | |
| i++) { | | sends MAC PDUs. | |
| | | Range [0 . . . 1] | |
| FID | 4 | Flow identifier assigned by the | |
| | | source of packets on the flow | |
| Traffic Priority | 3 | 0 to 7: Higher numbers indicate | |
| | | higher priority | |
| | | Default: 0 | |
| CS | 8 | 0-15: Reserved | |
| Specification | | 16: Voice Codec G.729A | |
| Parameters | | 17: Voice Codec AMR | |
| | | 18-255: Reserved | |
| MAC Header | 1 | Indicates whether AGMH or SPMH | |
| Type | | is presented at the start of MAC | |
| | | PDUs of the service flow. | |
| | | 0: AGMH (Advanced Generic MAC | |
| | | Header) | |
| | | 1: SPMH (Short-Packet MAC Header) | |
| | | default value is 0. | |
| } | | | |

Table 12 describes fields of a DM-LREL-CMD (which may be used together with an AAI-DC-LREL-CMD) message.

TABLE 12

| | Size | | |
|---|---|---|---|
| Field | (bits) | Value/Description | Condition |
| Link Release | 8 | Used to indicate the purpose | Shall always |
| Command Code | | of this message | be present |
| | | 0x00: Link release command. | |
| | | 0x01-0xff: Reserved | |

Table 13 describes fields of a DM-DSA-CMD (which may be used together with an AAI-DC-DSA-CMD) message.

TABLE 13

| | Size | | |
|---|---|---|---|
| Field | (bits) | Value/Description | Condition |
| FID Change | 4 | The change count of this transaction | Shall |
| Count | | assigned by the sender. If new | always be |
| | | transaction is started, FID Change | present |
| | | Count is incremented by one | |
| | | (modulo 16) by the sender. | |
| For (i = 0; | | N Flow Est is the number of flows | |
| i < N Flow Est; | | on which the sender of this message | |
| i++) { | | sends MAC PDUs. | |
| FID | 4 | Flow identifier assigned by the | |
| | | source of packets on the flow | |
| Traffic | 3 | 0 to 7: Higher numbers indicate | |
| Priority | | higher priority | |
| | | Default: 0 | |
| CS | 8 | 0-15: Reserved | |
| Specification | | 16: Voice Codec G.729A | |
| Parameters | | 17: Voice Codec AMR | |
| | | 18-255: Reserved | |
| MAC Header | 1 | Indicates whether AGMH or SPMH | |
| Type | | is presented at the start of MAC | |
| | | PDUs of the service flow. | |
| | | 0: AGMH (Advanced Generic MAC | |
| | | Header) | |
| | | 1: SPMH (Short-Packet MAC Header) | |
| | | default value is 0. | |
| } | | | |

Table 14 describes fields of a DM-DSC-CMD (which may be used together with an AAI-DC-DSC-CMD) message.

TABLE 14

| | Size | | |
|---|---|---|---|
| Field | (bits) | Value/Description | Condition |
| FID Change | 4 | The change count of this transaction | Shall |
| Count | | assigned by the sender. If new | always be |
| | | transaction is started, FID Change | present |
| | | Count is incremented by one | |
| | | (modulo 16) by the sender. | |
| For (i = 0; | | N Flow Chg is the number of flows | Present if |
| i < N Flow Chg; | | on which the sender of this message | 0 < N |
| i++) { | | sends MAC PDUs. | Flow Chg |
| FID | 4 | Flow identifier assigned by the | |
| | | source of packets on the flow | |
| Traffic Priority | 3 | 0 to 7: Higher numbers indicate | |
| | | higher priority | |
| | | Default: 0 | |
| CS | 8 | 0-15: Reserved | |
| Specification | | 16: Voice Codec G.729A | |
| Parameters | | 17: Voice Codec AMR | |
| | | 18-255: Reserved | |
| MAC Header | 1 | Indicates whether AGMH or SPMH | |
| Type | | is presented at the start of MAC | |
| | | PDUs of the service flow. | |
| | | 0: AGMH (Advanced Generic MAC | |
| | | Header) | |
| | | 1: SPMH (Short-Packet MAC Header) | |
| | | default value is 0. | |
| } | | | |

Table 15 describes fields of a DM-DSD-CMD (which may be used together with an AAI-DC-DSD-CMD) message.

TABLE 15

| | Size | | |
|---|---|---|---|
| Field | (bits) | Value/Description | Condition |
| FID Change | 4 | The change count of this transaction | Shall |
| Count | | assigned by the sender. If new | always be |
| | | transaction is started, FID Change | present |
| | | Count is incremented by one | |
| | | (modulo 16) by the sender. | |
| For (i = 0; | | N Flow Rel is the number of flows | |
| i < N Flow Rel; | | which the sender of this message is | |
| i++) { | | to release. | |
| | | Range [0 . . . 12] | |
| FID | 4 | Flow identifier assigned by the | |
| | | source of packets on the flow | |
| } | | | |

Table 16 describes fields of a DM-MES-CMD (which may be used together with an AAI-DC-MES-CMD) message.

TABLE 16

| | Size | | |
|---|---|---|---|
| Field | (bits) | Value/Description | Condition |
| Report | 2 | Report mode indicator | |
| Mode | | 0b00: Event-triggered report | |
| | | 0b01: One-time report | |
| | | 0b10: Periodic report | |
| | | 0b11: reserved | |
| Report | 2 | Bitmap indicator of trigger metrics that | |
| Metric | | the sending HR-MS requests the | |
| | | receiving HR-MS to report. | |
| | | Bit 0: DCH CINR mean | |
| | | Bit 1: DCH Noise and Interference mean | |
| | | and variance | |
| Report | 4 | type indicator of direct mode zone that | |
| Direct | | the sending HR-MS requests the | |
| Mode | | receiving HR-MS to measure and report. | |
| Zone | | Bit 0: Common direct mode zone | |
| Type | | (CDMZ) | |
| | | Bit 1: Common direct mode zone | |
| | | extended (CDMZ-E) | |
| | | Bit 2: Cell specific direct mode zone | |
| | | (CSDMZ) | |
| | | Bit 3: Reserved. | |
| Report | 8 | The period of HR-MS report of | Present if |
| Period | | measurement result on DCHs when the | Report |
| | | HR-MS is required to report the value | Mode == |
| | | periodically or once. Report Period is | 0b01 ∥ 0b10. |
| | | the number of DC frames that the | |
| | | sending HR-MS suggests to the | |
| | | receiving HR-MS from receiving | |
| | | AAI-DC-MES-CMD message to | |
| | | sending AAI-DC-MES-REP message. | |
| Report | 4 | The averaging parameter used for | |
| Trigger | | averaging this trigger metric. | |
| Averaging | | 0x0: 1 | |
| Parameter | | 0x1: ½ | |
| | | 0x2: ¼ | |
| | | 0x3: ⅛ | |
| | | 0x4: 1/16 | |
| | | 0x5: 1/32 | |
| | | 0x6: 1/64 | |
| | | 0x7: 1/128 | |
| | | 0xA to 0xF: Reserved | |
| Report | 8 | Threshold value that the sending | Present if |
| Trigger | | HR-MS requests the receiving HR-MS | Report |
| CINR | | to report the measurements if CINR of | Mode == |
| Threshold | | DCH for receiving packets is less than | 0b00 |
| | | the value. Unsigned bytes in units of | |
| | | 0.25 dB. 0x00 are interpreted as | |
| | | −103.75 dBm and 0xFF is interpreted | |
| | | as −40 dBm. | |

Table 17 describes fields of a DM-RCHG-CMD (which may be used together with an AAI-DC-RCHG-CMD) message.

TABLE 17

| | Size | | |
|---|---|---|---|
| Field | (bits) | Value/Description | Condition |
| For (i = 0; | | N DCH is the number of DCHs which | |
| i < N DCH; | | are changed to new DCHs | |
| i++) { | | | |
| Old Direct | 2 | Direct mode zone type for old DCH | |
| Mode | | 0x0: Common direct mode zone (CDMZ) | |
| Zone Type | | 0x1: Common direct mode zone | |
| | | extended (CDMZ-E) | |
| | | 0x2: Cell specific direct mode zone | |
| | | (CSDMZ) | |
| | | 0x3: Reserved. | |
| Old DCH | 4 | Indicates old DCH number. | |
| Number | | | |
| New Direct | 2 | Direct mode zone type for new DCH | |
| Mode | | 0x0: Common direct mode zone (CDMZ) | |
| Zone Type | | 0x1: Common direct mode zone | |
| | | extended (CDMZ-E) | |
| | | 0x2: Cell specific direct mode zone | |
| | | (CSDMZ) | |
| | | 0x3: Reserved. | |
| New DCH | 4 | Indicates new DCH number. | |
| Number | | | |
| } | | | |

Table 18 describes fields of a DM-TKN-ADV (which may be used together with an AAI-DC-TKN-ADV) message.

TABLE 18

| | Size | | |
|---|---|---|---|
| Field | (bits) | Value/Description | Condition |
| Direct Mode | 2 | Direct mode zone type of DCH for | |
| Zone Type | | advertising that the PTT token is | |
| | | available. | |
| | | 0x0: Common direct mode zone | |
| | | (CDMZ) | |
| | | 0x1: Common direct mode zone | |
| | | extended (CDMZ-E) | |
| | | 0x2: Cell specific direct mode zone | |
| | | (CSDMZ) | |
| | | 0x3: Reserved. | |
| DCH | 4 | Indicates DCH number for the | |
| Number | | advertisement. | |
| PTT | 2 | Zero indicates that the PTT token | |
| Token | | is available. | |
| Status | | Nonzero indicates unavailable. | |
| | | 0x0: PTT token is available. | |
| | | 0x2-0x3: Reserved | |
| Destination | 24 | Indicates a destination HR-MS | |
| DCGID | | (Group) address. | |

Table 19 describes fields of an RTS (which may be used together with an AAI-DC-RTS) message.

TABLE 19

| | Size | | |
|---|---|---|---|
| Field | (bits) | Value/Description | Condition |
| Source | 24 | Indicates a source HR-MS address | |
| DCTID | | | |
| Destination | 24 | Indicates a destination HR-MS | |
| DCTID | | (Group) address. | |
| or DCGID | | | |
| Maximum | 8 | Indicates a maximum index of burst | |
| Index of | | size that the sending HR-MS suggests | |
| Burst Size | | the receiving HR-MS to recommend. | |
| | | The receiving HR-MS selects burst | |
| | | size that is less than | |
| Maximum | 2 | Indicates maximum number of PHY | |
| Number | | burst retransmission for HARQ | |
| of HARQ | | operation. | |
| Retrans- | | 0: HARQ retransmission is disabled | |
| mission | | 1-3: HARQ retransmission is enabled | |
| Destination | 1 | Indicates type of destination address. | |
| Address | | 0: DCTID | |
| Type | | 1: DCGID | |
| Piggyback | 1 | Indicates whether a control message | |
| Message | | is piggybacked or not | |
| Indicator | | 0: no piggyback | |
| | | 1: MAC control message | |
| Reserved | 4 | | |
| MAC | | variable MAC control messages in | Present if |
| Control | | Table 1216 except AAI-DC-RTS | Piggyback |
| Message | | and AAI-DC-CTS messages. | message |
| | | | indicator |
| | | | is set to 1 |

Table 20 describes fields of a CTS (which may be used together with an AAI-DC-CTS) message.

TABLE 20

| | Size | | |
|---|---|---|---|
| Field | (bits) | Value/Description | Condition |
| Source DCTID | 24 | Indicates a source HR-MS address | |
| Destination | 24 | Indicates a destination HR-MS | |
| DCTID or | | (Group) address. | |
| DCGID | | | |
| Recommended | 8 | Indicates a recommended index of | |
| Index of | | burst size for a dedicated channel | |
| Burst Size | | | |
| Maximum | 2 | Indicates maximum number | |
| Number | | of PHY burst retransmission for | |
| of HARQ | | HARQ operation | |
| Retrans- | | | |
| mission | | | |
| Piggyback | 1 | Indicates whether a control | |
| Message | | message is piggybacked or not | |
| Indicator | | 0: no piggyback | |
| | | 1: MAC control message | |
| Reserved | 5 | | |
| MAC Control | | variable MAC control messages in | Present if |
| Message | | Table 1216 except AAI-DC-RTS | Piggyback |
| | | and AAI-DC-CTS messages. | message |
| | | | indicator |
| | | | is set to 1 |

Table 21 describes a field of an AAI_DC_MCHG_CMD message.

TABLE 21

| | Size | | |
|---|---|---|---|
| Field | (bits) | Value/Description | Condition |
| Maximum | 8 | Indicates a maximum index of | |
| indexof | | burst size for a dedicated | |
| burst size | | channel | |

Table 22 describes fields of an AAI_DC_RELAY-ADV message.

TABLE 22

| | Size | | |
|---|---|---|---|
| Field | (bits) | Value/Description | Condition |
| Relay DCTID | 24 | DC Terminal Identifier. | |
| | | Indicate the HR-MS which relays | |
| | | packets between two TDC links | |
| Relay Status | 1 | Indicate that the relaying HR-MS | |
| | | is available for two-hop operation. | |
| | | 0x0: available | |
| | | 0x1: relaying packets | |
| Relay Traffic | 3 | Indicate the traffic priority for | |
| Priority | | relaying packets | |
| | | 0 to 7: Higher numbers indicate | |
| | | higher priority | |
| | | Default: 0 | |
| For (i = 0; | | N Reserved DCH is the number | |
| i < N Reserved | | of dedicated channels for | |
| DCH; | | reservation | |
| i++) { | | | |
| Direct Mode | 2 | Direct mode zone type of a | |
| Zone Type for | | reserved DCH | |
| Reservation | | 0x0: Common direct mode zone | |
| | | (CDMZ) | |
| | | 0x1: Common direct mode zone | |
| | | extended (CDMZ-E) | |
| | | 0x2: Cell specific direct mode | |
| | | zone (CSDMZ) | |
| | | 0x3 to 0xF: Reserved. | |
| DCH Number | 6 | Reserved DCH number on the | |
| for Reservation | | zone of Direct Mode Zone Type | |
| } | | | |

Table 23 describes fields of an AAI_DC_RELAY-REQ message.

TABLE 23

| | Size | | |
|---|---|---|---|
| Field | (bits) | Value/Description | Condition |
| Link Change | 4 | The change count of this transaction | Shall |
| Count | | assigned by the sender. If new | always be |
| | | transaction is started, Link Change | present |
| | | Count is incremented by one | |
| | | (modulo 16) by the sender. | |
| For (i = 0; | | N Flow Est is the number of flows | |
| i < N Flow Est; | | on which the sender of this message | |
| i++) { | | sends MAC PDUs. | |
| | | Range [0 . . . 1] | |
| FID | 4 | Flow identifier assigned by the sink | |
| | | of packets on the flow | |
| Traffic Priority | 3 | 0 to 7: Higher numbers indicate | |
| | | higher priority | |
| | | Default: 0 | |
| CS Specifi- | 8 | 0-15: Reserved | |
| cation | | 16: Voice Codec G.729A | |
| Parameters | | 17: Voice Codec AMR | |
| | | 18-255: Reserved | |
| MAC Header | 1 | Indicates whether AGMH or SPMH | |
| Type | | is presented at the start of MAC | |
| | | PDUs of the service flow. | |
| | | 0: AGMH (Advanced Generic MAC | |
| | | Header) | |
| | | 1: SPMH (Short-Packet MAC | |
| | | header) | |
| | | default value is 0. | |
| } | | | |
| Target DCTID | 24 | Indicates a receiving HR-MS | |
| or DCGID | | (Group) address. | |

Table 24 describes fields of an AAI_DC_RELAY-RSP message.

TABLE 24

| | Size | | |
|---|---|---|---|
| Field | (bits) | Value/Description | Condition |
| Link Change | 4 | Link Change Count from | Shall always |
| Count | | the corresponding | be present |
| | | AAI-DCRELAY-REQ | |
| Confirmation | 4 | Zero indicates the request was | Shall always |
| Code | | successful. Nonzero indicates | be present |
| | | failure. | |
| | | 0x0: accept | |
| | | 0xl : reject with a recommended | |
| | | DCH | |
| | | 0x2: wait next response message | |
| | | 0x3 to 0xF: reserved | |
| Direct Mode | 2 | Direct mode zone type of a | Present if |
| Zone Type | | recommended DCH | Confirmation |
| | | 0x0: Common direct mode zone | Code == 0x1 |
| | | (CDMZ) | |
| | | 0xl : Common direct mode zone | |
| | | extended (CDMZ-E) | |
| | | 0x2: Cell specific direct mode | |
| | | zone (CSDMZ) | |
| | | 0x3 to 0xF: Reserved. | |
| DCH | 6 | Recommended DCH number on | Present if |
| Number | | zone of Direct Mode Zone Type | Confirmation |
| | | | Code == 0x1 |

According to an embodiment of the present invention, signaling methods for a link establishment, a flow management, a channel measurement, a resource management, information broadcasting, and a token management for one-to-many direct communication between a terminal and a plurality of terminals, as well as one-to-one direct communication between terminals, can be provided.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A signaling method of a first terminal for direct communication between terminals, the method comprising:
transmitting a link establishment request message for establishing a direct communication link including flow information to a second terminal;
receiving a link establishment response message for establishing a direct communication link including flow information from the second terminal; and
establishing a direct communication link between the first terminal and the second terminal.

2. The method of claim 1, further comprising,
when a token is intended to be transferred to the second terminal, transmitting a token handover message instructing about transferring a token to the second terminal.

3. The method of claim 1, further comprising:
receiving a token request message requesting a transfer of the token from the second terminal; and
transmitting a token handover message instructing about transferring the token to the second terminal.

4. A signaling method of a first terminal for direct communication between terminals, the method comprising:
transmitting a first command message for establishing a direct communication link including flow information to a plurality of second terminals; and
establishing a direct communication link between the first terminal and the plurality of second terminals.

5. The method of claim 4, further comprising,
when flow management between the first terminal and the plurality of second terminals is required, transmitting one of a service addition command message instructing about configuring a flow, a service change command message instructing about changing a flow, and a service release command message instructing about releasing a flow to the plurality of second terminals.

6. The method of claim 4, further comprising,
when the link between the first terminal and the plurality of second terminals is required to be released, transmitting a link release command message instructing about releasing the direct communication link to the plurality of second terminals.

7. The method of claim 4, further comprising:
when a channel measurement between the first terminal and the plurality of second terminals is required, dedicatedly transmitting a measurement command message instructing about a channel measurement to the plurality of second terminals; and
receiving measurement report messages reporting a channel measurement result from the plurality of second terminals.

8. The method of claim 4, further comprising:
receiving a change request message requesting changing of a resource from at least one of the plurality of second terminals; and
multicasting a change command message instructing about changing a resource to the plurality of second terminals.

9. The method of claim 4, further comprising:
multicasting a token advertisement message announcing that a token is to be transferred to the plurality of second terminals;
receiving a token request message requesting to receive the token from at least one of the plurality of second terminals; and
multicasting a token handover message including information regarding a terminal to which the token is to be transferred to the plurality of second terminals.

10. A signaling method of a first terminal for direct communication between terminals, the method comprising:
transmitting a first link establishment request message for establishing a direct communication link to a second terminal through an RTS (request to send) data region;
receiving a first link establishment response message for establishing a direct communication link from the second terminal through a CTS (clear to send) data region; and
establishing a direct communication link in a first direction with respect to the second terminal from the first terminal.

11. The method of claim 10, wherein the first link establishment response message includes direct communication resource information, and the direct communication resource information indicates whether or not a resource is a common direct communication resource commonly allocated to a cell or a cell-specific direct communication resource allocated to a cell individually.

12. The method of claim 10, further comprising:
when the direct communication link is intended to be released, transmitting a link release command message for releasing the direct communication link to the second terminal; and
releasing a direct communication link with respect to the first direction.

13. The method of claim 10, further comprising,
when a flow of the direct communication link is intended to be managed, transmitting one of a flow addition command message instructing about configuring a flow, a flow change command message instructing about changing a flow, and a flow release command message instructing about releasing a flow to the second terminal.

14. The method of claim 10, further comprising:
transmitting a measurement command message instructing about measuring a first channel transferring a packet for direct communication between terminals to the second terminal; and
receiving a measurement report message including a measurement value through a second channel transferring a control message for the first channel from the second terminal or receiving a code through a corresponding supplementary channel in order to report a radio state of the first channel from the second terminal.

15. The method of claim 14, wherein the measurement report message further comprises at least one of information regarding the first channel and direct communication resource information.

16. The method of claim 10, further comprising:
receiving a token request command message requesting a transfer of a token through the second channel transferring a control message for a first channel transferring a packet for direct communication between terminals from the second terminal;
when it is determined that the token is transferred to the second terminal, transmitting a token handover message instructing about transferring the token to the second terminal; and
receiving data in a second direction with respect to the first terminal from the second terminal.

17. The method of claim 10, further comprising:
receiving a second link establishment request message from the second terminal through an RTS data region;
transmitting a second link establishment response message to the second terminal through a CTS data region; and
establishing a direct communication link in the second direction with respect to the first terminal from the second terminal.

18. The method of claim 17, further comprising:
transferring a first link release command message for releasing a direct communication link to the second terminal;
receiving a second link release command message from the second terminal; and
releasing the links in the first direction and the second direction.

19. A signaling method of a first terminal for direct communication between terminals, the method comprising:
multicasting a link establishment command message for establishing a direct communication link to a plurality of second terminals through an RTS (request to send) data region;
receiving CTS (clear to send) from the plurality of second terminals; and
establishing a direct communication link between the first terminal and the plurality of second terminals.

20. The method of claim 19, further comprising:
receiving a token request message requesting a token from one of the plurality of terminals;
when a token request is accepted, transmitting a token response message as a response to the token request to the one terminal; and
transmitting a token handover message informing about the transfer of the token to the plurality of second terminals.

21. The method of claim 20, wherein the token request message and the token response message are transmitted through a resource in which the first terminal does not transmit a packet.
